(19) United States
(12) Patent Application Publication
(10) Pub. No.: US 2012/0229459 A1
(43) Pub. Date: Sep. 13, 2012

(54) 3D DISPLAY APPARATUS AND TIME-SEQUENTIAL 3D DISPLAY SYSTEM

(75) Inventors: Makoto Ishiguro, Kanagawa (JP); Yusuke Ohashi, Kanagawa (JP)

(73) Assignee: FUJIFILM CORPORATION, Tokyo (JP)

(21) Appl. No.: 13/414,994

(22) Filed: Mar. 8, 2012

(30) Foreign Application Priority Data
Mar. 9, 2011 (JP) 2011-051606

(51) Int. Cl. G09G 3/36; G02B 27/26; G06T 15/00

(52) U.S. Cl. 345/419; 359/492.01; 345/87

(57) ABSTRACT

A 3D display apparatus has at least a first polarization film disposed on an observation side, and a protection member that is disposed on the surface of the first polarization film on the observation side and has a λ/4 function, in which the protection member includes at least a first film for which the moisture permeability at 40° C. and 90% RH is 100 g/m²/day or less. In addition, the first film is preferably a cyclic olefin-based polymer film, and may have the λ/4 function.

### BACKGROUND OF THE INVENTION

1. Field of the Invention

The present invention relates to a 3D display apparatus and a time-sequential 3D display system.

2. Description of the Related Art

Hitherto, a variety of systems have been proposed as a stereoscopic (3D) display method, and one of the systems is a time-sequential system in which liquid crystal shutter glasses or the like are used. In this system, images for the left eye and the right eye are alternately displayed temporally, shutters of the glasses are opened and closed in synchronization with the display of the images, and the respective images are controlled in order that the images enter the corresponding eyes (for example, JP1978-51917A (JP-S53-51917A)). As a 3D display apparatus using this system, a system in which a liquid crystal panel is used as the display monitor is proposed (for example, JP2003-259395A). In this 3D display system, there is a problem of luminance degradation or crosstalk deterioration which occurs when the face of an observer is turned, but solution of this problem is also proposed in which λ/4 plates are respectively disposed on the surface of the image display apparatus and the surface of the shutter glasses, and circular polarization images are used (for example, JP2009-237376A).

### SUMMARY OF THE INVENTION

However, when a 3D display apparatus having the above configuration is stored under high humidity for a long period of time, there are cases in which uneven circles or uneven image edges occur on the screen, and there is a demand for improvement.

In the past, in order to improve the durability of polarization plates used in liquid crystal display apparatuses, use of a film having low moisture permeability as a protective film was proposed (for example, JP2009-237376A). However, disposing a film having a large phase difference, such as a λ/4 plate, as a protective film on the observation side for 2D liquid crystal display apparatuses of the related art has not been considered. Since there is a need for an increase in the screen size and a decrease in the bezel thickness in 3D display apparatuses, there is a problem in that durability unevenness cannot be improved by simply attaching an optical retardation film having low moisture permeability.

The invention has been made in consideration of the above problem, and an object of the invention is to improve the durability of a 3D display apparatus and a time-sequential 3D display system in which a λ/4 plate is used.

Specifically, the object is to provide a 3D display apparatus and a time-sequential 3D display system in which occurrence of uneven display under high humidity is alleviated.

Measures for solving the above problem are as follows:

[1] A 3D display apparatus having at least a first polarization film disposed on an observation side, and a protection member that is disposed on an observation-side surface of the first polarization film and has a λ/4 function, in which the protection member includes at least a first film of which the moisture permeability at 40° C. and 90% RH is 100 g/m²/day or less.

[2] The 3D display apparatus according to [1], in which the first film is a cyclic olefin-based polymer film.

[3] The 3D display apparatus according to [1] or [2], in which the protection member has an anti-reflection layer on the surface of the protection member on the observation-side surface.

[4] The 3D display apparatus according to any one of [1] to [3], in which the first film has a λ/4 function.

[5] The 3D display apparatus according to any one of [1] to [4], in which the protection member is an optically anisotropic layer composed of a composition including a liquid crystalline compound.

[6] The 3D display apparatus according to any one of [3] to [5] further having a cellulose acylate-based film at least at one of positions between the first film and the anti-reflection layer and between the first film and the optically anisotropic layer.

[7] The 3D display apparatus according to any one of [1] to [5] further having a second film of which the moisture permeability at 40° C. and 90% RH is 10 g/m²/day to 2000 g/m²/day on the surface opposite to the side on which the protection member of the first polarization film is disposed.

[8] The 3D display apparatus according to [7], in which the second film is a cellulose acylate-based film.

[9] A time-sequential 3D display system having at least the 3D display apparatus according to any one of [1] to [8] and a time-sequential image display shutting device that operates in synchronization with the 3D display apparatus.

[10] The time-sequential 3D display system according to [9], in which the time-sequential image display shutting device has at least a λ/4 plate, a liquid crystal cell, and a polarization film arranged in order from the side facing the 3D display apparatus.

[11] The time-sequential 3D display system according to [10], in which the time-sequential image display shutting device further has a polarization film between the λ/4 plate and the liquid crystal cell.

According to the invention, it is possible to improve the durability of the 3D display apparatus and the time-sequential 3D display system in which the λ/4 plate is used.

Specifically, according to the invention, it is possible to provide a 3D display apparatus and a time-sequential 3D display system in which occurrence of uneven display under high humidity is alleviated.

### BRIEF DESCRIPTION OF THE DRAWINGS

FIG. 1 is a schematic view showing an example of the time-sequential 3D display apparatus of the invention together with liquid crystal shutter glasses.

FIG. 2 is a schematic cross-sectional view of an example of the time-sequential 3D display apparatus of the invention.

FIGS. 3A and 3B are schematic cross-sectional views of an example of the time-sequential 3D display apparatus of the invention.

FIGS. 4A and 4B are schematic cross-sectional views of an example of an aspect of a protection member.

FIGS. 5A to 5G are schematic cross-sectional views of examples of the protection member and a λ/4 layer.

FIGS. 6A to 6J are schematic cross-sectional views of examples of the protection member and a λ/4 layer.

FIGS. 7A to 7J are schematic cross-sectional views of examples of the protection member and a λ/4 layer.

FIG. 8 is a schematic cross-sectional view of an example of the time-sequential 3D display system of the invention.

### DESCRIPTION OF THE PREFERRED EMBODIMENTS

Hereinafter, the invention will be described in detail using embodiments. Meanwhile, in the present specification, the numerical ranges expressed using “to” refer to ranges that include numeric values specified before and after the “to” as the lower limit value and the upper limit value.

Firstly, terminologies that will be used in the specification will be described. Re (λ) and Rth (λ) indicate the retardation in the surface and the retardation in the thickness direction at a wavelength of λ. The Re (λ) is measured by making light rays having a wavelength of λ nm be incident in the normal direction to a film in a KOBRA 21ADH or WR (manufactured by Oji Scientific Instruments). The measurement wavelength λ can be selected by manually exchanging wavelength-selecting filters, or converting measured values using a program or the like. In a case in which the measured film is expressed as a uniaxial or biaxial refractive index ellipsoid, the Rth (2) is computed by the following method.

Re (λ) is measured at a total of six points by making light rays having a wavelength of λ nm be incident from directions inclined at 10 degrees intervals from the normal direction to 50 degrees with respect to the normal direction to the film when retarded axes in the surface (determined using KOBRA 21ADH or WR) are used as inclined axes (rotation axes) (in the case of no retarded axis, arbitrary directions in the film surface are used as the rotation axes), and Rth (λ) is computed using KOBRA 21ADH or WR based on the measured retardation values, an assumed value of the average refractive index, and the input film thickness value. In the above, in a case in which a film has a direction at which the retardation value becomes zero at an inclined angle when retarded axes in the surface from the normal direction are used as the rotation axes, the retardation values at inclined angles larger than the above inclined angle are changed to be negative values, and then KOBRA 21ADH or WR computes Re (λ). Meanwhile, it is also possible to compute Rth by measuring retardation values from two arbitrary inclined angles when retarded axes are used as the inclined axes (rotation axes) (in the case of no retarded axis, arbitrary directions in the film surface are used as the rotation axes), and using the following formulae (A) and (B) based on the measured values, an assumed value of the average refractive index, and the input film thickness.

### [Number 1]

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \qquad Formula ( A )$$

Meanwhile, the above Re (9) represents a retardation value in a direction inclined by 9 degrees from the normal direction. In addition, in the formula (A), nx represents the refractive index in the retarded axis direction in the surface, ny represents the refractive index in the orthogonal direction to nx in the surface, and nz represents the refractive index in the orthogonal direction to nx and ny.

Rth=((nx+ny)/2−nz)×d formula (B)

In a case in which a measured film does not have an axis that can be expressed as a uniaxial or biaxial refractive index ellipsoid, which is a so-called optical axis, Rth (λ) is computed by the following method. Re (λ) is measured at 11 points by making light rays having a wavelength of λ nm be incident from directions inclined at 10 degrees intervals from −50 degrees to +50 degrees with respect to the normal direction to the film when retarded axes in the surface (determined using KOBRA 21ADH or WR) are used as inclined axes (rotation axes), and Rth (λ) is computed using KOBRA 21ADH or WR based on the measured retardation values, an assumed value of the average refractive index, and the input film thickness value. In addition, in the above measurement, values in the polymer handbook (JOHN WILEY & SONS, INC) and a variety of optical film catalogues can be used as the assumed value of the average refractive index. For films with no known average refractive index value, the refractive index value can be measured using an Abbe refractometer. The average refractive index values of principal optical films will be as follows: cellulose acylate (1.48), cycloolefin polymer (1.52), polycarbonate (1.59), polymethyl methacrylate (1.49), and polystyrene (1.59). When an assumed value of the average refractive index and a film thickness are input, KOBRA 21ADH or WR computes nx, ny, and nz, and Nz=(nx−nz)/(nx−ny) is further computed using the computed nx, ny, and nz.

In the specification, the moisture permeability refers to a moisture permeability obtained by measuring the moisture permeability of the respective specimens according to the method as described in JIS Z 0208, and computing the amount (g) of moisture evaporated per an area of 1 m² for 24 hours.

In the specification, “parallel” and “orthogonal” mean that angles are strictly within a range of less than ±10°. The range of the angle difference is preferably less than ±5°, and more preferably less than ±2°. In addition, “retarded axis” refers to a direction in which the refractive index becomes largest.

Meanwhile, the measurement wavelength of the refractive index is a wavelength λ=550 nm in the visible light range unless particularly limited, and therefore the measurement wavelengths for Re and Rth are set to 550 nm unless particularly limited.

In addition, in the specification, “polarization film” and “polarization plate” will be distinctively used, and the “polarization plate” refers to a laminate having a transparent protective film that protects the polarization film at least on one surface of the “polarization film.” The transparent protective film refers to a self-supportive film that is disposed between a liquid crystal cell and the polarization film. (The degree of retardation does not matter.) Meanwhile, “λ/4 plate” and “λ/4 film” have the same meaning.

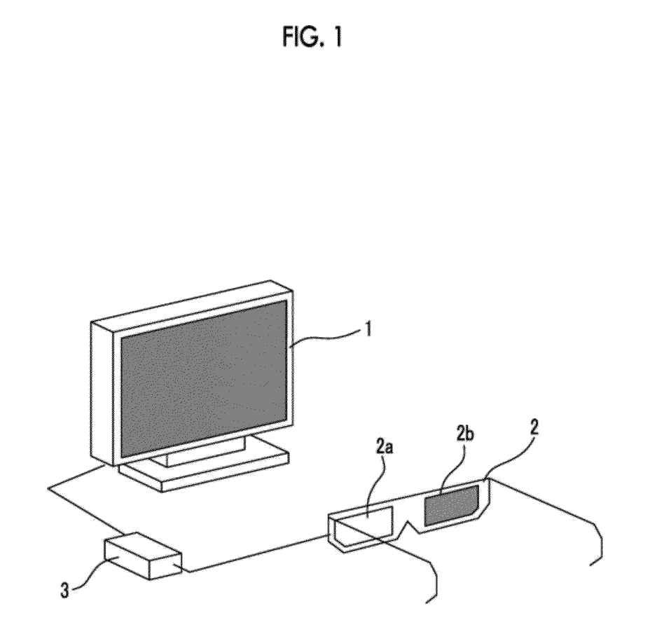

Hereinafter, an embodiment of the time-sequential 3D display apparatus of the invention will be described using the accompanying drawings. FIG. 1 is a schematic pattern diagram of an aspect of the time-sequential 3D display apparatus of the invention. The time-sequential 3D display apparatus as shown in FIG. 1 has an image display apparatus 1 and glasses 2 having a shutter function (time-sequential image display shutting device); images on the image display apparatus 1 are observed by an observer wearing the glasses 2. Although not shown in FIG. 1, the polarization film and a protection member having a λ/4 function are disposed in the image display apparatus 1 on the display surface side, the image display apparatus 1 displays circular polarized images toward the observer, the glasses 2 also include a λ/4 layer, and have a shutter function through which the transmission of the circle polarized images is turned on and off (the circle polarized images are transmitted or not).

The image display apparatus 1 alternately displays left-eye images and right-eye images, for example, at predetermined frequencies (for example, frequencies of 60 Hz or more). An example is that image signals for stereoscopic observation are processed into left-eye image signals and right-eye image signals in an image processing portion, then, sent to a display monitor-driving circuit, the left-eye image signals and the right-eye image signals are alternately assigned to each field in the respective pixel portions in the image display apparatus 1, the left-eye images and the right-eye images are alternately displayed on the same screen of the image display apparatus 1 at predetermined time intervals, and changed into left-eye circle polarized images and right-eye circle polarized images by the polarization film and the protection member having a λ/4 function, which are disposed on the observation-side surface.

A driving voltage and the like are applied to the glasses 2 in synchronization with switching of image display for the left eye and the right eye in the image display apparatus 1, in which the synchronization is carried out by a synchronization circuit 3. Specifically, when a left eye image is displayed, the transmission of a left eye shutter 2a with respect to circle polarization becomes largest, the image is input to the left eye, the transmission of a right eye shutter 2b with respect to circle polarization becomes smallest, and the image is not input to the right eye. On the other hand, when a right eye image is displayed, the circle polarization transmission of the right eye shutter 2b becomes largest, the image is input to the right eye, the circle polarization transmission of a left eye shutter 2a becomes smallest, and the image is not input to the left eye. The observer selectively views the left eye images only with the left eye and the right eye images only with the right eye so as to recognize the display images as stereoscopic images. Meanwhile, the mechanism that turns the transmission of the glasses 2 on and off is not particularly limited. Glasses using the shutter function by a liquid crystal cell are preferred.

As described above, the polarization film and the protection member having the λ/4 function are disposed in the image display apparatus 1 on the display surface side, circular polarized images are displayed to an observer, the glasses 2 also include the λ/4 layer, and has the shutter function that turns the transmission of circle polarized images on and off. In the protection member in the invention, the moisture permeability at 40° C. and 90% RH is 100 g/m²/day or less, and uneven display occurring under high humidity (uneven circles and diagonal unevenness) is suppressed. Even when the first film has the λ/4 function, or, separately from the first film, a phase difference film having the λ/4 function is disposed, similarly, uneven display can be alleviated. In addition, the protection member may be composed of the first film only, or may include other members (a phase difference film, an anti-reflection film, and the like) in addition to the first film.

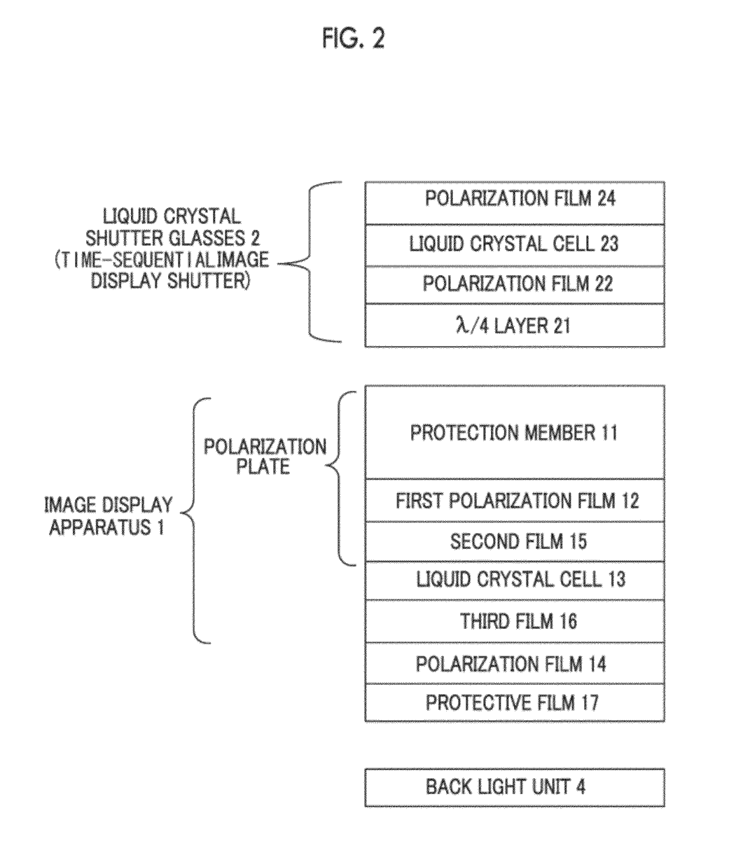

FIG. 2 shows a configuration example in which a liquid crystal panel is used as the image display apparatus 1, and liquid crystal shutter glasses are used as the glasses 2 in the form of a schematic cross-sectional view. Meanwhile, in the drawing, the relative relationship of the thickness between the respective layers is not necessarily coincident with the relative relationship of the thickness between the respective layers in an actual liquid crystal display apparatus.

The configuration of the image display apparatus 1 is not particularly limited. The image display apparatus may be, for example, a liquid crystal panel including a liquid crystal layer or an organic EL display panel including an organic EL layer. In any aspect, a variety of possible configurations can be employed. In addition, the shutter function of the glasses 2 is also not particularly limited, and a variety of configurations can be employed. Glasses using the shutter function of a liquid crystal cell are preferred.

The image display apparatus 1 is preferably a liquid crystal panel having a liquid crystal cell 13, and has a first polarization film 12 on the observation side of the liquid crystal cell, and, furthermore, a protection member 11 on the surface on the observation side of the first polarization film. The liquid crystal shutter glasses 2 are liquid crystal shutter glasses having the liquid crystal cell 13 and a λ/4 layer 21 on the observation side of the liquid crystal cell. The protection member 11 has the λ/4 function. The protection member 11 includes at least the first film for which the moisture permeability at 40° C. and 90% RH is 100 g/m²/day or less.

A back light 4 is disposed on the back side of the liquid crystal cell 13 in the image display apparatus 1, and a second polarization film 14 is disposed between the back light 4 and the liquid crystal cell 13, which is configured as a transparent mode.

The absorption axis of the second polarization film 14 is orthogonal to the absorption axis of the first polarization film 12. In addition, the second film 15 is disposed between the first polarization film 12 and the liquid crystal cell 13 for view angle compensation and/or protection of the polarization film 12. The second polarization film 14 also has a third film 16 disposed on the surface of the polarization film on the liquid crystal cell side and a protective film 17, if necessary, on the surface on the backlight side.

The configuration of the liquid crystal cell 13 is not particularly limited, and a liquid crystal cell having an ordinary configuration can be employed. The liquid crystal cell 13 includes, for example, a pair of substrates disposed opposite, not shown, and a liquid crystal layer sandwiched between the pair of substrates, and may include a color filter layer and the like, if necessary. The driving mode of the liquid crystal cell 13 is also not particularly limited, and a variety of modes, such as a twisted nematic (TN) mode, a super twisted nematic (STN) mode, a vertical alignment (VA) mode, an in-plane switching (IPS) mode, and an optically compensated birefringence (OCB) mode, can be used.

The first polarization film 12 disposed on the display side has the protection member 11 having the λ/4 function on the observation-side surface. The configuration of the protection member 11 is not particularly limited, and may be a single layer structure or a multilayer structure. The member having the λ/4 function includes a phase difference polymer film, a laminate of phase difference polymer films, an optically anisotropic layer formed by fixing the orientation of a liquid crystal composition, and a laminate of the optically anisotropic layer and a polymer film that supports the optically anisotropic layer. When including a polymer film, the protection member 11 can also be used as a protective film of the polarization film 12, which is preferred. In addition, the protection member 11 preferably has an anti-reflection layer on the observation-side surface. The details of the above members will be described below.

The protection member 11 includes the first film for which the moisture permeability at 40° C. and 90% RH is 100 g/m²/day or less. In an aspect in which the protection member 11 is a single layer structure of a phase difference film only, the vapor permeability of the phase difference film needs to be in the above range, and the phase difference film needs to exhibit the λ/4 function. In an aspect in which the protection member 11 is a multilayer structure, at least one layer needs to be a film for which the vapor permeability is in the above range. The film may be a phase difference film, and may achieve the λ/4 function singly or together with other phase difference films and the like. In addition, the film may be an optically isotropic film having no phase difference.

Meanwhile, the second film 15 is disposed on the surface of the first polarization film 12 on the liquid crystal cell side, and the third film 16 is also disposed on the surface of the polarization film 14, which is disposed on the backlight side 4, on the liquid crystal cell side. The films 15 and 16 may be a phase difference film that functions as the protective film of the polarization films 12 and 14 respectively, and has a phase difference that contributes to view angle compensation of the liquid crystal cell 13. At least either of the films 15 and 16 is preferably a film having high moisture permeability in order to further alleviate uneven display under high humidity, and, specifically, the film preferably has moisture permeability at 40° C. and 90% RH of 10 g/m²/day to 2000 g/m²/day.

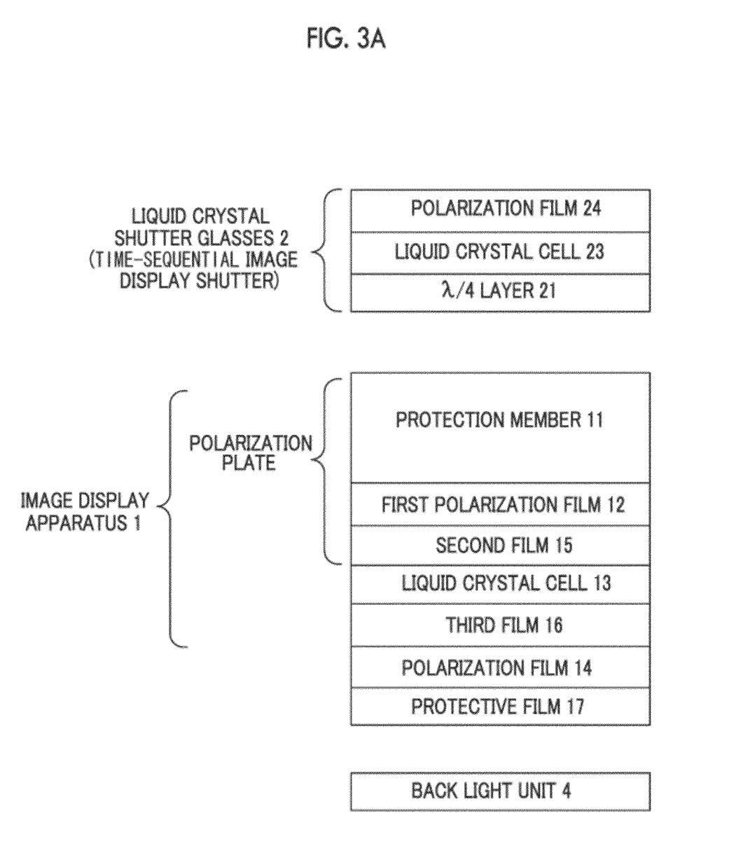

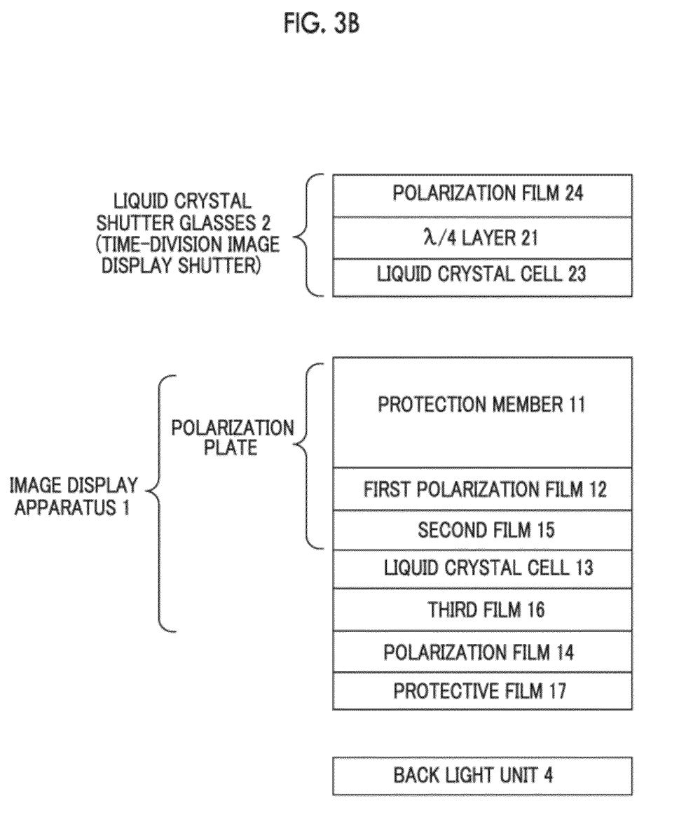

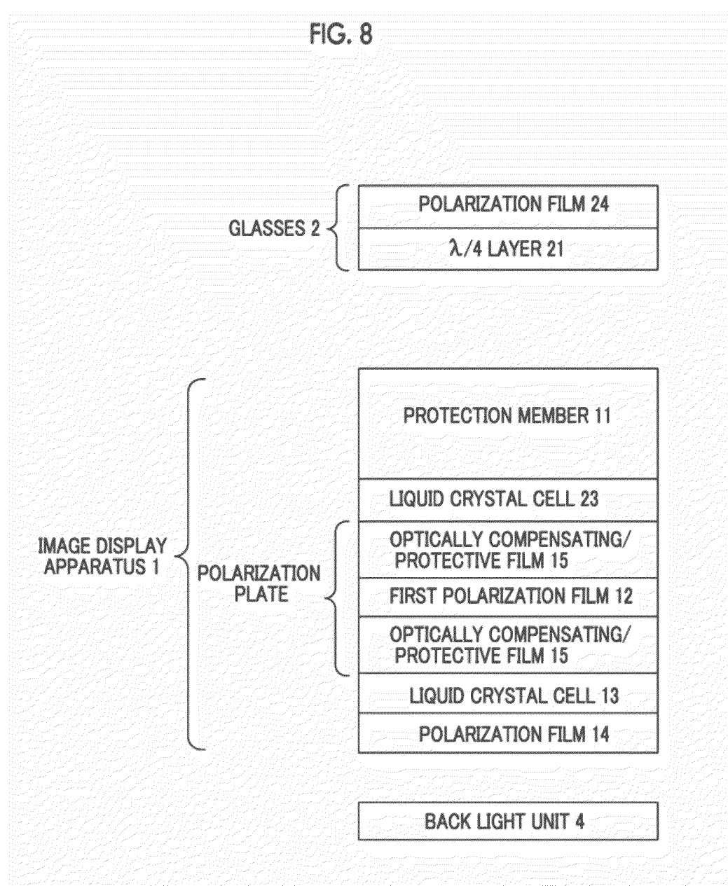

The glasses 2 have the λ/4 plate 21, the polarization plate 22, the liquid crystal cell 23, and the polarization film 24, and has a shutter function that works in synchronization with image display of the image display apparatus 1. The configuration of the glasses 2 may be a type in which two polarization plates are provided as shown in FIG. 2, or may be, other than the configuration as shown in FIG. 2, a configuration of a type in which one polarization plate is provided as shown in FIGS. 3A and 3B. In addition, as shown in FIG. 8, the same effect is exhibited even when the liquid crystal cell 23 is disposed on the display surface side of the image display apparatus 1. In this case, the liquid crystal cell 23 functions as an active retarder cell that converts outgoing light rays of the image display apparatus 1 to right circular polarized light and left circular polarized light in a time-sequential manner.

The configuration of the λ/4 plate 21 is also not particularly limited, and may be a single layer structure or a laminate structure. Considering that an observer wears the glasses, the λ/4 plate is preferably a light and thin layer, and therefore a single layer-structured λ/4 plate is preferred. Members that can be used for the λ/4 plate 21 include a phase difference polymer film, a laminate of phase difference polymer films, an optically anisotropic layer formed by fixing the orientation of a liquid crystal composition, and a laminate of the optically anisotropic layer and a polymer film that supports the optically anisotropic layer. When including a polymer film, the λ/4 plate 21 can also be used as a protective film of the polarization film 22, which is preferred. In addition, the λ/4 plate 21 preferably has a hard coating layer or an anti-reflection layer on the surface. The details of the above members will be described below.

The absorption axis of the first polarization film 12 in the image display apparatus 1 and the retarded axis of the protection member 11 having the λ/4 function are preferably 45°±10°, that is 35° to 55°, or 135°±10°, that is 125° to 145°. In addition, the absorption axis of the first polarization film 11 and the absorption axis of the polarization film 22 are preferably disposed orthogonally or in parallel, and the retarded axes of the protection member 11 and the λ/4 plate 21 are preferably orthogonal or in parallel.

Meanwhile, in an aspect in which the protection member 11 and the λ/4 plate 21 include a plurality of phase difference layers and/or phase difference films, the retarded axis is specified as the retarded axis measured with respect to all of the protection member 11 and the λ/4 plate 21.

In addition to the members as shown in FIG. 2, the time-sequential 3D system of the invention preferably further has an image processing portion that processes image signals for stereoscopic observation into left-eye image signals and right-eye image signals, a display monitor-driving circuit that sends the image signals to a display, and the synchronization circuit that, in accordance with the image signals, sends the signals to the liquid crystal shutter glasses, and turns the transmission of the left and right liquid crystal shutters on and off.

Hereinafter, a variety of members that are used in the time-sequential 3D display system of the invention will be described in detail.

1. A member having the λ/4 function

In the invention, members having the λ/4 function are used as the protection member that is disposed on the observation-side surface of the first polarization film disposed on the observation side of the image display apparatus and the λ/4 plate included in the time-sequential image display shutting device. Meanwhile, the λ/4 plate refers to all the layers present on the image display apparatus side of the liquid crystal cell in the aspects as shown in FIGS. 2 and 3A, and all the layers present between the polarization film and the liquid crystal cell in the aspect as shown in FIG. 3B.

In the invention, the protection member includes at least the first film for which the moisture permeability at 40° C. and 90% RH is 100 g/m²/day or less.

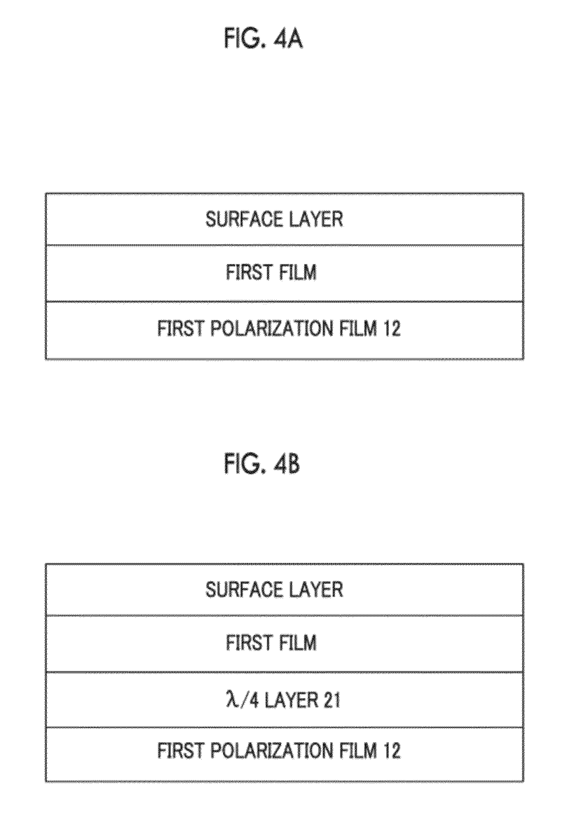

As the configuration of the protection member, for example, the protection member may have the first film having the λ/4 function and moisture permeability at 40° C. and 90% RH of 100 g/m²/day or less as shown in FIG. 4A, or may have the first film for which the moisture permeability at 40° C. and 90% RH is 100 g/m²/day or less together with a member having the λ/4 function (λ/4 film) as shown in FIG. 4B, and the configuration is not particularly limited as long as the protection member has at least the first film therein. In addition, the protection member may have a surface layer, such as an anti-reflection layer, on the outmost surface, if necessary.

The protection member and the λ/4 layer may have a single layer structure or multilayer structure respectively. Since the λ/4 layer is included in the time-sequential image display shutting device that an observer wears as glasses, the λ/4 layer is preferably a light single layer. In addition, when the protection member and the λ/4 layer include a polymer film, the protection member and the λ/4 layer can be used as a protective film of the polarization films that are adjacently disposed. In addition, the protection member and the λ/4 layer preferably include an anti-reflection layer on the surface. Members having the λ/4 function include a phase difference polymer film, a laminate of phase difference polymer films, an optically anisotropic layer formed by fixing the orientation of a liquid crystal composition, and a laminate of the optically anisotropic layer and a polymer film that supports the optically anisotropic layer, and any of them can be used. Examples of the phase difference polymer film include films having optical anisotropy that is developed by stretching the polymer film and orientating high molecules in the film. The phase difference polymer film can be constituted by one piece or two or more pieces of biaxial films or combining two or more pieces of uniaxial films, such as combining a C plate and an A plate. Needless to say, the phase difference polymer film can be constituted by combining one or more pieces of biaxial films and one or more pieces of uniaxial films. The optically anisotropic layer is a layer that exhibits optical anisotropy developed by orientation of molecules in a liquid crystalline compound. The optically anisotropic layer may have the λ/4 function singly, or have the λ/4 function wholly together with a polymer film which acts as a supporting body.

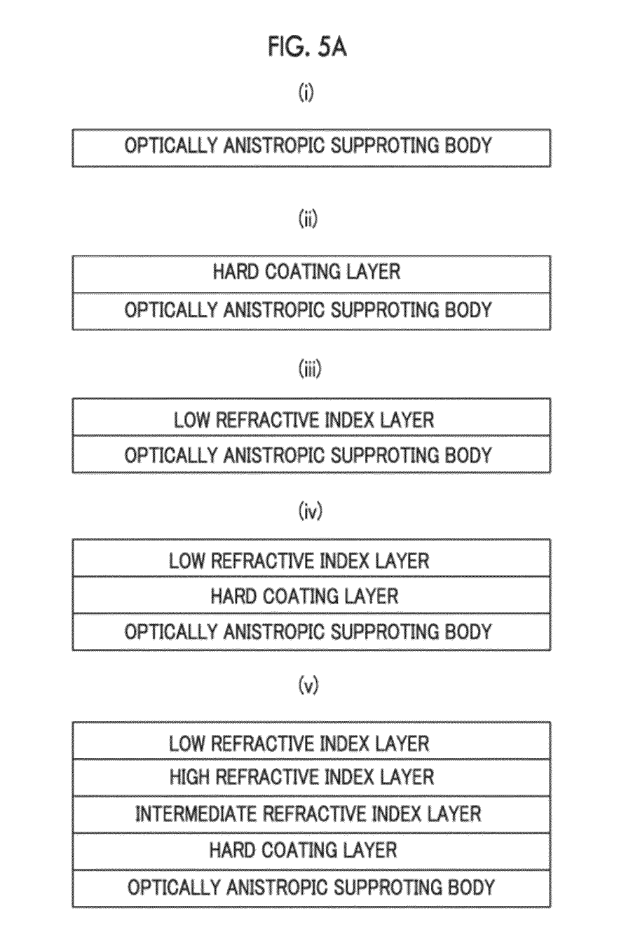

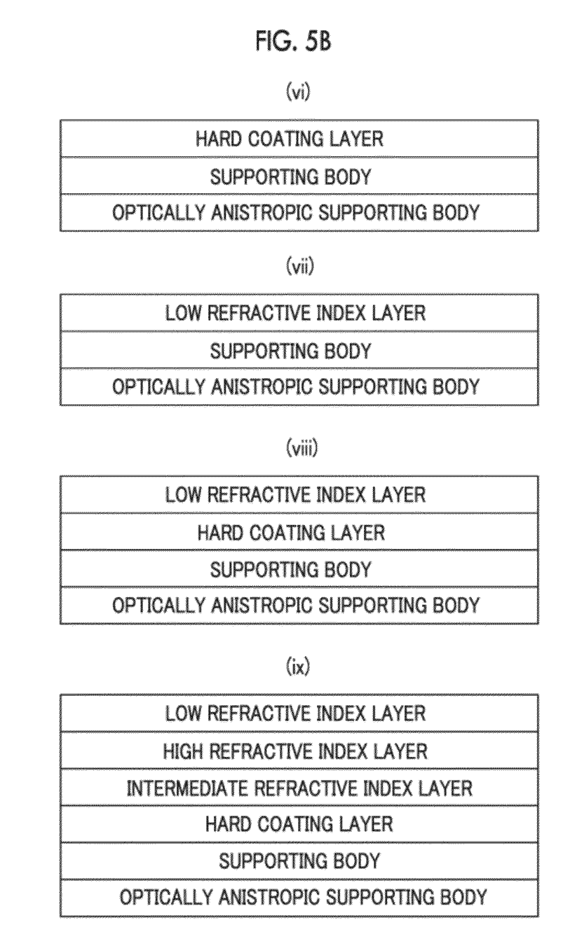

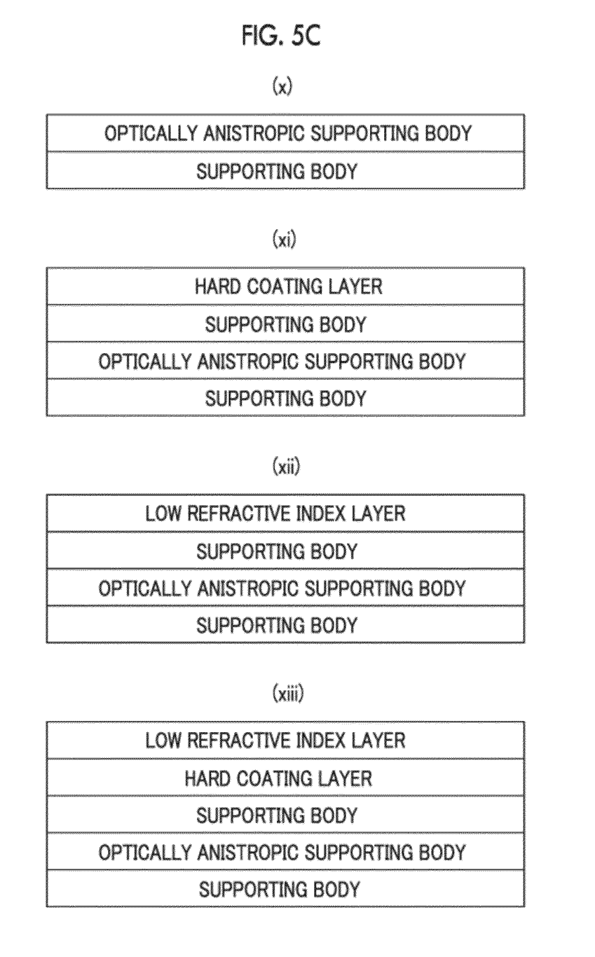

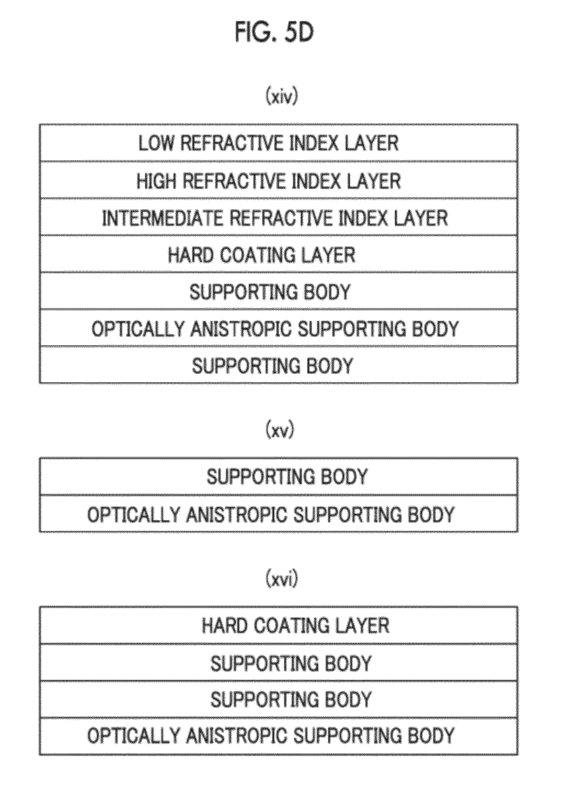

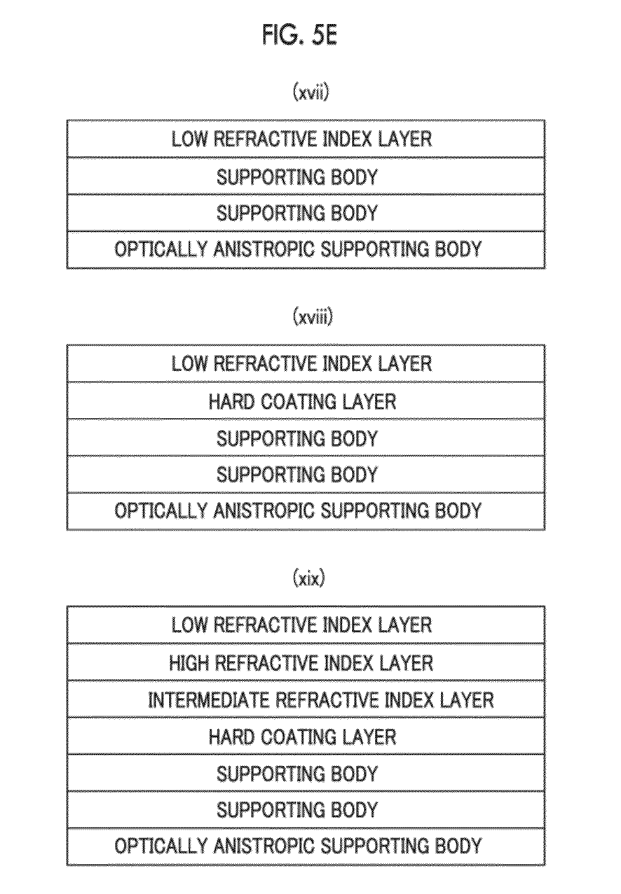

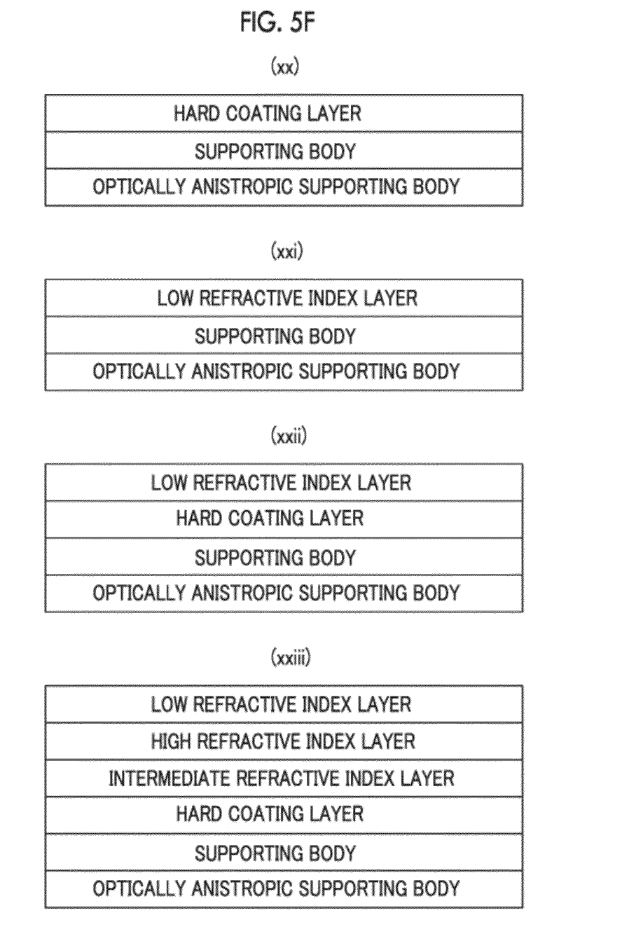

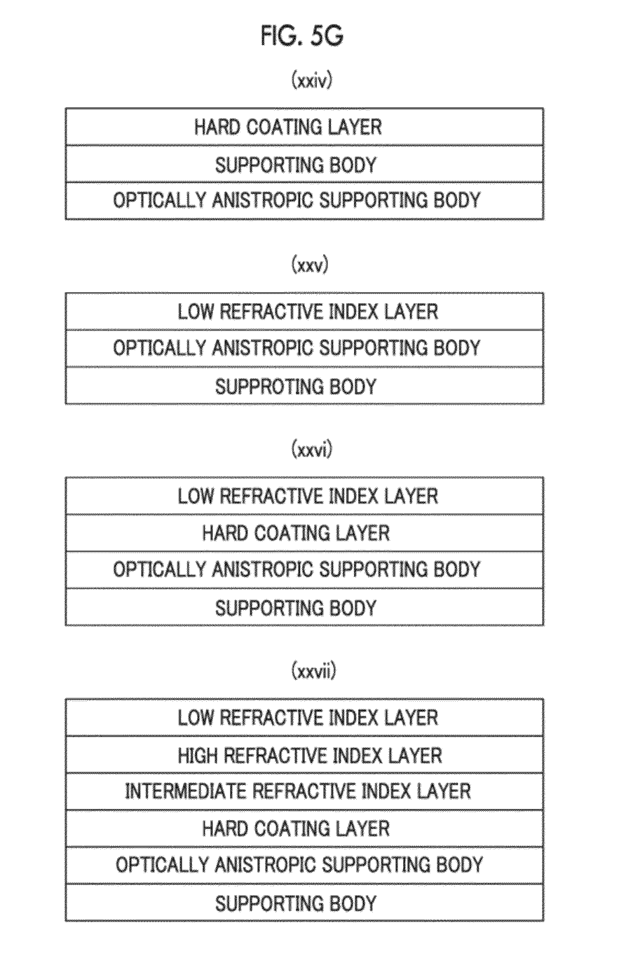

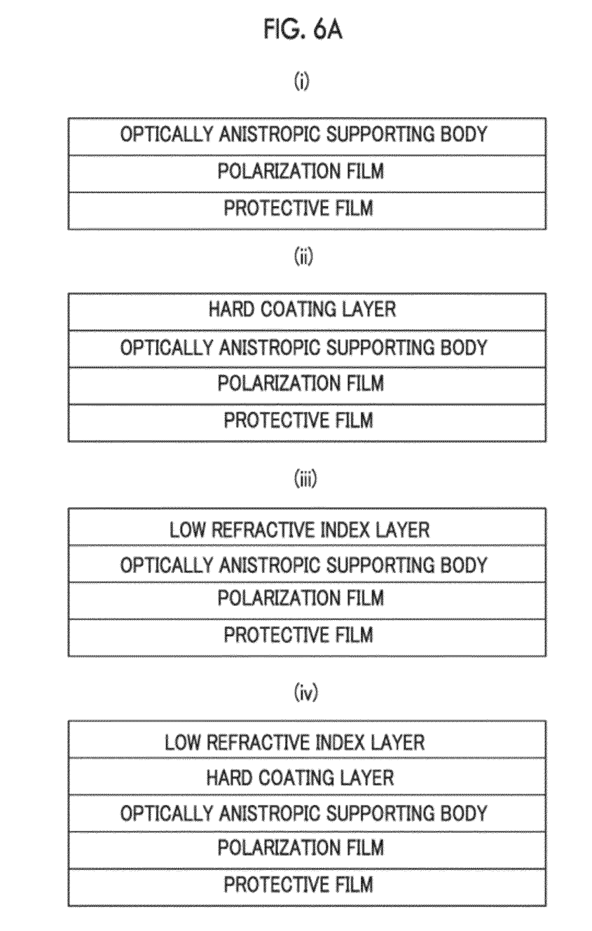

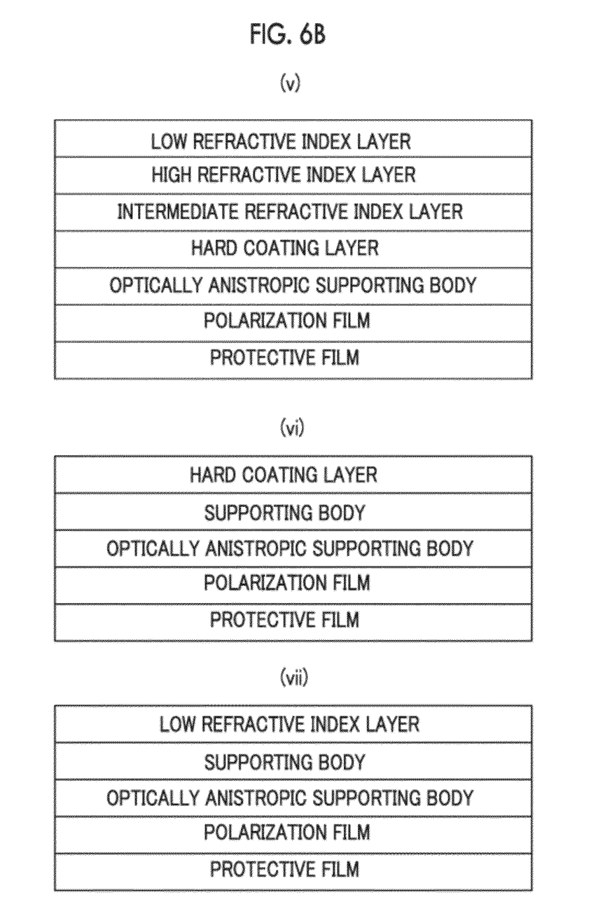

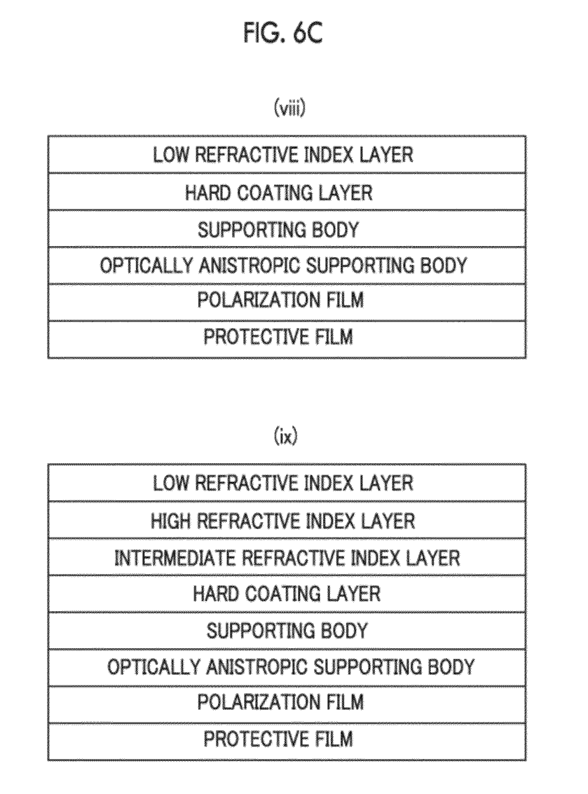

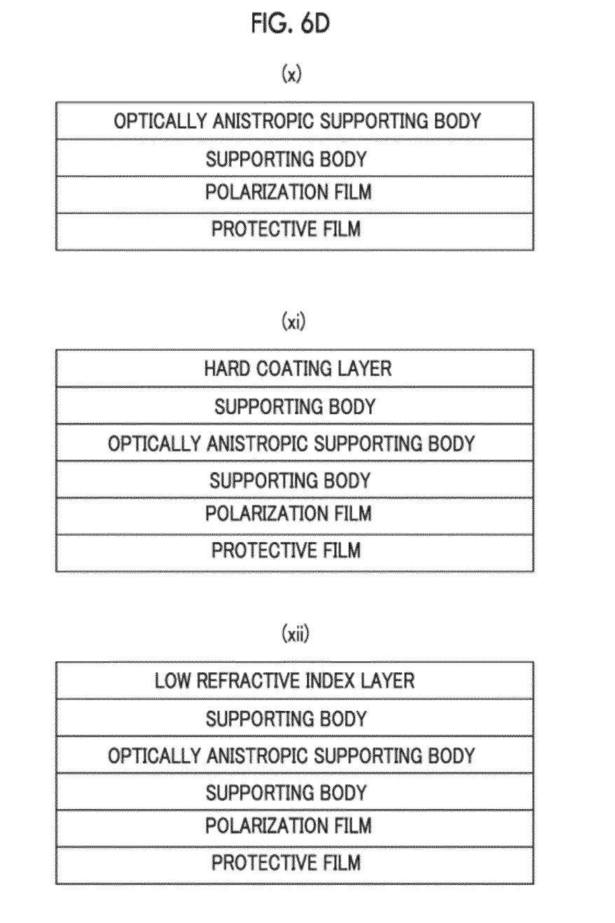

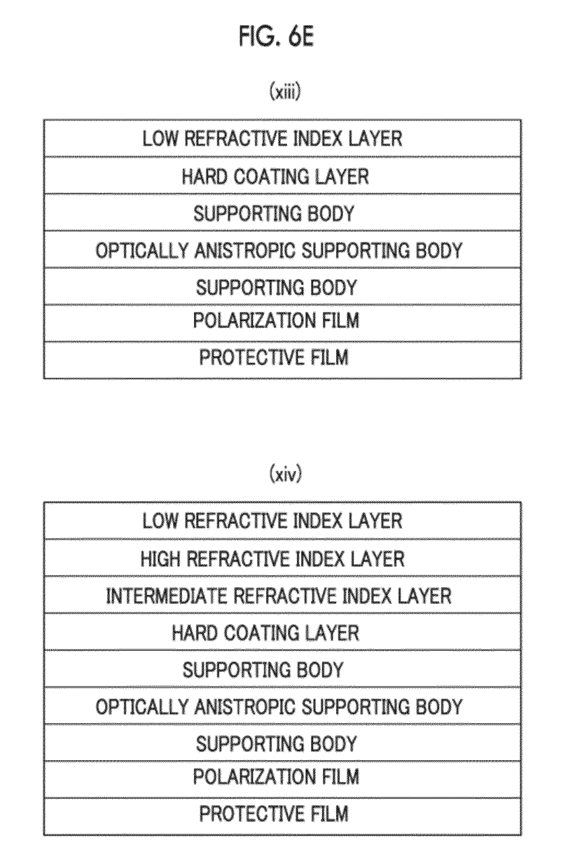

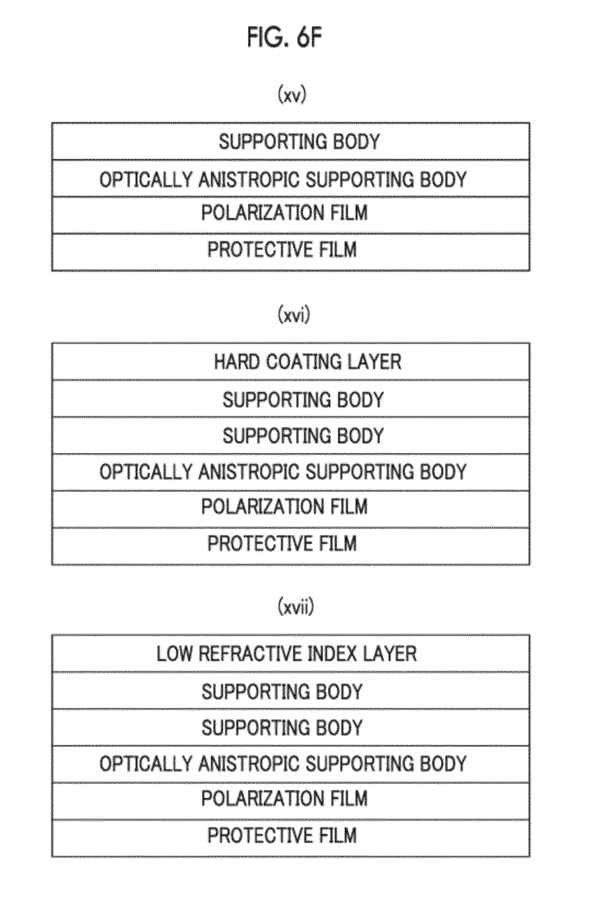

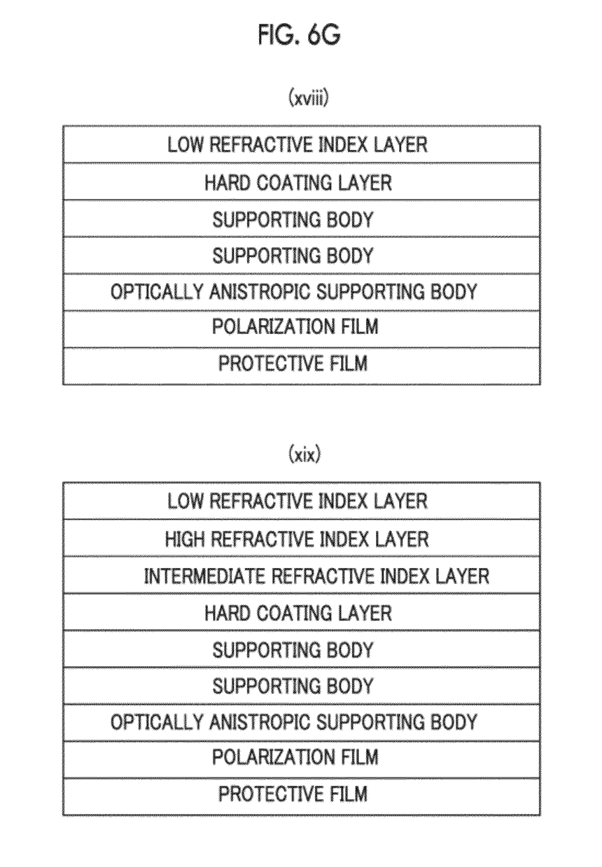

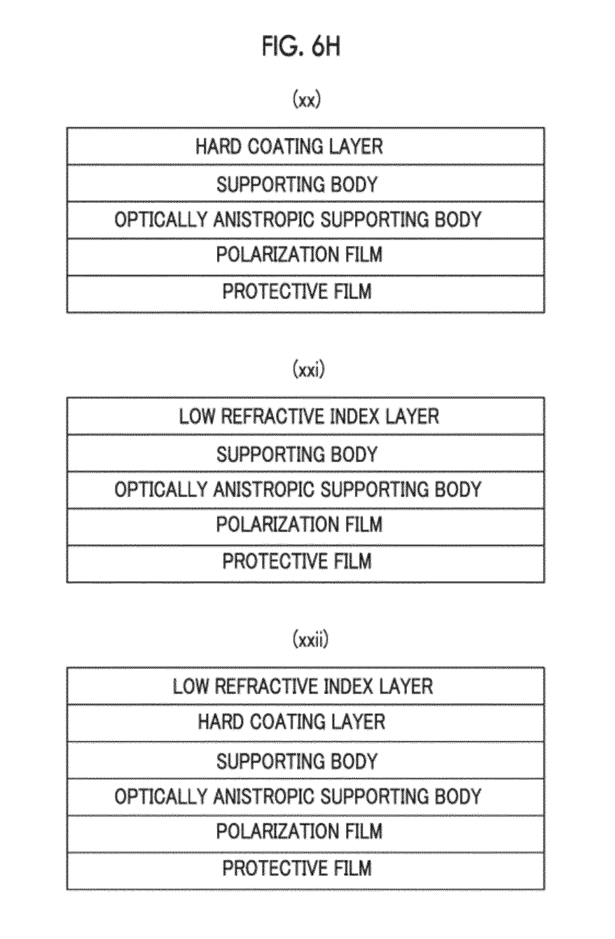

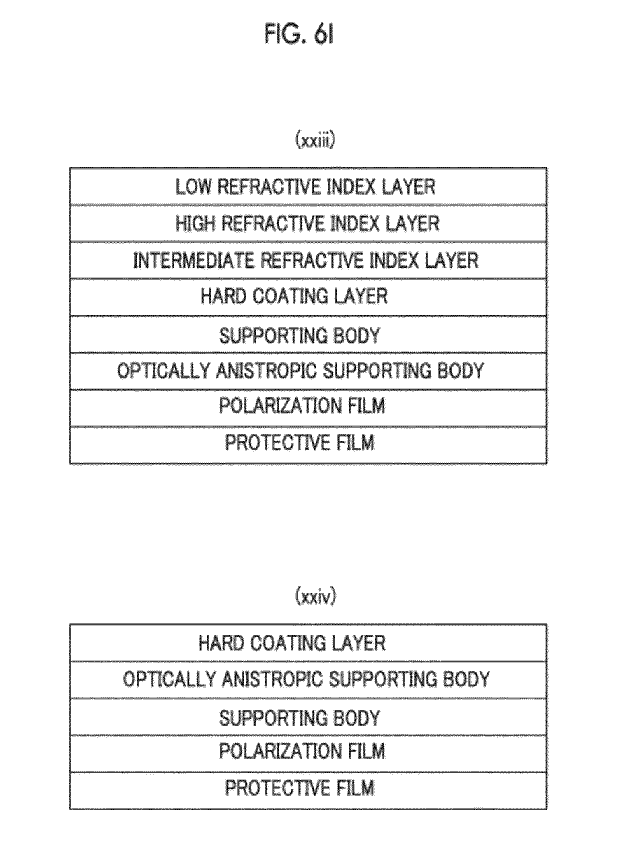

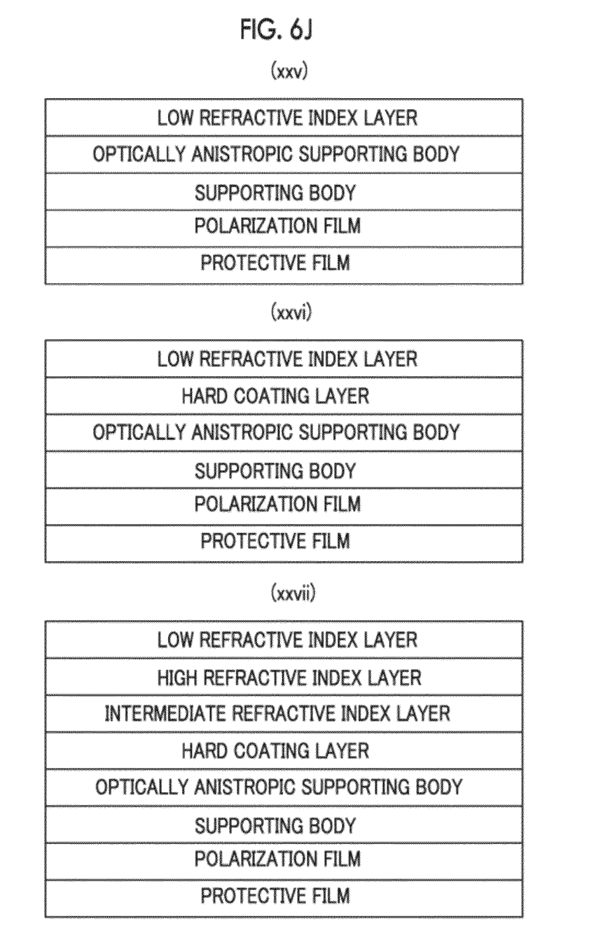

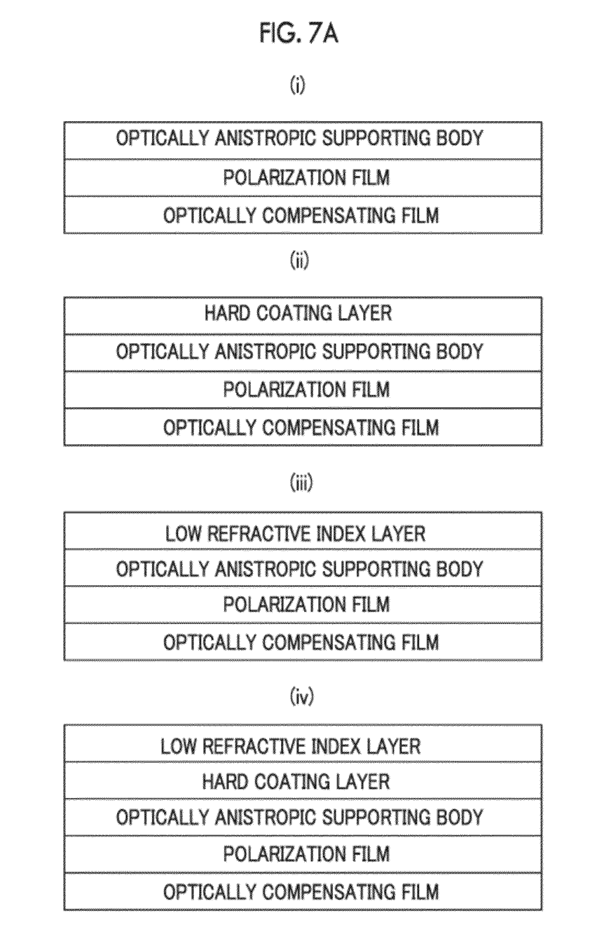

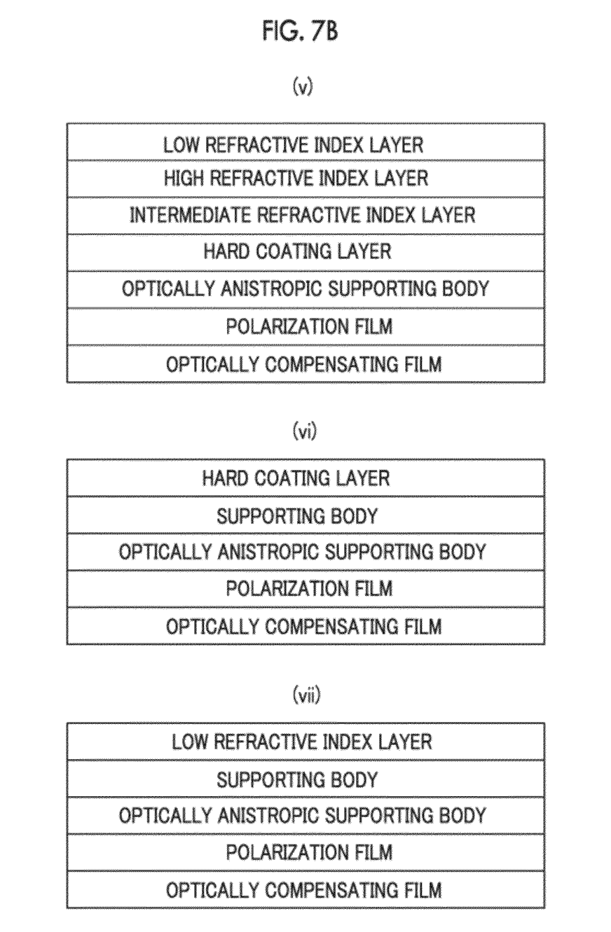

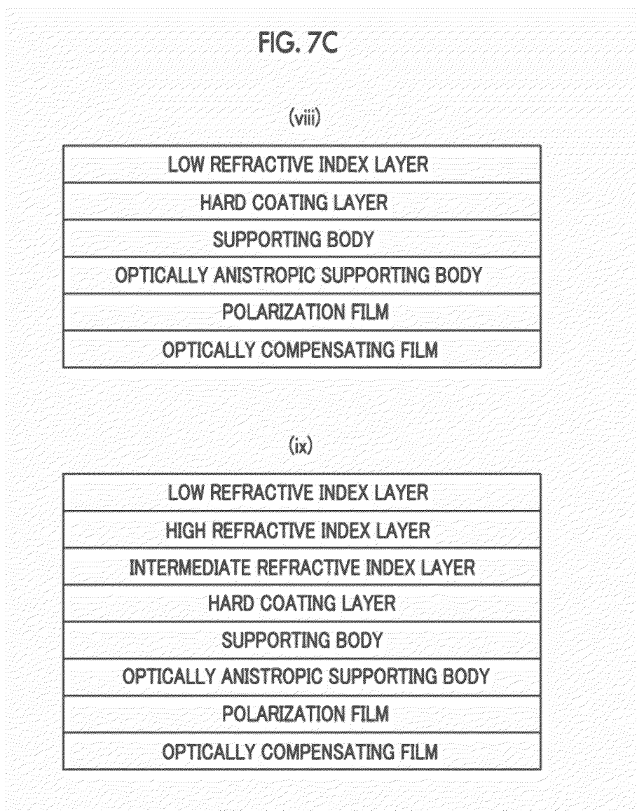

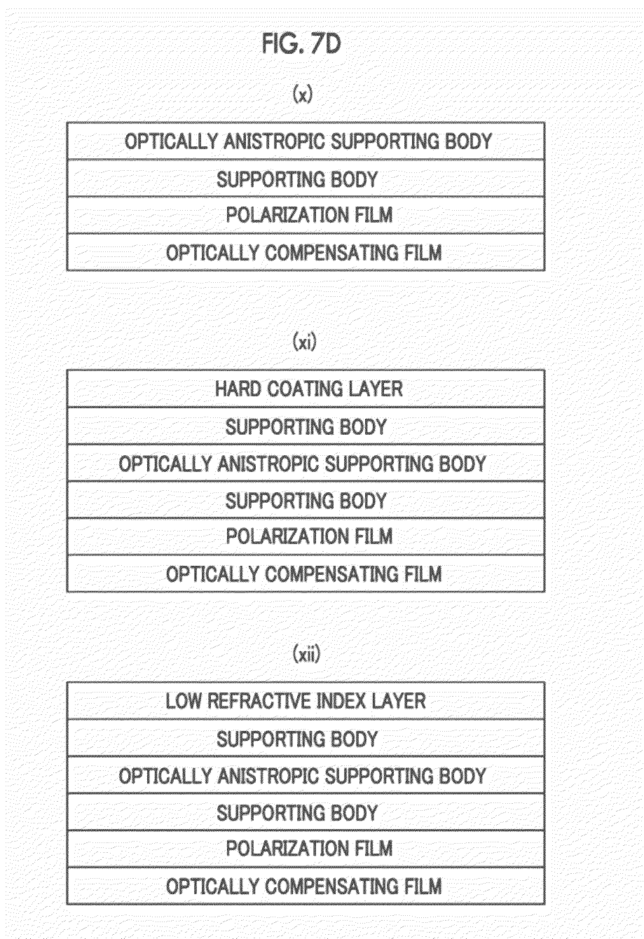

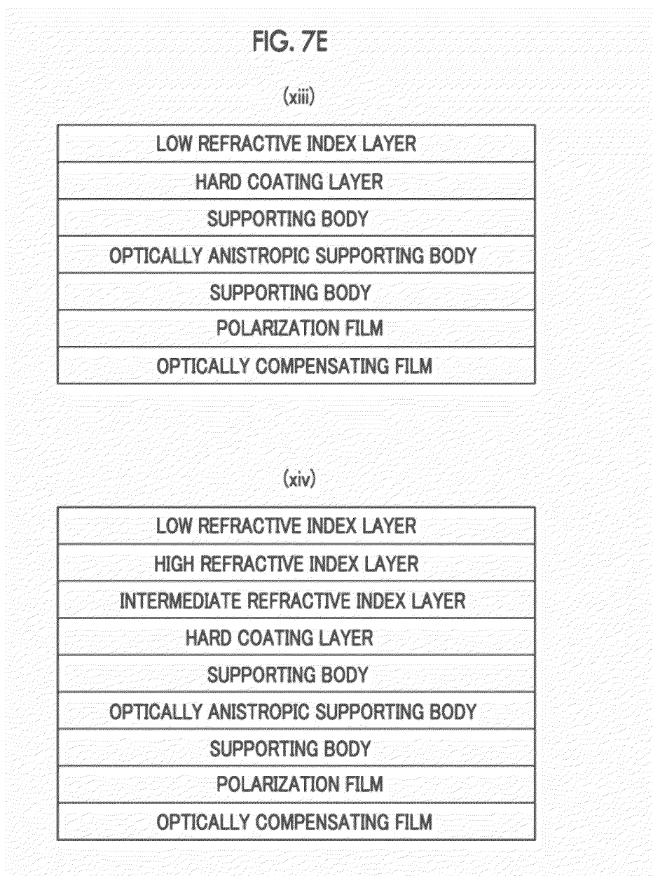

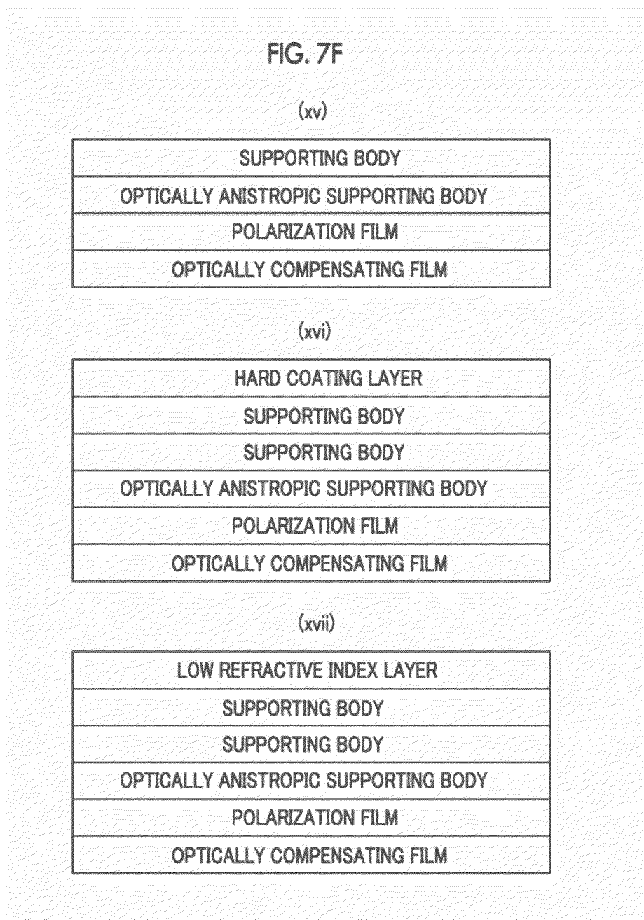

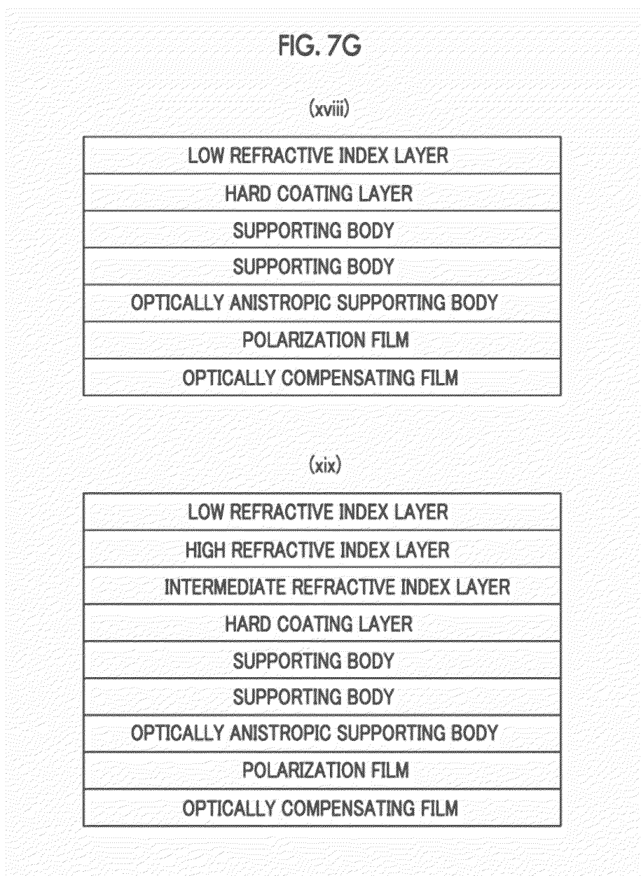

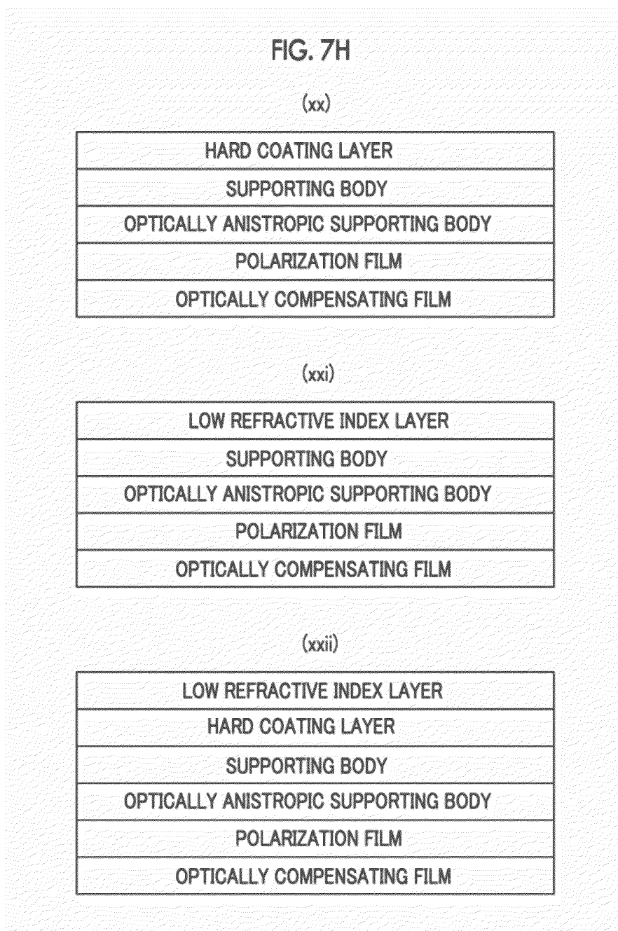

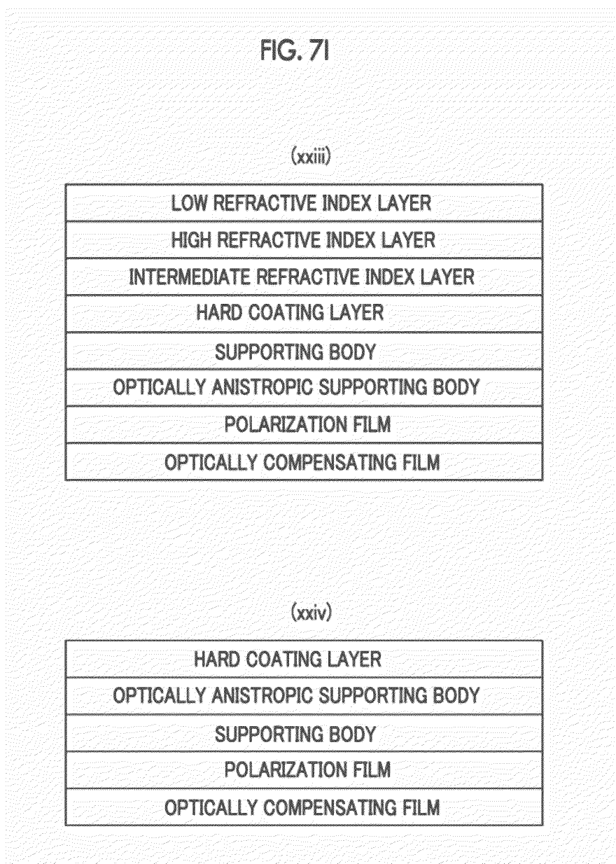

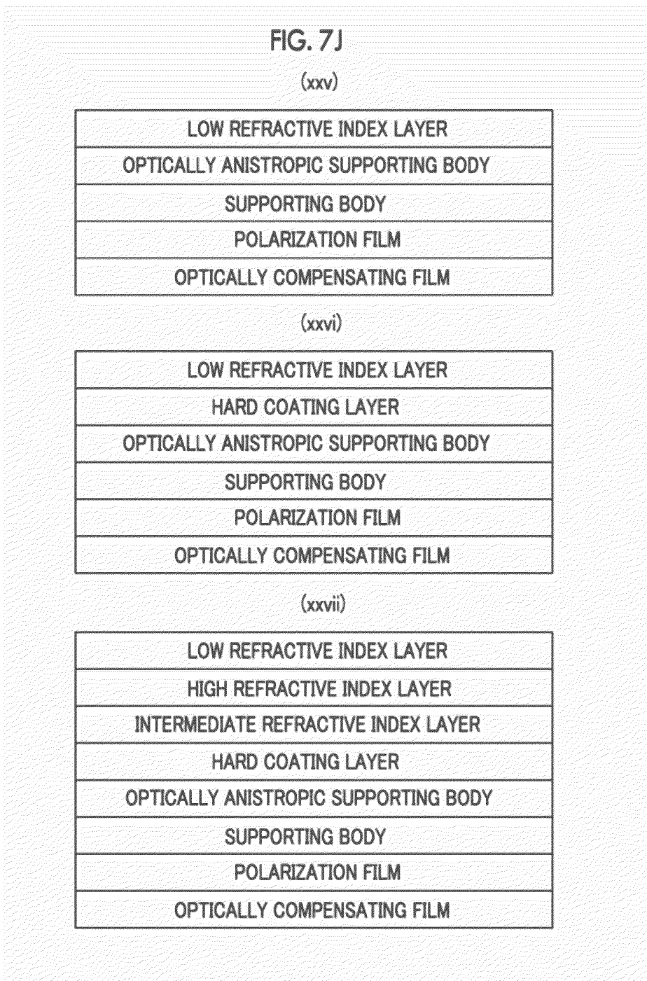

Configuration examples of the protection member and the λ/4 plate will be shown in FIGS. 5A to 5G and below. Meanwhile, in the drawing and the following description, an “optically anisotropic supporting body” refers to a phase difference polymer film, and a “supporting body” includes both a phase difference polymer film and a polymer film for which the phase difference is almost optically isotropic. The above also applies to FIGS. 6A to 7J as described below. In FIGS. 5A to 7J, the first film will be disposed in the protection member as the “optically anisotropic support” and the “supporting body.”

Optically anisotropic supporting body ((i) of FIG. 5A)

Optically anisotropic supporting body/hard coating layer ((ii) of FIG. 5A)

Optically anisotropic supporting body/low refractive index layer ((iii) of FIG. 5A)

Optically anisotropic supporting body/hard coating layer/low refractive index layer ((iv) of FIG. 5A)

Optically anisotropic supporting body/hard coating layer/intermediate refractive index layer/high refractive index layer/low refractive index layer ((v) of FIG. 5A)

Optically anisotropic supporting body/supporting body/hard coating layer ((vi) of FIG. 5B)

Optically anisotropic supporting body/supporting body/low refractive index layer ((vii) of FIG. 5B)

Optically anisotropic supporting body/supporting body/hard coating layer/low refractive index layer ((viii) of FIG. 5B)

Optically anisotropic supporting body/supporting body/hard coating layer/intermediate refractive index layer/high refractive index layer/low refractive index layer ((ix) of FIG. 5B)

Supporting body/optically anisotropic layer ((x) of FIG. 5C)

Supporting body/optically anisotropic supporting body/supporting body/hard coating layer ((xi) of FIG. 5C)

Supporting body/optically anisotropic supporting body/supporting body/low refractive index layer ((xii) of FIG. 5C)

Supporting body/optically anisotropic supporting body/supporting body/hard coating layer/low refractive index layer ((xiii) of FIG. 5C)

Supporting body/optically anisotropic supporting body/supporting body/hard coating layer/intermediate refractive index layer/high refractive index layer/low refractive index layer ((xiv) of FIG. 5D)

Optically anisotropic supporting body/supporting body ((xv) of FIG. 5D)

Optically anisotropic supporting body/supporting body/supporting body/hard coating layer ((xvi) of FIG. 5D)

Optically anisotropic supporting body/supporting body/supporting body/low refractive index layer ((xvii) of FIG. 5E)

Optically anisotropic supporting body/supporting body/supporting body/hard coating layer/low refractive index layer ((xviii) of FIG. 5E)

Optically anisotropic supporting body/supporting body/supporting body/hard coating layer/intermediate refractive index layer/high refractive index layer/low refractive index layer ((xix) of FIG. 5E)

Optically anisotropic supporting body/supporting body/hard coating layer (FIG. 5 (xx) of FIG. 5F)

Optically anisotropic supporting body/supporting body/low refractive index layer ((xxi) of FIG. 5F)

Optically anisotropic supporting body/supporting body/hard coating layer/low refractive index layer ((xxii) of FIG. 5F)

Optically anisotropic supporting body/supporting body/hard coating layer/intermediate refractive index layer/high refractive index layer/low refractive index layer ((xxiii) of FIG. 5F)

Supporting body/optically anisotropic supporting body/hard coating layer ((xxiv) of FIG. 5G)

Supporting body/optically anisotropic supporting body/low refractive index layer ((xxv) of FIG. 5G)

Supporting body/optically anisotropic supporting body/hard coating layer/low refractive index layer ((xxvi) of FIG. 5G)

Supporting body/optically anisotropic supporting body/hard coating layer/intermediate refractive index layer/high refractive index layer/low refractive index layer ((xxvii) of FIG. 5G)

The retardation in the surface of the protection member Re (550) is preferably 100 nm to 175 nm, more preferably 110 nm to 165 nm, and still more preferably 115 nm to 155 nm.

The retardation in the thickness direction Rth (550) is preferably −400 nm to 260 nm, more preferably −200 nm to 160 nm, and still more preferably −90 nm to 90 nm. When the retardations are in the above ranges, it is possible to produce the protection member having the λ/4 function for which the wavelength dependency or incidence angle dependency of light is small. In addition, ideally, wavelength dispersion in which Re becomes λ/4 preferably occurs at any of 450 nm, 550 nm, and 630 nm. That is, the ideal protection member satisfies Re (450)=112.5 nm, Re (550)=137.5 nm, and Re (630)=157.5 nm. Ideally, Rth becomes 0 nm at any wavelength. That is, ideally, Rth (450)=0 nm, Rth (550)=0 nm, and Rth (630)=0 nm are satisfied.

The wavelength dispersion of the entire protection member at Re is preferably 0.80 Re (450)/Re (550)≦1.21 and 0.82≦Re (630)/Re (550)≦1.11, and more preferably (IV) 1.00≦Re (450)/Re (550)≦1.18 and (V) 0.92≦Re (630)/Re (550)≦1.00. When the wavelength dispersion is in the above ranges, the view angle luminance and the view angle crosstalk are mainly dependent on Rth of the entire protection member of the polarization plate on the display side, and a 3D display apparatus that is independent of the wavelength dispersion of Re of the entire protection member.

(1) First Film

The first film needs to have moisture permeability at 40° C. and 90% RH of 100 g/m²/day or less.

The moisture permeability at 40° C. and 90% RH is 100 g/m²/day or less. When the moisture permeability at 40° C. and 90% RH exceeds 100 g/m²/day, it is not possible to improve durability unevenness, which is not preferred, and the moisture permeability at 40° C. and 90% RH is preferably 5 g/m²/day to 100 g/m²/day, and more preferably 15 g/m²/day to 80 g/m²/day. When the moisture permeability is too low, there are cases in which it takes time to remove durability unevenness when slight durability unevenness is caused.

A material for the first film is not particularly limited as long as the moisture permeability at 40° C. and 90% RH is 100 g/m²/day or less, but a cyclic olefin-based polymer film containing a cyclic olefin-based resin as a main component is preferred.

The cyclic olefin-based resin is preferably composed of a polymer resin having a cyclic olefin structure. Examples of the (co)polymer resin having a cyclic olefin structure include (1) norbornene-based polymers, (2) polymers of monocyclic olefins, (3) polymers of cyclic conjugated dienes, (4) vinyl alicyclic hydrocarbon polymers, hydrides of (1) to (4), and the like.

A preferred polymer that can be used for the first film is a cyclic olefin-based resin containing a (co)polymer of a cyclic olefin-based monomer having at least one kind of polar group selected from a group consisting of the following general formula (I), and particularly preferably a cyclic olefin-based resin containing an addition (co)polymer of a cyclic olefin-based monomer having at least one kind of polar group selected from a group consisting of the following general formula (1).

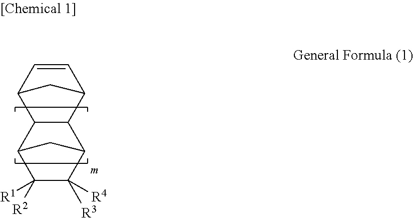

In the general formula (I), m indicates an integer of 0 to 4, at least one of R¹, R², R³, and R⁴ indicates a polar group and the others indicate a nonpolar group, the nonpolar group is a hydrogen atom; a straight or branched alkyl, haloalkyl, alkenyl, or haloakenyl group having 1 to 20 carbon atoms; a straight or branched alkynyl or haloalkynyl group having 3 to 12 carbon atoms; a cycloalkyl group having 3 to 12 carbon atoms that is or is not substituted with an alkyl, alkenyl, alkynyl, haloalkyl, haloalkenyl, or haloalkynyl group or a halogen atom; an aryl group having 6 to 40 carbon atoms that is or is not substituted with an alkyl, alkenyl, alkynyl, haloalkyl, haloalkenyl, or haloalkynyl group or a halogen atom; or an aralkyl group having 7 to 15 carbon atoms that is or is not substituted with an alkyl, alkenyl, alkynyl, haloalkyl, haloalkenyl, or haloalkynyl group or a halogen atom, a polar group is a nonhydrocarbon group including at least one or more oxygen atoms, nitrogen atoms, phosphorous atoms, sulfur atoms, or boron atoms, and is one selected from —R⁵OR⁶, —OR⁶, —OC(O)OR⁶, —R⁵OC(O)OR⁶, —C(O)R⁶, —R⁵C(O)OR⁶, —C(O)R⁶, —R⁵C(O)OR⁶, —C(O)OR⁶, —(R⁵⁰)ₖ—OR⁶, —OC(O)R⁶, —R⁵OC(O)R⁶, R⁵SSR⁶, —S(═O)R⁶, —R⁵S(═O)R⁶, —R⁵C(═S)R⁶, —R⁵C(═S)SR⁶, —R⁵SO₃R⁶, —SO₃R⁶, —R⁵N═C═S, —NCO, R⁵—NCO, —CN, —R⁵CN, —NNC(═S)R⁶, —R⁵NNC(═S)R⁶, —NO₂, and —R⁵NO₂,

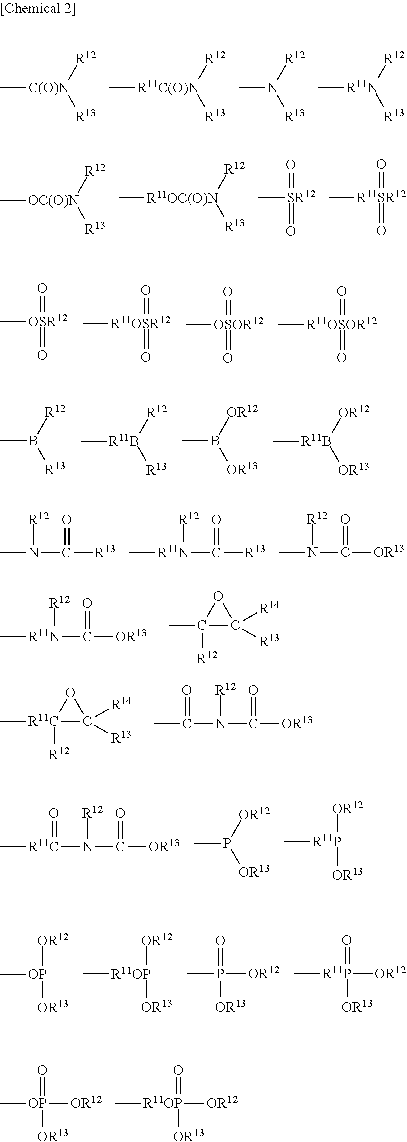

herein, R⁵ and R¹¹ is a straight or branched alkylene, haloalkylene, alkenylene, or haloalkenylene having 1 to 20 carbon atoms; a straight or branched alkynylene, or haloalkynylene having 3 to 20 carbon atoms; a cycloalkylene having 3 to 12 carbon atoms that is or is not substituted with an alkyl, alkenyl, alkynyl, halogen atom, haloalkyl, haloalkenyl, or haloalkynyl; an arylene having 6 to 40 carbon atoms that is or is not substituted with an alkyl group, an alkenyl group, an alkynyl group, a halogen atom, a haloalkyl group, a haloalkenyl group, or a haloalkynyl group; or an aralkylene group having 7 to 15 carbon atoms that is or is not substituted with an alkyl group, an alkenyl group, an alkynyl group, a halogen atom, a haloalkyl group, a haloalkenyl group, or a haloalkynyl group, R⁶, R¹², R¹³, and R¹⁴ respectively are a hydrogen atom; a halogen atom; a straight or branched alkyl, haloalkyl, alkenyl, or haloalkenyl having 1 to 20 carbon atoms; a straight or branched alkynyl or haloalkynyl having 3 to 20 carbon atoms; a cycloalkylene having 3 to 12 carbon atoms that is or is not substituted with an alkyl, alkenyl, alkynyl, halogen atom, haloalkyl, haloalkenyl, or haloalkynyl; an aryl having 6 to 40 carbon atoms that is or is not substituted with an alkyl, alkenyl, alkynyl, halogen atom, haloalkyl, haloalkenyl, or haloalkynyl; an aralkyl having 7 to 15 carbon atoms that is or is not substituted with an alkyl, alkenyl, alkynyl, halogen atom, haloalkyl, haloalkenyl, or haloalkynyl; or alkoxy, carbonylalkoxy, or halocarbonylalkoxy, and k indicates an integer of 1 to 10.

The protective film that is used in the invention is preferably composed of a polymer resin having a cyclic olefin structure. Examples of the polymer resin having a cyclic olefin structure include (1) norbornene-based polymers, (2) monocyclic olefin polymers, (3) polymers of cyclic conjugated diene, (4) vinyl alicyclic hydrocarbon polymers, hydrides of (1) to (4), and the like. Preferred polymers that are used in the protective film of the invention are norbornene-based (co)polymers.

Specific examples of the norbornene-based (co)polymers include ring-opening polymers of norbornene-based monomers, ring-opening polymers of norbornene-based monomers and other monomers that can form ring-opening polymers, hydrogen additives thereof, addition polymers of norbornene-based monomers, addition copolymers of norbornene-based monomers and other monomers that can form ring-opening polymers, and the like. Among them, addition (co)polymers and ring-opening (co)polymer hydrogen additives of norbornene-based monomers are most preferred from the viewpoint of transparency or moisture-permeating properties.

The norbornene-based addition (co)polymers are disclosed in the specifications of JP1998-7732 (JP-H10-7732) and JP2002-504184, the pamphlet of US Patent App. No. 2004/229157, WO2004/070463, and the like, and are obtained by addition-polymerizing norbornene-based polycyclic unsaturated compounds. In addition, the norbornene-based addition (co)polymers can also be obtained by, according to necessity, addition-polymerizing a norbornene-based polycyclic unsaturated compound and a linear diene compound, such as ethylene, propylene, butene; a conjugated diene, such as butadiene and isoprene; an unconjugated diene, such as ethylidene and norbornene; acrylonitrile, acrylic acid, methacrylic acid, maleic acid anhydride, an acrylic acid ester, a methacrylic acid ester, maleimide, vinyl acetate, vinyl chloride, or the like. The norbornene-based addition (co)polymers have been launched by Mitsui Chemicals, Inc. under a trade name of APEL, and have grades with different glass transition temperature (Tg), for example, APL8008T (Tg 70° C.), APL6013T (Tg 125° C.), APL6015T (Tg 135° C.), and the like. Polyplastics Co., Ltd. has launched pellets of TOPAS 8007 (Tg 80° C.), TOPAS 6013 (Tg 140° C.), TOPAS 6015 (Tg 160° C.), and the like. Furthermore, Ferrania S.p.A has launched APPEAR3000 (Tg 330° C.).

Hydrides of the norbornene-based ring-opening polymers are produced by causing addition polymerization or metathesis ring-opening polymerization of a polycyclic unsaturated compound, and then adding hydrogen to the polymer as disclosed in JP1989-240517 (JP-H1-240517), JP1995-196736 (JP-H7-196736), JP1985-26024 (JP-S60-26024), JP1987-19801 (JP-S62-19801), JP2003-1159761, JP2004-309979, and the like. The norbornene-based resins have been available since JSR Corporation launched ARTON G or ARTON F (trade names), and Zeon Corporation commercially launched ZEONOR750R, 1020R, 1600, ZEONEX 250 or 280 (trade names).

A variety of additives (for example, an anti-deterioration agent, an ultraviolet protector, fine particles, a separation promoter, an ultraviolet absorbent, and the like) can be added to the first film in each of the preparation processes, and the additives may be solid or oily substances. That is, the melting point or boiling point of the additive is not particularly limited. Examples include mixing of ultraviolet-absorbing materials having melting points or boiling points of 20° C. or lower and 20° C. or higher and mixing of anti-deterioration agents in the same manner. Furthermore, ultraviolet absorbing dyes are described in, for example, JP2001-194522. In addition, the additives may be added at any step in the manufacturing process of a cyclic olefin-based resin solution (dope), and may be added by adding a process in which the additives are added to the final preparation process of the dope preparation process. Furthermore, the added amounts of the respective materials are not particularly limited as long as the functions are developed. In addition, in a case in which the cyclic olefin-based resin film is formed in a multilayer configuration, the kinds or added amounts of a variety of additives may be different.

In an aspect in which the first film is a cyclic olefin-based polymer film, there are cases in which the adhesion properties to the anti-reflection layer disposed as the surface layer or the adhesion properties to the optically anisotropic layer composed of a liquid crystal composition as described below are weak. Therefore, the adhesion properties to the surface layer and the like of the cyclic olefin-based polymer film that is used as the first film are preferably improved by carrying out a surface treatment or forming an easy-adhesion layer. In addition, the adhesion properties may be improved by disposing a cellulose acylate-based film between the surface layer, such as the anti-reflection layer, and the cyclic olefin-based polymer film or between the cyclic olefin-based polymer film and the optically anisotropic layer.

(2) Polymer Film

A material for the phase difference polymer film or a polymer film that is used as the supporting body of the optically anisotropic layer is not particularly limited. The material includes a variety of polymer films, for example, cellulose acylate (for example, a cellulose triacetate film, a cellulose diacetate film, a cellulose acetate butylate film, and a cellulose acetate propionate film), polyester-based polymers, such as polycarbonate-based polymers, polyethylene terephthalate, and polyethylene naphthalate, acryl-based polymers, such as polymethyl methacrylate, styrene-based polymers, such as polystyrene or acrylonitrile styrene copolymers (AS resins), polyolefin, such as polyethylene and polypropylene, cyclic olefin-based polymers, such as norbornene, polyolefin-based polymers, such as ethylene-propylene copolymers, vinyl chloride-based polymers, amide-based polymers, such as nylon or aromatic polyamides, imide-based polymers, sulfone-based polymers, polyether sulfone-based polymers, polyether ether ketone-based polymers, polyphenylene sulfide-based polymers, vinylidene chloride-based polymers, vinyl alcohol-based polymers, vinyl butyral-based polymers, arylate-based polymers, polyoxy-methylene-based polymers, epoxy-based polymers, mixtures of polymers, and the like. It is possible to use one or two or more polymers as main components. Commercially available products may be used, and ARTON (manufactured by ISR Corporation), which is a cyclic olefin-based polymer, ZEONEX (manufactured by Zeon Corporation), which is an amorphous polyolefin, and the like may also be used. Among them, triacetyl cellulose, polyethylene terephthalate, and cyclic olefin-based polymers are preferred, and acetyl cellulose is particularly preferred.

A method of manufacturing the phase difference polymer film is not particularly limited. Any of the solution film-making method and the melting film-making method can be used. In order to obtain desired characteristics, a stretching treatment may be carried out after a film is made. In addition, in a case in which an optically anisotropic layer composed of a liquid crystal composition is formed, the polymer film may be subjected to a surface treatment (for example, a glow discharge treatment, a corona discharge treatment, an ultraviolet (UV) treatment, a flame treatment, or a saponification treatment).

The thickness of the phase difference polymer film is not particularly limited, and a phase difference polymer film having a thickness of approximately, in general, 25 μm to 1000 μm is used.

Meanwhile, a polymer film that is used as the supporting body of the optically anisotropic layer composed of the liquid crystal composition as described below may have a low Re, for example, 0 nm to 50 nm, 0 nm to 30 nm, or 0 nm to 10 nm. In addition, Rth of the polymer film that is used as the supporting body is also not particularly limited, and may be, for example, −300 nm to 300 nm, −100 nm to 200 nm, or −60 nm to 60 nm. The optical characteristics of the supporting body are preferably selected according to the combination with the optically anisotropic layer provided thereon.

The Re and Rth of the supporting body can be adjusted using a variety of well-known retardation adjusters, stretching, and the like.

(3) Optically Anisotropic Layer Including a Liquid Crystalline Compound

The protection member or the λ/4 layer may have one or more optically anisotropic layers composed of a composition containing a liquid crystalline compound. The kind of the liquid crystalline compound is not particularly limited. For example, it is possible to use an optically anisotropic layer obtained by forming a low molecular liquid crystalline compound in a nematic orientation in a liquid crystalline state, and then fixing the compound through photocrosslinking or thermal crosslinking or an optically anisotropic layer obtained by forming a high molecular liquid crystalline compound in a nematic orientation in a liquid crystalline state, and then fixing the orientation by cooling the compound. Meanwhile, in the invention, even in a case in which a liquid crystalline compound is used for the optically anisotropic layer, the optically anisotropic layer is a layer formed by fixing the liquid crystalline compound through polymerization or the like, and the compound does not need to exhibit liquid crystalline properties after becoming a layer. The polymerizable liquid crystalline compound may be a multifunctional polymerizable liquid crystal or a monofunctional polymerizable liquid crystalline compound. In addition, the liquid crystalline compound may be a discotic liquid crystalline compound or a rod-shaped liquid crystalline compound.

In the optically anisotropic layer, molecules in the liquid crystalline compound are preferably fixed in any orientation state of a vertical orientation, a horizontal orientation, a hybrid orientation, and an inclined orientation. One example is a substantially vertical orientation of the disc surface of the discotic liquid crystalline compound with respect to the film surface (the surface of the optically anisotropic layer), and another example is a substantially horizontal orientation of the long axis of the rod-shaped liquid crystalline compound with respect to the film surface (the surface of the optically anisotropic layer). The substantially vertical discotic liquid crystalline compound means that the average value of angles formed between the film surface (the surface of the optically anisotropic layer) and the disc surface of the discotic liquid crystalline compound is in a range of 70° to 90°, more preferably 80° to 90°, and still more preferably 85° to 90°. The substantially horizontal rod-shaped liquid crystalline compound means that the angle formed between the film surface (the surface of the optically anisotropic layer) and the director of the rod-shaped liquid crystalline compound is in a range of 0° to 20°, more preferably 0° to 10°, and still more preferably 0° to 5°.

In a case in which an optical retardation film in which molecules in a liquid crystalline compound are hybrid-oriented so as to have asymmetric view angle dependency is manufactured, the average inclination angle of the director of the liquid crystalline compound is preferably in a range of 5° to 85°, more preferably 10° to 80°, and still more preferably 15° to 75°.

The optically anisotropic layer can be formed by coating a liquid crystalline compound, such as the rod-shaped liquid crystalline compound or the disc-shaped (discotic) liquid crystalline compound, and, if desired, a coating fluid including a polymerization initiator, an orientation controlling agent, and other additives as described below on the supporting body. The optically anisotropic layer is preferably formed by forming an oriented film on the supporting body, and coating a coating fluid on the surface of the oriented film.

[Rod-Shaped Liquid Crystalline Compound]

A rod-shaped liquid crystalline compound may be used to form the optically anisotropic layer having the λ/4 film. As the rod-shaped liquid crystalline compound, azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyl dioxanes, tolans and alkenylcyclohexyl benzonitriles are preferably used. It is also possible to use a high-molecular liquid crystalline compound as well as the above low-molecular liquid crystalline compounds. It is more preferable to fix the orientation of the rod-shaped liquid crystalline compound through polymerization. Liquid crystalline compounds having partial structures in which a polymerization or crosslinking reaction can be caused by active light rays, an electron beam, heat, or the like are preferably used. The number of the partial structures is preferably 1 to 6, and more preferably 1 to 3. The polymerizable rod-shaped liquid crystalline compounds that can be used include compounds as described in Makromol. Chem., Vol. 190, p 2255 (1989), Advanced Materials Vol. 5, p 107 (1993), U.S. Pat. No. 4,683,327A, U.S. Pat. No. 5,622,648A, U.S. Pat. No. 5,770,107A, WO95/22586, WO95/24455, WO97/00600, WO98/23580, WO98/52905, JP1989-272551 (JP-H1-272551), JP1994-16616 (JP-H6-16616), JP1995-110469 (JP-H7-110469), JP2008-80081 (JP-H11-80081), JP2001-328973, and the like.

[Discotic Liquid Crystalline Compound]

In the invention, it is preferable to use a discotic liquid crystalline compound to form the optically anisotropic layer having an optical film. The discotic liquid crystalline compound is described in a variety of publications (C. Destrade et al., Mol. Cryst. Liq. Cryst., Vol. 71, page 111 (1981); Quarterly Outline of Chemistry, No. 22, Chemistry of Liquid Crystal, Chap. 5, Chap. 10, Sec. 2 (1994), by the Chemical Society of Japan; B. Kohne et al., Angew. Chem. Soc. Chem. Comm., page 1794 (1985); J. Zhang et al., J. Am. Chem. Soc., Vol. 116, page 2655 (1994)). Polymerization of the discotic liquid crystalline compound is described in JP1996-27284 (JP-H8-27284).

The discotic liquid crystalline compound preferably has a polymerizable group so as to be fixable through polymerization. For example, a structure in which a polymerizable group is bonded to the disc-shaped core of the discotic liquid crystalline compound as a substituent can be considered; however, when the polymerizable group is directly bonded to the disc-shaped core, it becomes difficult to maintain the orientation state during a polymerization reaction. That is, the discotic liquid crystalline compound having a polymerizable group is preferably a compound represented by the following formula.

D(-L-P)ₙ

In the formula, D represents a discotic core, L represents a divalent linking group, P represents a polymerizable group, and n is an integer of 1 to 12. Preferred specific examples of the discotic core (D), the divalent linking group (L), and the polymerizable group (P) are (D1) to (D15), (L1) to (L25), and (P1) to (P18) respectively as described in JP2001-4837, and the contents of JP2001-4837 can be preferably used. Meanwhile, the discotic nematic liquid crystal phase-solid phase transition temperature of the liquid crystalline compound is preferably 30° C. to 300° C., and more preferably 30° C. to 170° C.

Since the discotic liquid crystalline compound represented by the following formula (I) has low wavelength dispersion properties of the retardation in the surface, can develop high retardation in the surface, and can achieve a vertical orientation excellent in terms of evenness at a high average inclination angle without using a special oriented film or additive, the discotic liquid crystalline compound is preferably used to form the optical anisotropic layer. Furthermore, the coating fluid containing the liquid crystalline compound tends to have a relatively low viscosity, the coating properties are favorable, which is preferred

(1)-1 Discotic Liquid Crystalline Compound Represented by the General Formula (I)

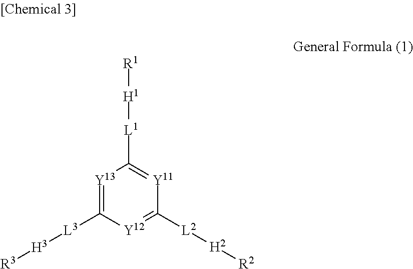

In the formula, Y¹¹, Y¹², and Y¹³ respectively represent methane or a nitrogen atom that may be substituted; L¹, L², and L³ respectively represent a single bond or a divalent coupling group; H¹, H², and H³ respectively represent a group of the general formula (I-A) or (I-B); and R¹, R², and R³ respectively represent the following general formula (I-R).

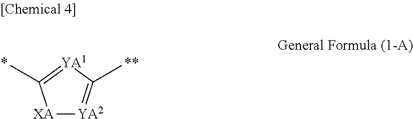

In the general formula (I-A), YA¹ and YA² respectively represent methane or a nitrogen atom; XA represents an oxygen atom, a sulfur atom, methane, or imino; * represents locations that bond with L¹ to L³ sides in the general formula (I); and ** represents locations that bond with R¹ to R³ sides in the general formula (I).

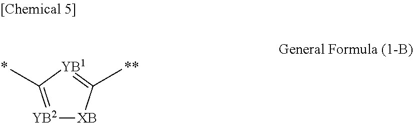

In the general formula (I-B), YB¹ and YB² respectively represent methane or a nitrogen atom; XB represents an oxygen atom, a sulfur atom, methane, or imino; * represents locations that bond with L¹ to L³ sides in the general formula (I); and ** represents locations that bond with R¹ to R³ sides in the general formula (I).

*-(-L²¹-Q²)ₙ₁-L²²-L²²-L²³-Q¹ General formula (I-R)

In the general formula (I-R), * represents locations that bond with H¹ to H³ sides in the general formula (I); L²¹ represents a single bond or a divalent coupling group; Q² represents a divalent group (cyclic group) having at least one kind of cyclic structure; n1 represents an integer of 0 to 4; L²² represents **—O—, **—O—CO—, **—CO—O—, **—O—CO—O—, **—S—, **—NH—, **—SO₂—, **—CH₂—, **—CH═CH— or **—C═C—; L²³ represents —O—, —S—, —C(═O)—, —SO₂—, —NH—, —CH₂—, —CH═CH— and —C≡C— and a divalent coupling group selected from a group composed of combinations thereof; and Q′ represents a polymerizable group or a hydrogen atom.

Paragraphs [0013] to [0077] of JP2010-244038 can be referenced for the preferred ranges of the respective symbols of the 3-substituted benzene-based discotic liquid crystalline compound represented by the formula (I) and specific examples of the compound represented by the formula (I). However, the discotic liquid crystalline compound that can be used in the invention is not limited to the 3-substituted benzene-based discotic liquid crystalline compound of the formula (I).

Triphenylene compounds include the compounds as described in paragraphs [0062] to [0108] of JP2007-108732, but the invention is not limited thereto.

Meanwhile, together with the 3-substituted benzene-based or triphenylene compound, at least one kind of the pyridinium compound represented by the following general formula (II) (more preferably the general formula (II′)) and at least one kind of compounds including the triazine ring group represented by the following general formula (III) may be contained. The added amount of the pyridinium compound is preferably 0.5 parts by mass to 3 parts by mass with respect to 100 parts by mass of the discotic liquid crystalline compound. In addition, the added amount of the compound including the triazine ring group is preferably 0.2 parts by mass to 0.4 parts by mass with respect to 100 parts by mass of the discotic liquid crystalline compound.

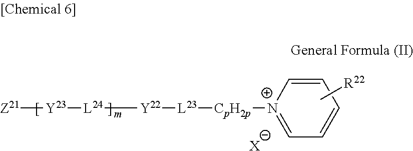

In the formula, L²³ and L²⁴ are a divalent linking group respectively; R²² is a hydrogen atom, an unsubstituted amino group, or a substituted amino group having 1 to 20 hydrogen atoms; X is an anion; Y²² and Y²³ are a divalent linking group having a 5 or 6-membered ring which may be substituted as the partial structure respectively; Z²¹ is a monovalent group selected from a group consisting of halogen-substituted phenyl, nitro-substituted phenyl, cyano-substituted phenyl, phenyl substituted with an alkyl group having 1 to 10 hydrogen atoms, phenyl substituted with an alkoxy group having 2 to 10 carbon atoms, an alkyl group having 1 to 12 carbon atoms, an alkynyl group having 2 to 20 carbon atoms, an alkoxy group having 1 to 12 carbon atoms, an alkoxy carbonyl group having 2 to 13 carbon atoms, an aryloxy carbonyl group having 7 to 26 carbon atoms, and an aryl carbonyloxy group having 7 to 26 carbon atoms; p is an integer of 1 to 10; and m is 1 or 2.

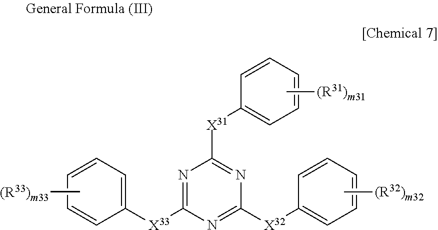

In the formula, R³¹, R³², and R³³ represent an alkyl group or alkoxy group having a CF₃ group at the terminal, but two or more hydrogen atoms that are not adjacent in the alkyl group (including the alkyl group in the alkoxy group) may be substituted with an oxygen atom or a sulfur atom; X³¹, X³², and X³³ represent a group obtained by combining at least two of an alkylene group, —CO—, —NH—, —O—, —S—, —SO₂—, and a divalent linking group selected from a group thereof; and m31, m32, and m33 are a number of 1 to 5 respectively. In the formula (III), R³¹, R³², and R³³ are preferably a group represented by the following formula.

—O(CₙH₂ₙ)ₙ₁O(CₘH₂ₘ)ₘ₁—CₖF₂ₖ₊₁

In the formula, n and m are 1 to 3 respectively, n1 and ml are 1 to 3 respectively, and k is 1 to 10.

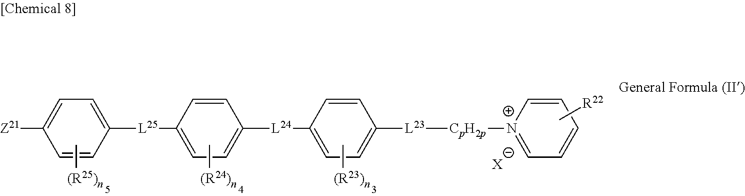

In the general formula (II′), the same symbols as in the formula (II) have the same meaning; L²⁵ is the same as L²⁴; R²³, R²⁴, and R²⁵ represent an alkyl group having 1 to 12 carbon atoms respectively, n3 represents 0 to 4, n4 represents 1 to 4, and n5 represents 0 to 4.

At least one kind of the polymerizable liquid crystalline composition that is used to form the optically anisotropic layer is contained, and one or more kinds of additives may be contained together with the composition. As examples of the additive that can be used, an air interface orientation controller, an anti-repelling agent, a polymerization initiator, a polymerizable monomer, and the like will be described.

Air Interface Orientation Controller:

The composition is oriented at the tilt angle of the air interface in the air interface. The degree of the tilt angle varies with the kind or the liquid crystalline compound included in the liquid crystalline composition, the kinds of the additives, and the like; it is necessary to arbitrarily control the tilt angle of the air interface according to purpose.

The tilt angle can be controlled by, for example, using an external field, such as an electric field or a magnetic field, or using an additive, and use of an additive is preferred. As the additive, compounds having one or more substituted or unsubstituted aliphatic groups having 6 to 40 carbon atoms or substituted or unsubstituted aliphatic group-substituted oligosiloxanoxy group having 6 to 40 carbon atoms in the molecules are preferred, and compounds having two or more groups in the molecules are more preferred. For example, the hydrophobic excluded volume effect compound as described in JP2002-20363 can be used as the air interface orientation controller.

In addition, the fluoro aliphatic group-containing polymer as described in JP2009-193046 and the like also has the same action, and therefore can be added as the air interface orientation controller.

The added amount of an additive for orientation control on the air interface side is preferably 0.001% by mass to 20% by mass, more preferably 0.01% by mass to 10% by mass, and still more preferably 0.1% by mass to 5% by mass with respect to the composition (the solid content in the case of the coating fluid, which also applies in the following).

Anti-Repelling Agent:

Generally, a high molecular compound can be preferably used as a material that is added to the composition and prevents repulsion when the composition is coated.

Polymers used are not particularly limited as long as the inclination angle change or orientation of the composition is not significantly impaired.

Examples of the polymers are described in JP1996-95030 (JP-H8-95030), and specific examples of the particularly preferred polymers include cellulose esters. Examples of the cellulose esters include cellulose acetate, cellulose acetate propionate, hydroxylpropyl cellulose, and cellulose acetate butyrate.

The added amount of the polymer used for preventing repulsion so as not to impair the orientation of the composition is generally in a range of 0.1% by mass to 10% by mass with respect to the composition, more preferably in a range of 0.1% by mass to 8% by mass, and still more preferably in a range of 0.1% by mass to 5% by mass.

Polymerization Initiator:

The composition preferably contains a polymerization initiator. When the composition containing the polymerization initiator is used, it is also possible to manufacture an optically anisotropic layer by heating the composition to the liquid crystal phase-forming temperature, then, polymerizing and cooling the composition so as to solidify the orientation state in a liquid crystal state. The polymerization reaction includes a thermal polymerization reaction in which a thermal polymerization initiator is used, a photopolymerization reaction in which a photopolymerization initiator is used, and a polymerization reaction by electron irradiation; however, in order to prevent the supporting body and the like from being deformed and modified by heat, the photopolymerization reaction or the polymerization by electron irradiation is preferred.

Examples of the photopolymerization initiator include α-carbonyl compounds (as described in US2367661A and US2367670A), acyloin ethers (as described in US2448828A), α-hydrocarbon-substituted aromatic acyloin compounds (as described in US2722512A), multinuclear quinone compounds (as described in U.S. Pat. No. 3,046,127A and US2951758A), combinations of triarylimidazole dimer and p-aminophenyl ketone (as described in U.S. Pat. No. 3,549,367A), acridine and phenazine compounds (as described in JP1985-105667 (JP-S60-105667) and U.S. Pat. No. 4,239,850A) and oxadiazole compounds (as described in U.S. Pat. No. 4,212,970).

The used amount of the photopolymerization initiator is preferably 0.01% by mass to 20% by mass of the composition, and more preferably 0.5% by mass to 5% by mass.

Polymerizable Monomer:

A polymerizable monomer may be added to the composition. The polymerizable monomer that can be used in the invention is not particularly limited as long as the polymerizable monomer has compatibility with the liquid crystalline composition being jointly used, and does not cause significant orientation impair of the liquid crystalline composition. Among them, compounds having a polymerization-active ethylenic unsaturated group, for example, a vinyl group, a vinyloxy group, an acryloyl group, a methacryloyl group, and the like, is preferably used. The added amount of the polymerizable monomer is generally in a range of 0.5% by mass to 50% by mass, and preferably 1% by mass to 30% by mass with respect to the liquid crystalline composition being jointly used. In addition, when a monomer having two or more reactive functional groups is used, an effect of enhancing the adhesion properties with the oriented film can be expected, which is particularly preferred.

The composition may be prepared as a coating fluid. As a solvent that is used for preparation of the coating fluid, a commonly used organic solvent is preferably used. Examples of the commonly used organic solvent include amide-based solvents (for example, N,N-dimethylformamide), sulfoxide-based solvents (for example, dimethylsulfoxide), hetero ring-based solvents (for example, pyridine), hydrocarbon-based solvents (for example, toluene and hexane), alkyl halide-based solvents (for example, chloroform and dichloromethane), ester-based solvents (for example, methyl acetate and butyl acetate), ketone-based solvents (for example, acetone, methyl ethyl ketone, methylisobutyl ketone, and cyclohexanone), and ether-based solvents (for example, tetrahydrofuran and 1,2-dimethoxy-ethane). The ester-based solvents and the ketone-based solvents are preferred, and the ketone-based solvents are particularly preferred. Two or more kinds of the organic solvents may be jointly used.

The optically anisotropic layer can be manufactured by turning the composition into an orientation state and fixing the orientation state. Hereinafter, an example of the manufacturing method will be described, but the manufacturing method is not limited thereto.

Firstly, the composition containing at least the polymerizable liquid crystalline compound is coated on the surface of the supporting body (the surface of the oriented film in a case in which the orientation film is provided). The composition is subjected to heating or the like, according to desire, so as to be oriented in a desired orientation state. Next, a polymerization reaction and the like are caused, and the state is fixed, thereby forming an optically anisotropic layer. Examples of additive that can be added to the composition used in the above method include the air interface orientation controller, an anti-repelling agent, a polymerization initiator, a polymerizable monomer, and the like.

The coating can be carried out by a well-known method (for example, the wire bar coating method, the extrusion coating method, the direct gravure coating method, the reverse gravure coating method, or the die coating method).

In order to realize a uniformly oriented state, an oriented film is preferably used. The oriented film is preferably formed by carrying out a rubbing treatment on the surface of a polymer film (for example, a polyvinyl alcohol film, an imide film, or the like). Examples of the oriented film that is preferably used in the invention include the oriented films of acrylic acid copolymers or methacrylic acid copolymers as described in [0130] to [0175] of JP2006-276203. When the above oriented film is used, it is possible to suppress fluctuation of the liquid crystalline compound and achieve an increase in the contrast, which is preferred.

Next, in order to fix the orientation state, it is preferable to carry out polymerization. It is preferable that a polymerization initiator be contained in the composition and polymerization be initiated by light irradiation. Ultraviolet rays are preferably used for the light irradiation. The irradiation energy is preferably 10 mJ/cm² to 50 J/cm², and more preferably 50 mJ/cm² to 800 mJ/cm². In order to promote the photopolymerization reaction, the light irradiation may be carried out under the heating conditions. In addition, since the oxygen concentration in the atmosphere affects the degree of polymerization, in a case in which the desired degree of polymerization is not achieved in vacuum, it is preferable to lower the oxygen concentration by a method of nitrogen substitution or the like. A preferable oxygen concentration is preferably 10% or less, more preferably 7% or less, and still more preferably 3% or less.

In the invention, the most typical and preferable aspect of the state in which the orientation state is fixed is a state in which the orientation is held, but the state is not limited only thereto, and, specifically, the state refers to a state under, ordinarily, 0° C. to 50° C., and a more strict condition of a temperature range of −30° C. to 70° C., the fixed composition cannot flow, any change in the orientation form is not caused by an external field or an external force, and the fixed orientation form can be stably maintained. Meanwhile, when the orientation state reaches formation of the ultimately fixed optically anisotropic layer, the composition does not need to exhibit the liquid crystalline properties. For example, consequently, polymerization or a crosslinking reaction proceeds due to a reaction by heat, light, or the like, and the molecular weight is increased, whereby the liquid crystalline compound loses the liquid crystalline properties.

The thickness of the optically anisotropic layer is not particularly limited; however, in general, the thickness is preferably approximately 0.1 μm to 10 μm, and more preferably approximately 0.5 μm to 5 μm.

For the formation of the optically anisotropic layer, the oriented film may be used, and it is possible to use a film obtained by carrying out a rubbing treatment on the surface of the film including a polyvinyl alcohol or a modified polyvinyl alcohol as a main component or the like.

Meanwhile, the phase difference film and the optically anisotropic layer that are used in the invention are preferably manufactured continuously in a state of a long length. Furthermore, the retarded axis being present in a direction neither parallel nor orthogonal to the longitudinal direction is preferable since the polarization film can be attached with the retarded axis of the polarization film inclined at 45° or 135° with respect to the absorption axis of the polarization film by the roll to roll method. That is, the angle formed between the retarded axis and the long side of the phase difference film and the optically anisotropic layer is preferably 5° or 85°.

The angle of the retarded axis of the optically anisotropic layer formed of the liquid crystalline composition can be adjusted using the rubbing angle. For the retarded axis of the stretched film, the angle of the retarded axis can be adjusted using the stretching direction.

(3) Surface Layer

A single layer or plural layers of necessary surface layer may be provided on the surface of the protection member and the λ/4 layer according to purpose. Preferred aspects include an aspect in which a hard coating layer is laminated on the optically anisotropic layer, an aspect in which an anti-reflection layer is laminated on the optically anisotropic layer, an aspect in which a hard coating layer is laminated on the optically anisotropic layer, and, furthermore, an anti-reflection layer is laminated on the hard coating, and the like.

[Anti-Reflection Layer]

The anti-reflection layer is a layer that is designed in consideration of the refractive index, the film thickness, the number of layers, the layer sequence, and the like so that the reflectance is decreased due to optical interruption, and is composed of at least one or more layers.

The simplest configuration of the anti-reflection layer is a configuration in which only a low refractive index layer is coated on the outermost surface of the film. In order to further lower the reflectance, the anti-reflection layer is preferably constituted by combining a high refractive index layer having a high refractive index and a low refractive index layer having a low refractive index. The configuration examples include a configuration of two layers of a high refractive index layer/a low refractive index layer sequentially from the bottom side, a configuration in which three layers having different refractive indexes are laminated in the order of an intermediate refractive index layer (a layer having a refractive index that is higher than that of a low refractive index layer and lower than that of a high refractive index layer)/a high refractive index layer/a low refractive index layer, and the like, and, furthermore, a configuration in which a number of anti-reflection layers are laminated is also proposed. Among them, the configuration having an intermediate refractive index layer/a high refractive index layer/a low refractive index layer sequentially on a hard coating layer is preferred in terms of the durability, optical characteristics, costs, productivity, and the like, and examples thereof include the configurations as disclosed in JP1996-122504 (JP-H8-122504), JP1996-110401 (JP-H8-110401), JP1998-300902 (JP-H10-300902), JP2002-243906, and JP2000-111706. In addition, an anti-reflection film having a three-layer configuration that is excellent in terms of the roughness with respect to changes in the film thickness is described in JP2008-262187. In a case in which the anti-reflection film having a three-layer configuration is placed on the surface of an image display apparatus, it is possible to set the average value of the reflectance to be 0.5% or less, to significantly reduce reflected glare, and produce images that are excellent in terms of stereoscopic feelings. In addition, different functions may be supplied to the respective layers, and examples thereof include a configuration having an antifouling low refractive index layer, an antistatic high refractive index layer, an antistatic hard coating layer, and an anti-dazzling hard coating layer (for example, JP1998-206603 (JP-H10-206603), JP2002-243906, JP2007-264113, and the like), and the like.

Specific examples of the layer configuration in a case in which the hard coating layer and the anti-reflection layer are provided are shown below.-*/in the examples represents a base material on which the surface layer is laminated. Specifically, -*/represents the optically anisotropic supporting body, the optically anisotropic layer, the supporting body, or the like.
-*/hard coating layer
-*/low refractive index layer
-*/anti-dazzling layer/low refractive index layer
-*/hard coating layer/low refractive index layer
-*/hard coating layer/anti-dazzling layer/low refractive index layer
-*/hard coating layer/high refractive index layer/low refractive index layer
-*/hard coating layer/intermediate refractive index layer/high refractive index layer/low refractive index layer
-*/hard coating layer/anti-dazzling layer/high refractive index layer/low refractive index layer
-*/hard coating layer/anti-dazzling layer/intermediate refractive index layer/high refractive index layer/low refractive index layer
-*/anti-dazzling layer/high refractive index layer/low refractive index layer
-*/anti-dazzling layer/intermediate refractive index layer/high refractive index layer/low refractive index layer

Among the above respective configurations, it is preferable to directly form a surface layer of a hard coating layer, an anti-dazzling layer, an anti-reflection layer, and the like on the optically anisotropic layer. In addition, the anti-reflection layer may be manufactured by attaching and laminating an optical film including the optically anisotropic layer and, separately, an optical film provided with layers of a hard coating layer, an anti-dazzling layer, an anti-reflection layer, and the like on a supporting body.

[Hard Coating Layer]

The surface film provided in the protection member can be provided with a hard coating layer in order to supply the physical strength of the film. In the invention, the hard coating layer may not be provided, but provision of the hard coating layer strengthens abrasion-resistant surfaces in pencil scratch hardness tests and the like, which is preferred.

The anti-reflection film is constituted by preferably providing a low refractive index layer on the hard coating layer, and, more preferably providing an intermediate refractive index layer and a high refractive index layer between the hard coating layer and a low refractive index layer. The hard coating layer may be composed of a laminate of two or more layers.

The refractive index of the hard coating layer in the invention is preferably in a range of 1.48 to 2.00, and more preferably 1.48 to 1.70 in terms of optical design for producing an anti-reflection surface film.

The thickness of the hard coating layer is ordinarily approximately 0.5 μm to 50 μm, preferably 1 μm to 20 μm, and more preferably 5 μn to 20 μm from the viewpoint of supplying sufficient durability and impact resistance to the surface film.

The strength of the hard coating layer is preferably 1 H or more, more preferably 2 H or more, and most preferably 3 H or more in a pencil scratch hardness test. Furthermore, in the Taber abrasion test according to JIS K5400, the amount of a test specimen abraded before and after the test is preferably small.

The hard coating layer is preferably formed by a crosslinking reaction or polymerization reaction of ionizing radiation thermosetting compounds. For example, the hard coating can be formed by coating a coating composition including an ionizing radiation thermosetting multifunctional monomer or multifunctional oligomer on a transparent supporting body, and causing a crosslinking reaction or polymerization reaction of the multifunctional monomer or multifunctional oligomer. The functional groups of the ionizing radiation thermosetting multifunctional monomer or multifunctional oligomer are preferably photo, electron, and radiation-polymerizable functional groups, and, among them, photopolymerizable functional groups are preferred. The photopolymerizable functional group includes compounds having a (meth)acryloyl group, a vinyl group, a styryl group, an aryl group, and the like, and, among them, a (meth)acryloyl group and —C(O)OCH═CH₂ are preferred.

Specific examples of the ionizing radiation thermosetting compounds include (meth)acrylic acid diesters of alkylene glycol, (meth)acrylic acid diesters of polyoxy-alkylene glycol, (meth)acrylic acid diesters of multivalent alcohols, (meth)acrylic acid diesters of ethylene oxide or propylene oxide addition, epoxy (meth)acrylates, urethane (meth)acrylates, polyester (meth)acrylates, and the like.

Commercially available products can also be used as the multifunctional acrylate-based compounds having a (meth)acryloyl group, and examples thereof include NK ester A-TMMT, manufactured by Shin-Nakamura Chemical Co., Ltd., KAYARAD DPHA, manufactured by Nippon Kayaku Co., Ltd., and the like. The multifunctional monomers which are also the same in the invention are described in paragraphs [0114] to [0122] of JP2009-98658.

The ionizing radiation thermosetting compounds are preferably compounds having a hydrogen-bonding substituent in terms of the adhesion properties with the supporting body and low curling properties. The hydrogen-bonding substituent refers to a substituent in which an atom having a large electronegativity, such as nitrogen, oxygen, sulfur, or halogen, and a hydrogen bonding are bonded through a covalent bond, specifically including OH—, SH—, —NH—, CHO—, CHN—, and the like, and is preferably urethane (meth)acrylates or (meth)acrylates having a hydroxide group. Commercially available compounds can also be used, and include NK oligomer U4HA, NK ester A-TMM-3, manufactured by Shin-Nakamura Chemical Co., Ltd., KAYARAD PET-30, manufactured by Nippon Kayaku Co., Ltd., and the like.

The hard coating layer may also contain matting particles having an average particle diameter of 1.0 μm to 10.0 μm, and preferably 1.5 μm to 7.0 μm, for example, particles of an inorganic compound or resin particles.

Monomers or inorganic particles having a variety of refractive indexes, or both can be added to a binder of the hard coating layer for the purpose of controlling the refractive index of the hard coating layer. The inorganic particles also have an effect of suppressing curing shrinkage due to a crosslinking reaction in addition to an effect of controlling the refractive index. In the invention, polymers generated by polymerizing multifunctional monomers and/or high refractive index monomers after formation of the hard coating layer, the inorganic particles dispersed therein are all referred to as the binder.

[Anti-Dazzling Layer]

The anti-dazzling layer is formed to supply the film with hard coating properties for improving anti-dazzling properties due to surface scattering, and preferably the hardness and abrasion resistance of the surface film

The anti-dazzling layer which is also the same in the invention is described in paragraphs [0178] to [0189] of JP2009-98658.

[High Refractive Index Layer and Intermediate Refractive Index Layer]

The refractive index of the high refractive index layer is preferably 1.70 to 1.74, and more preferably 1.71 to 1.73. The refractive index of the intermediate refractive index layer is adjusted to be an intermediate value between the refractive index of the low refractive index layer and the refractive index of the high refractive index layer. The refractive index of the intermediate refractive index layer is preferably 1.60 to 1.64, and more preferably 1.61 to 1.63.

For formation of the high refractive index layer and the intermediate refractive index layer, it is possible to use a transparent thin film of an oxide of an inorganic substance by a chemical vapor deposition (CVD) method or a physical vapor deposition (PVD) method, particularly, the vacuum deposition method or the sputtering method, which is one of the physical vapor deposition method, and a method by all wetting coating is preferred.

For the intermediate refractive index layer, the same material and the same adjustment method as for the high refractive index layer can be used except that the refractive indexes are made to be different, and therefore particularly the high refractive index layer will be hereinafter described.

The high refractive index layer is preferably formed by coating a coating composition containing inorganic particles, a curable compound having trifunctional or more polymerizable groups (hereinafter, sometimes, referred to as the “binder”), a solvent, and a polymerization initiator, drying the solvent, and curing the composition through heating, ionizing radiation irradiation, or use of both. In a case in which a curable compound or an initiator is used, it is possible to form an intermediate refractive index layer or the high refractive index layer that is excellent in terms of damage resistance or close adhesion properties by curing the curable compound by heat and/or an ionizing radiation ray-induced polymerization reaction after coating.

[Low Refractive Index Layer]

The refractive index of the low refractive index layer in the invention is preferably 1.30 to 1.47. In a case in which the surface film is a multilayer thin film interruption-type anti-reflection film (intermediate refractive index layer/high refractive index layer/low refractive index layer), the refractive index of the low refractive index layer is desirably 1.33 to 1.38, and more desirably 1.35 to 1.37. When the refractive index is in the above ranges, the reflectance can be suppressed, and the film strength can be maintained, which is preferred. For formation of the low refractive index layer, it is also possible to use a transparent thin film of an oxide of an inorganic substance by a chemical vapor deposition (CVD) method or a physical vapor deposition (PVD) method, particularly, the vacuum deposition method or the sputtering method, which is one of the physical vapor deposition method, and it is preferable to use a method in which a composition for the low refractive index layer and all wetting coating are used.

The low refractive index layer can be formed using a fluorine-containing curable polymer, a fluorine-containing curable monomer, a fluorine-free curable monomer, low refractive index particles, and the like as the components. The compounds as described in paragraphs [0018] to [0168] in JP2010-152311 can be used as the compound.

The haze of the low refractive index layer is preferably 3% or less, more preferably 2% or less, and most preferably 1% or less.

The strength of the anti-reflection film for which even the low refractive index layer is formed is preferably 1 H or more, more preferably 2 H or more, and most preferably 3 H or more in a pencil scratch hardness test in which a load of 500 g is used.

In addition, in order to improve the antifouling properties of the anti-reflection film, the contact angle of the surface with respect to water is preferably 95° or more, and more preferably 102° or more. Particularly, when the contact angle is 105° or more, the antifouling performance against fingerprints is significantly improved, which is particularly preferred. In addition, with the contact angle of water of 102° or more, the surface free energy is more preferably 25 dyne/cm or less, particularly preferably 23 dyne/cm or less, and still more preferably 20 dyne/cm or less. Most preferably, the surface free energy is 20 dyne/cm or less with the contact angle of water of 105° or more.

(4) Ultraviolet Absorbent

In the invention, the protection member and the λ/4 layer preferably contain an ultraviolet absorbent. In an aspect in which the protection member and the λ/4 layer are a laminate structure, at least one layer preferably contains the ultraviolet absorbent. For example, in an aspect in which the protection member and the λ/4 layer contain a transparent supporting body, an optically anisotropic layer, an anti-reflection layer, or an adhesive that adheres the above, any of the above preferably contains the ultraviolet absorbent. In addition, it is also possible to make the hard coating layer and/or the anti-reflection layer in the surface film contain the ultraviolet absorbent. Any well-known substances that can exhibit ultraviolet ray-absorbing properties can be used as the ultraviolet absorbent. Among such ultraviolet absorbents, a benzotriazole-based or hydroxyl phenyl triazine-based ultraviolet absorbent is preferred in order to produce high ultraviolet ray-absorbing properties and ultraviolet ray-absorbing performance (ultraviolet ray cutting performance) that is used in electronic image display apparatuses). In addition, in order to widen the absorption width of ultraviolet rays, it is possible to jointly use two or more kinds of ultraviolet absorbents having different maximum absorption wavelengths.

The benzotriazole-based ultraviolet absorbent includes 2-[2′-hydroxy-5′-(methacryloyloxy methyl)phenyl]-2H-benzotriazole, 2-[2′-hydroxy-5′-(methacryloyloxy ethyl)phenyl]-2H-benzotriazole, 2-[2′-hydroxy-5′-(methacryloyloxy propyl)phenyl]-2H-benzotriazole, 2-[2′-hydroxy-5′-(methacryloyloxy hexyl)phenyl]-2H-benzotriazole, 2-[2′-hydroxy-3′-tert-butyl-3′-(methacryloyloxy ethyl)phenyl]-2H-benzotriazole, 2-[2′-hydroxy-5′-tert-butyl-3′-(methacryloyloxy ethyl)phenyl]-2H-benzotriazole, 2-[2′-hydroxy-5′-(methacryloyloxy ethyl)phenyl]-5-chloro-2H-benzotriazole, 2-[2′-hydroxy-5′-(methacryloyloxy ethyl)phenyl]-5-methoxy-2H-benzotriazole, 2-[2′-hydroxy-5′-(methacryloyloxy ethyl)phenyl]-5-cyano-2H-benzotriazole, 2-[2′-hydroxy-5′-(methacryloyloxy ethyl)phenyl]-5-tert-butyl-2H-benzotriazole, 2-[2′-hydroxy-5′-(methacryloyloxy ethyl)phenyl]-5-nitro-2H-benzotriazole, 2-(2-hydroxy-5-ter-butyl phenyl)-2H-benzotriazole, benzenepropanoic acid-3-(2H-benzotriazole-2-yl)-5-(1,1-dimethylethyl)-4-hydroxy-, C7 to 9 branched or straight chain alkyl ester, 2-(2H-benzotriazol-2-yl)-4,6-bis(1-methyl-1-phenyl ethyl)phenol, 2-(2H-benzotriazol-2-yl)-6-(1-methyl-1-phenylethyl)-4-(1,1,3,3-tetramethylbutyl)phenol, and the like.

The hydroxyl phenyl triazine-based ultraviolet absorbent includes 2-[4-[(2-hydroxy-3-dodecyloxypropyl)oxy]-2-hydroxyphenyl]4,6-bis(2,4-dimethylphenyl)-1,3,5-triazine, 2-[4-[(2-hydroxy-3-tridecyloxypropyl)oxy]-2-hydroxyphenyl]-4,6-bis(2,4-dimethylphenyl)-1,3,5-triazine, 2-[4-[(2-hydroxy-3-(2′-ethyl)hexyl)oxy]-2-hydroxyphenyl]-4,6-bis(2,4-dimethylphenyl)-1,3,5-triazine, 2,4-bis(2-hydroxy-4-butyloxyphenyl)-6-(2,4-bis-butyloxyphenyl)-1,3,5-triazine, 2-(2-hydroxy-4-[1-octyloxycarbonylethoxy]phenyl)-4,6-bis(4-phenylphenyl)-1,3,5-triazine, 2,2′,4,4′-tetrahydroxybenzophenone, 2,2′-dihydroxy-4-methoxybenzophenone, 2,4-dihydroxybenzophenone, 2-hydroxy-4-acetoxyethoxybenzophenone, 2-hydroxy-4-methoxybenzophenone, 2,2′-dihydroxy-4-methoxybenzophenone, 2,2′-dihydroxy-4,4′-dimethoxybenzophenone, 2-hydroxy-4-n-octhoxybenzophenone, 2,2′-dihydroxy-4,4′-dimethoxy-5,5′-disulfobenzophenone-2 sodium salt, and the like.

The content of the ultraviolet absorbent is also dependent on the required ultraviolet transmission or the absorbency of the ultraviolet absorbent, and is ordinarily 20 parts by mass or less, and preferably 1 parts by mass to 20 parts by mass with respect to 100 parts by mass of the ultraviolet-curable resin. In a case in which the content of the ultraviolet absorbent is more than 20 parts by mass, the curing properties of the curable composition by ultraviolet rays tend to be degraded, and, also, there is a concern that the visible light transmission of an optical film is degraded. On the other hand, in a case in which the content of the ultraviolet absorbent is less than 1 part by mass, it becomes impossible to sufficiently exhibit the ultraviolet ray-absorbing properties of an optical film.

2. Second and Third Films

A protective film (second film) may be provided on the surface opposite to the side on which the 3D display apparatus of the invention and the protection member of the first polarization film are disposed. In addition, in an aspect of a liquid crystal display apparatus in which the display apparatus has liquid crystal cells, it is common to provide the second polarization film on the backlight side of the liquid crystal cells as well. Therefore, for the second polarization film as well, a protective film (third film) may be provided on the surface on the liquid crystal cell side, or a protective film may be provided on the surface on the backlight side. As the second and third films, a variety of polymer films, for example, cellulose acylate (for example, a cellulose triacetate film, a cellulose diacetate film, a cellulose acetate butylate film, and a cellulose acetate propionate film), polyester-based polymers, such as polycarbonate-based polymers, polyethylene terephthalate, and polyethylene naphthalate, acryl-based polymers, such as polymethyl methacrylate, styrene-based polymers, such as polystyrene or acrylonitrile-styrene copolymers (AS resins), polyolefin, such as polyethylene and polypropylene, cyclic olefin-based polymers, such as norbornene, polyolefin-based polymers, such as ethylene-propylene copolymers, vinyl chloride-based polymers, amide-based polymers, such as nylon or aromatic polyamides, imide-based polymers, sulfone-based polymers, polyether sulfone-based polymers, polyether ether ketone-based polymers, polyphenylene sulfide-based polymers, vinylidene chloride-based polymers, vinyl alcohol-based polymers, vinyl butyral-based polymers, arylate-based polymers, polyoxy methylene-based polymers, epoxy-based polymers, mixtures of polymers, and the like. It is possible to use one or two or more polymers as main components. Commercially available products may be used, and ARTON (manufactured by JSR Corporation), which is a cyclic olefin-based polymer, ZEONEX (manufactured by Zeon Corporation), which is an amorphous polyolefin, and the like may also be used.

As a result of thorough studies by the present inventors, it was found that uneven display caused under high moisture permeability can be alleviated when the second and third films are a film having high moisture permeability. In the past, since a film having low moisture permeability was preferably disposed in an ordinary liquid crystal display apparatus from the viewpoint of the durability under high humidity, the effect of further alleviating uneven display caused under high humidity by using a film having high moisture permeability for the second and third films was an effect that could not be expected. Specifically, the moisture permeability at 40° C. and 90% RH of at least one of the second and third films is preferably 10 g/m²/day to 2000 g/m²/day, more preferably 15 g/m²/day to 1500 g/m²/day, and still more preferably 200 g/m²/day to 1300 g/m²/day. Examples of a film that satisfies the above characteristic include cellulose acylate films, and cellulose acetate films are particularly preferred.

Meanwhile, the second and third films may contribute to the view angle compensation of the liquid crystal cell. The preferable ranges of Re and Rth of the second and third films that contribute to the view angle compensation can be determined according to the mode of the liquid crystal cell. In addition, the second and third films may be a laminate of two or more polymer films, or may have an optically anisotropic layer formed by fixing the orientation of a liquid crystal composition.

3. Polarization Film

The image display apparatus that is used in the time-sequential 3D display system of the invention has at least one polarization film (the first polarization film) on the observation side. In an aspect in which the image display apparatus is a liquid crystal panel in a transmission mode, a polarization film is also provided on the back light side of the liquid crystal cell. In addition, in an aspect in which the time-sequential image display shutting device that is used in the system of the invention uses a shutter function of the liquid crystal cell, one polarization film or two polarization films with the liquid crystal cell therebetween are disposed.

The polarization film that is used in the 3D display apparatus of the invention is not particularly limited, and an ordinarily used polarization film can be used. Examples thereof that can be used include iodine-based polarization films, dye-based polarization films in which a dichromatic dye is used, and polyene-based polarization films. The iodine-based polarization films and the dye-based polarization films are generally manufactured by absorbing iodine or a dichromatic dye in polyvinyl alcohol and stretching the resultant.

Meanwhile, the polarization film is generally used as a polarization plate having protective films attached to both surfaces. In the invention, the polarization plate may be used. FIGS. 6A to 7J show examples of a polarization plate having the protection member and/or the λ/4 plate, but the polarization plate is not limited thereto. The optical retardation film in FIGS. 7A to 7J has a function of compensating the view angle of the liquid crystal cell, and represents the second film.

3. Liquid Crystal Cell

The configurations of the image display apparatus that is used in the time-sequential 3D display system and the time-sequential image display shutting device of the invention are not particularly limited. Examples thereof all use liquid crystal cells. The configurations of liquid crystals that can be used are not particularly limited. The liquid crystal may have a variety of components necessary to produce a variety of modes of liquid crystal cells in addition to a pair of substrates and a liquid crystal layer. The modes of the liquid crystal cell include a variety of modes, such as a twisted nematic (TN) mode, a super twisted nematic (STN) mode, an electrically controlled birefringence (ECB) mode, an in-plane switching (IPS) mode, a vertical alignment (VA) mode, a multidomain vertical alignment (MVA) mode, a patterned vertical alignment (PVA) mode, an optically compensated birefringence (OCB) mode, a hybrid aligned nematic (HAN) mode, an axially symmetric aligned microcell (ASM) mode, a half tone gray scale mode, a domain-division mode, a display mode in which ferroelectric liquid crystals and antiferroelectric liquid crystals are used, and the like. In addition, the driving mode of the liquid crystal is also not particularly limited, and may be any of the passive matrix mode that is used for STN-LCD and the like, the active matrix mode that is used for active electrodes, such as thin film transistor (TFT) electrodes and thin film diode (TFD) electrodes, the plasma address mode, and the like. The field sequential mode in which color filters are not used may be used.

The liquid crystal cell that is used in the image display apparatus is preferably a VA mode, an OCB mode, an IPS mode, or an TN mode, but is not limited thereto.

In the liquid crystal cell in the VA mode, rod-shaped liquid crystalline molecules are oriented substantially vertically when no voltage is applied. The liquid crystal in the VA mode includes (1) a liquid crystal cell in the VA mode in a narrow definition in which rod-shaped liquid crystalline molecules are oriented substantially vertically when no voltage is applied, and substantially horizontally when voltage is applied (described in JP1990-176625 (JP-H2-176625)), (2) a liquid crystal cell (in the MVA mode) for which the VA mode is made into multi domains for view angle enlargement (described in S1D97, Digest of tech. Papers (Proceedings) 28 (1997) 845), (3) a liquid crystal cell in a mode in which rod-shaped liquid crystalline molecules are oriented substantially vertically when no voltage is applied, and twisted so as to be oriented into multi domains when voltage is applied (n-ASM mode) (described in the Proceedings of Japanese Liquid Crystal Society 58 to 59 (1998)), and (4) a liquid crystal cell in a survival mode (presented in the LCD International 98). In addition, the liquid crystal may have any of a patterned vertical alignment (PVA) type, an optical alignment type, and polymer-sustained alignment (PSA). The details of the above modes are described in JP2006-215326 and JP2008-538819A.

The liquid cell in the OCB mode is a liquid crystal cell in a bend orientation mode in which the rod-shaped liquid crystalline molecules are oriented at the top portion and bottom portion of the liquid crystal cell in substantially reverse directions (symmetrically). Liquid crystal display apparatuses in which the liquid crystal cell in the bend orientation mode is used are disclosed in U.S. Pat. No. 4,583,825B and U.S. Pat. No. 5,410,422B. The liquid crystal cell in the bend orientation mode has a self optical retardation function in order for the rod-shaped liquid crystalline molecules to be symmetrically oriented at the top portion and the bottom portion of the liquid crystal cell. Therefore, the liquid crystal mode is also termed an optically compensatory bend (OCB) liquid crystal mode. The liquid crystal display apparatus in the bend orientation mode has an advantage of a rapid response speed.

In the liquid cell in the IPS mode, the rod-shaped liquid crystal molecules are disposed substantially in parallel to the substrate, and, when a parallel electric field is applied to the substrate surface, the liquid crystal molecules respond in a planar manner. The IPS mode displays black in an electric field-free state, and the transmission axes of a pair of top and bottom polarization plates cross orthogonally with each other. A method in which leaked light in an inclined direction while displaying black is reduced using an optical retardation sheet so as to improve the view angle is disclosed in JP2008-54982A (JP-H10-54982A), JP2009-202323A (JP-H11-202323A), JP2007-292522A (JP-H9-292522A), JP2009-133408A (JP-H11-133408A), JP2009-305217 (JP-H11-305217), JP2008-307291 (JP-H10-307291), and the like.

In the liquid crystal cell in the TN mode, when no voltage is applied, the rod-shaped liquid crystalline molecules are oriented substantially horizontally, and, furthermore, twisted at 60° to 120°. The liquid crystal cell in the TN mode is most widely used as a color TFT liquid crystal display apparatus, and described in many publications.

For example, the liquid crystal for the image display apparatus can be selected from the viewpoint of the display performance, and the liquid crystal cell that is used for the shutter function of the time-sequential image display shutting device is selected from the viewpoint of the response rate and transmission since the liquid crystal cell needs to respond in accordance with images for the right eye and the left eye, and use of a fast TN mode liquid crystal cell is preferred.

### EXAMPLES

Hereinafter, the characteristics of the invention will be described more specifically using examples and comparative examples. Materials, amounts used, proportions, treatment contents, treatment sequences, and the like as shown in the following examples can be appropriately modified within the scope of the purport of the invention. Therefore, the scope of the invention is not interpreted to be limited to specific examples as shown below.

Meanwhile, in the examples and the comparative examples, values measured at a wavelength of 550 nm using an automatic double reflectometer KOBRA-21ADH (manufactured by Oji Scientific Instruments) were used for Re (550), Rth (550), and Re wavelength dispersion unless otherwise described.

The moisture permeability is obtained by measuring the moisture permeability of the respective specimens according to the method as described in JIS Z 0208, and computing the amount (g) of moisture evaporated per an area of 1 m² for 24 hours.

1. Manufacturing of the λ/4 Film (a Film Having the λ/4 Function)

(Manufacturing of λ/4 Film 1A)

A commercially available norbornene-based polymer film “ZEONOR ZF14” (manufactured by Optes Inc.) was subjected to free-end uniaxial stretching at a temperature of 156° C. and a stretching rate of 45% so as to manufacture a norbornene-based λ/4 film 1A The Re (550) and Rth (550) of the λ/4 film 1A were 138 nm and 85 nm respectively. Here, for the Re (550) and Rth (550), values measured at a wavelength of 550 nm using an automatic double reflectometer KOBRA-21ADH (manufactured by Oji Scientific Instruments) were used.

In addition, the moisture permeability of the λ/4 film 1A at 40° C. and 90% RH after 24 hours was 25 g/m²/day.

(Manufacturing of λ/4 Film 2A)

The following cyclic olefin-based resin solution was injected into a mixing tank, stirred to dissolve the respective components, and then filtered using a paper filter having an average pore diameter of 34 μm and a sintered metal filter having an average pore diameter of 10 μm.

Cyclic olefin-based resin solution composition

| | |
|---|---|
| ARTON G (manufactured by JSR Corporation) | 150 parts by mass |
| Dichloromethane | 600 parts by mass |

Next, the following composition including the cyclic olefin-based resin solution manufactured by the above method was injected into a disperser, and a matting agent dispersion fluid was prepared.

Matting agent dispersion fluid

| | |
|---|---|
| Silica particles having a primary average | 2 parts by mass |
| particle diameter of 16 nm (aerosol R972, | |
| manufactured by Nippon Aerosil Co., Ltd.) | |
| Dichloromethane | 80 parts by mass |
| Cyclic olefin-based resin solution | 10 parts by mass |

100 parts by mass of the cyclic olefin-based resin solution and 3.8 parts by mass of the matting agent dispersion fluid were mixed, and a film-making dope was prepared. A film manufactured by casting the dope using a band caster was subjected to free-end uniaxial stretching so as to manufacture a λ/4 film 2A. The Re (550) and Rth (550) of the λ/4 film 2A were 138 nm and 85 nm respectively. Here, for the Re (550) and Rth (550), values measured at a wavelength of 550 nm using an automatic double reflectometer KOBRA-21ADH (manufactured by Oji Scientific Instruments) were used.

In addition, the moisture permeability of the λ/4 film 2A at 40° C. and 90% RH after 24 hours was 100 g/m²/day.

(Manufacturing of λ/4 Film 5A)

<Alkali Saponification Treatment>

A commercially available cellulose acylate film “TD80UL” (manufactured by Fuji Film Holdings Corporation) was passed through dielectric heating rolls at a temperature of 60° C. so as to increase the temperature of the film surface to 40° C., then, an alkali solution having the following composition was coated on the band surface of the film using a bar coater at a coating amount of 14 ml/m², and transported under a steam-type far-infrared heater, manufactured by Norita Co., Ltd., that was heated to 110° C. for 10 seconds. Subsequently, 3 ml/m² of pure water was coated using the bar coater in a similar manner. Next, water washing by a fountain coater and drainage by an air knife was repeated three times, and then the film was transported and dried in a drying zone of 70° C. for 10 seconds, thereby manufacturing an alkali-saponified cellulose acylate film.

Alkali solution composition (parts by mass)

| | | |
|---|---|---|
| Potassium hydroxide | 4.7 | parts by mass |
| Water | 15.8 | parts by mass |
| Isopropanol | 63.7 | parts by mass |
| Surfactant SF-1: C₁₄H₂₉O (CH₂CH₂O)₂₀H | 1.0 | part by mass |
| Propylene glycol | 14.8 | parts by mass |

<Formation of an Oriented Film>

An oriented film coating fluid having the following composition was continuously coated on the long cellulose acylate film that was saponified in the above manner using a #14 wire bar. The film was dried at a temperature of 60° C. for 60 seconds, and furthermore at a temperature of 100° C. for 120 seconds.

Composition of the oriented film coating fluid

| | | |
|---|---|---|
| The following modified polyvinyl alcohol | 10 | parts by mass |
| Water | 371 | parts by mass |
| Methanol | 119 | parts by mass |
| Glutaraldehyde | 0.5 | parts by mass |
| Polymerization initiator (IRGACURE 2959, | 0.3 | parts by mass |
| manufactured by Ciba Specialty Chemicals Inc.) | | |

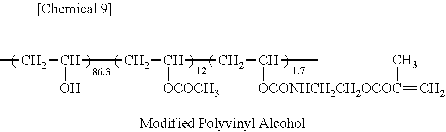

<Formation of an Optically Anisotropic Layer Including a Discotic Liquid Crystalline Compound>

The manufactured oriented film was continuously subjected to rubbing treatments. At this time, the longitudinal direction of the long film and the transportation direction were in parallel, and the rotation axis of the rubbing rolls was set in a direction of 45° clockwise with respect to the longitudinal direction of the film.

A coating fluid A including a discotic liquid crystalline compound that had the following composition was continuously coated on the manufactured oriented film using a wire bar. The transportation speed (V) of the film was set to 36 m/min. The coating fluid was heated for 90 seconds using hot air at 120° C. in order to dry the solvent in the coating fluid and mature the orientation of the discotic liquid crystalline compound. Subsequently, UV irradiation was carried out at 80° C., the orientation of the liquid crystalline compound was fixed, and a 1.77 μm-thick optically anisotropic layer was formed, thereby producing a λ/4 film 5A. The Re (550) and Rth (550) of the manufactured k/4 film 5A at 550 nm was 138 nm and −5 nm. The direction of the retarded axis was orthogonal to the rotation axis of the rubbing rollers. That is, the retarded axis was in the 45° clockwise direction with respect to the longitudinal direction of the supporting body. It was confirmed that the average inclination angle of the disc surfaces of the discotic liquid crystalline molecules with respect to the film surface was 90°, and the discotic liquid crystals were oriented perpendicular to the film surface. Meanwhile, for the Re (550) and Rth (550), values measured at a wavelength of 550 nm using an automatic double reflectometer KOBRA-21ADH (manufactured by Oji Scientific Instruments) were used. The moisture permeability of the λ/4 film 5A at 40° C. and 90% RH after 24 hours was 330 g/m²/day.

Composition of the optically anisotropic layer coating fluid (A)

| | | |
|---|---|---|
| The following discotic liquid crystalline | 91 | parts by mass |
| compound | | |
| Acrylate monomer *1 | 5 | parts by mass |
| Polymerization initiator (IRGACURE 907, | 3 | parts by mass |
| manufactured by Ciba Specialty Chemicals Inc.) | | |
| Sensitizer (KAYACURE DETX, manufactured by | 1 | part by mass |
| Nippon Kayaku Co., Ltd.) | | |
| The following pyridinium salt | 0.5 | parts by mass |
| The following fluorine-based polymer (FP1) | 0.2 | parts by mass |
| The following fluorine-based polymer (FP3) | 0.1 | parts by mass |
| Methyl ethyl ketone | 189 | parts by mass |

*1: Ethylene oxide-modified trimethylol-propane triacrylate (V#360, manufactured by Osaka Organic Chemicals Ltd.)

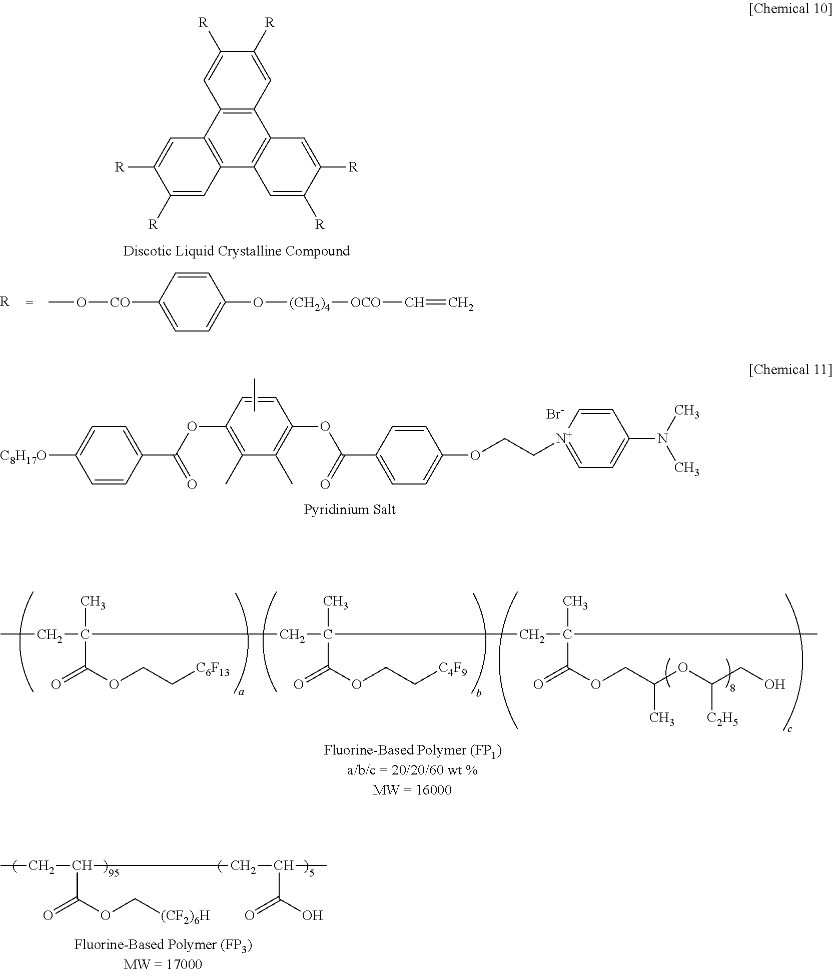

(Manufacturing of a Surface Layer (Anti-Reflection Layer)-Attached Optical Film 1B)

<Preparation of a Coating Fluid for the Hard Coating Layer>

The following composition was injected into a mixing tank, stirred, and filtered using a polypropylene filter having a pore diameter of 0.4 μm so as to prepare a coating fluid for the hard coating layer (a solid content concentration of 58% by mass).

Coating fluid for the hard coating layer

| | | |
|---|---|---|
| Methyl acetate | 36.2 | parts by mass |
| Methyl ethyl ketone | 36.2 | parts by mass |
| (a) Monomer having the following structure: | 77.0 | parts by mass |
| PETA *1 | | |
| (b) Monomer having the following structure *2 | 20.0 | parts by mass |
| Photopolymerization initiator *3 | 3.0 | parts by mass |
| Leveling agent having the following structure | 0.02 | parts by mass |
| (SP-13) | | |

*1: A compound having the following structure, manufactured by Shin-Nakamura Chemical Co., Ltd.; The mass average molecular weight was 325, and the number of functional groups in a molecule was 3.5 (average value).
*2: The mass average molecular weight was 596, and the number of functional groups in a molecule was 4.
*3: IRGACURE 184, manufactured by Ciba Specialty Chemicals Inc.

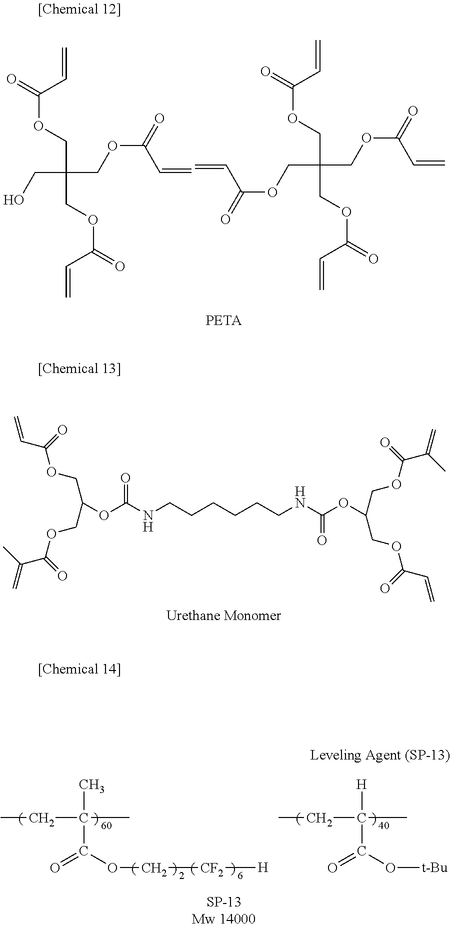

<Preparation of a Coating Fluid for the Low Refractive Index Layer>

The respective components was mixed as shown below, and dissolved into a mixture of MEK/MMPG-Ac in a mass ratio of 85/15, thereby preparing a coating fluid for the low refractive index layer having 5% by mass of solid content (MEK represents methyl ethyl ketone, and MMPG-Ac represents propylene glycol monomethyl ether acetate).

Composition of the coating fluid for the low refractive index layer

| | | |
|---|---|---|
| Perfluoroolefin copolymer having the following | 15 | parts by mass |
| structure | | |
| DPHA *1 | 7 | parts by mass |
| DEFENSA MCF-323 *2 | 5 | parts by mass |
| The following fluorine-containing polymerizable | 20 | parts by mass |
| compound | | |
| Solid content of hollow silica particles | 50 | parts by mass |
| IRGACURE 127 *3 | 3 | parts by mass |

*1: DPHA: a mixture of dipenta erythritol pentacrylate and dipenta erythritol hexacrylate, manufactured by Nippon Kayaku Co., Ltd..
*2: A fluorine-based surfactant, manufactured by Dainippon Ink & Chemicals, Inc.
*3: IRGACURE 127: a photopolymerization initiator, manufactured by Ciba Specialty Chemicals Inc.
Hollow silica: hollow silica particle dispersion fluid (average particle size: 45 nm, refractive index: 1.25, the surface was subjected to a surface treatment using a silane coupling agent having an acryloyl group, MEK dispersion fluid concentration: 20%)

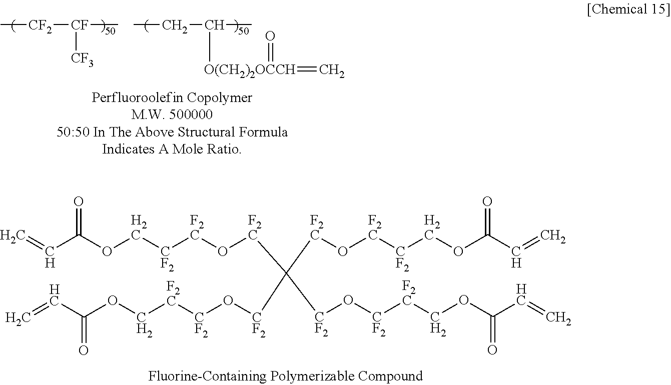

<Formation of the Hard Coating Layer and the Low Refractive Index Layer>

The coating fluid for the hard coating layer was coated on a commercially available cellulose acylate film “TD80UL” (manufactured by Fuji Film Holdings Corporation) using a die coater (an amount of the solid content coated: 12 g/m²). The coating fluid was dried at 100° C. for 60 seconds, then subjected to nitrogen purging so as to form an atmosphere having an oxygen concentration of 0.1% by volume, and ultraviolet rays were irradiated at an illuminance of 400 mW/cm² and an irradiance level of 150 mJ/cm² using a 160 W/cm air cooling metal halide lamp (manufactured by Eye Graphics Co., Ltd.) so as to cure the coated layer, thereby manufacturing a hard coating layer-attached optical film. The coating fluid for the low refractive index layer was coated on the hard coating layer. The drying conditions of the low refractive index layer were set to 70° C. and 60 seconds, and the ultraviolet curing conditions were set to an illuminance of 600 mW/cm² and an irradiance level of 300 mJ/cm² using a 240 W/cm air cooling metal halide lamp (manufactured by Eye Graphics Co., Ltd.) while carrying out nitrogen purging so as to form an atmosphere having an oxygen concentration of 0.1% by volume. A surface layer (anti-reflection layer)-attached optical film 1B was manufactured in the above manner. The refractive index of the low refractive index layer was 1.34, and the film thickness was 95 nm. Meanwhile, the moisture permeability of the used cellulose acylate film “TD80UL” at 40° C. and 90% RH after 24 hours was 430 g/m²/day.

(Manufacturing of a Surface Layer (Anti-Reflection Layer)-Attached Optical Film 5B)

After the same surface layer as for the surface layer (anti-reflection layer)-attached optical film 1B was manufactured on a glass substrate, the surface layer separated from the glass substrate was attached to a 100 μm-thick ZEONOR film ZF14, which was a commercially available cyclic olefin-based resin film manufactured by Optes Inc., and used as a surface layer (anti-reflection layer)-attached optical film 5B. The moisture permeability of the used ZEONOR film ZF14 at 40° C. and 90% RH after 24 hours was 20 g/m²/day.

(Manufacturing of a λ/4 Film 7A)

A λ/4 film 7A was manufactured in the same manner as for the manufacturing of the λ/4 film 2A except that the temperature and rate of stretching were changed in manufacturing of the λ/4 film 2A. The Re (550) and Rth (550) of the λ/4 film 7A were 138 nm and 85 nm. The moisture permeability of the λ/4 film 7A at 40° C. and 90% RH after 24 hours was 110 g/m²/day.

(Manufacturing of a λ/4 Film 9A)

<Formation of an Oriented Film>

After a commercially available cellulose acylate film “TD80UL” (manufactured by Fuji Film Holdings Corporation) was saponified, an oriented film coating fluid having the following composition was continuously coated. The coating fluid was dried for 60 seconds using hot air at 60° C., then, for 120 seconds using hot air at 100° C., and a film was formed. Next, the manufactured oriented film was continuously subjected to rubbing treatments. At this time, the longitudinal direction of the long film and the transportation direction were in parallel, and the rotation axis of the rubbing rolls was set in a direction of 45° clockwise with respect to the longitudinal direction of the film.

Composition of the oriented film coating fluid

| | | |
|---|---|---|
| The following modified polyvinyl alcohol | 10 | parts by mass |
| Water | 371 | parts by mass |
| Methanol | 119 | parts by mass |
| Glutaraldehyde | 0.5 | parts by mass |
| Polymerization initiator (IRGACURE 2959, | 0.3 | parts by mass |
| manufactured by Ciba Specialty Chemicals | | |
| Inc.) | | |

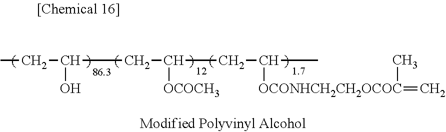

<Formation of an Optically Anisotropic Layer Including a Rod-Shaped Liquid Crystalline Compound>

A coating fluid including a rod-shaped liquid crystalline compound having the following composition was continuously coated on the manufactured oriented film using a wire bar.

Composition of a coating fluid having a rod-
shaped liquid crystalline compound (S1)

| | | |
|---|---|---|
| The following rod-shaped liquid crystalline compound | 1.8 | g |
| Ethylene oxide-modified trimethylol-propane triacrylate | 0.2 | g |
| (V#360, manufactured by Osaka Organic Chemicals Ltd.) | | |
| Polymerization initiator (IRGACURE 907, manufactured by | 0.06 | g |
| Ciba Specialty Chemicals Inc.) | | |
| Sensitizer (KAYACURE DETX, manufactured by Nippon | 0.02 | g |
| Kayaku Co., Ltd.) | | |
| Methyl ethyl ketone | 3.9 | g |

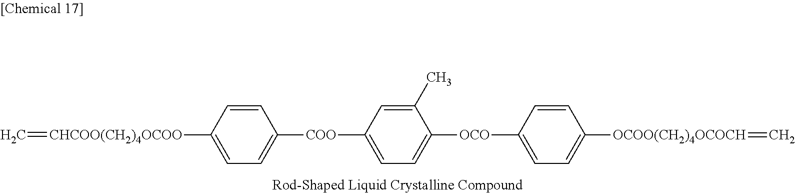

The oriented film was heated for 3 minutes in a constant temperature tank of 125° C., and the rod-shaped liquid crystalline compound was oriented. Next, UV irradiation was carried out for 30 seconds using a 120 W/cm high-pressure mercury lamp so as to crosslink the rod-shaped liquid crystalline compound. The temperature during UV curing was set to 80° C., and an optically anisotropic layer was produced. The thickness of the optical anisotropic layer was 1.7 μm. After that, the oriented film was cooled to room temperature. A λ/4 film 9A was produced in the above manner. The Re (550) and Rth (550) of the manufactured λ/4 film 9A at 550 nm were 138 nm and 108 nm. The direction of the retarded axis was orthogonal to the rotation axis of the rubbing rollers. That is, it was confirmed that the retarded axis was in the 45° clockwise direction with respect to the longitudinal direction of the supporting body. The moisture permeability of the λ/4 film 9A at 40° C. and 90% RH after 24 hours was 330 g/m²/day.

2. Manufacturing of the Protection Member

(Manufacturing of a Protection Member 1)

The supporting body surface of the surface layer (anti-reflection layer)-attached optical film 1B was attached to the λ/4 film 1A through the easy-adhesion layer so as to manufacture a protection member 1. The Re (550) and Rth (550) of the entire protection member 1 were 138 nm and 125 nm.

(Manufacturing of a Protection Member 2)

The supporting body surface of the surface layer (anti-reflection layer)-attached optical film 1B was attached to the λ/4 film 2A through the easy-adhesion layer so as to manufacture a protection member 2. The Re (550) and Rth (550) of the entire protection member 2 were 138 nm and 125 nm.

(Manufacturing of a Protection Member 3)

After the same surface layer as for the surface layer (anti-reflection layer)-attached optical film 1B was manufactured on a glass substrate, the surface layer separated from the glass substrate was attached to the λ/4 film 1A, and used as a protection member 3. The Re (550) and Rth (550) of the entire protection member 3 were 138 nm and 85 nm.

(Manufacturing of a Protection Member 4)

After the same surface layer as for the surface layer (anti-reflection layer)-attached optical film 1B was manufactured on a glass substrate, the surface layer separated from the glass substrate was attached to the λ/4 film 2A, and used as a protection member 4. The Re (550) and Rth (550) of the entire protection member 4 were 138 nm and 85 nm.

(Manufacturing of a Protection Member 5)

The supporting body surface of the surface layer (anti-reflection layer)-attached optical film 5B was attached to the λ/4 film 5A through the easy-adhesion layer so as to manufacture a protection member 5. The Re (550) and Rth (550) of the entire protection member 5 were 138 nm and −3 nm.

(Manufacturing of a Protection Member 6)

The supporting body surface of the surface layer (anti-reflection layer)-attached optical film 1B was attached to the λ/4 film 5A through the easy-adhesion layer so as to manufacture a protection member 6. The Re (550) and Rth (550) of the entire protection member 6 were 138 nm and 35 nm.

(Manufacturing of a Protection Member 7)

A surface layer was manufactured on a glass substrate in the same manner as for the manufacturing of the optical film 1B except that the hard coating layer and the low refractive index layer of the optical film 1B were manufactured on the glass substrate instead of being coated on a cellulose acylate film “TD80UL.” The surface layer separated from the glass substrate was attached to the λ/4 film 7A, and used as a protection member 7. The Re (550) and Rth (550) of the entire protection member 7 were 138 nm and 85 nm.

(Manufacturing of a Protection Member 8)

A commercially available cellulose acylate film “TD80UL” (manufactured by Fuji Film Holdings Corporation) was attached to the λ/4 film 1A on the supporting body side through the easy-adhesion layer so as to manufacture a protection member 8. The Re (550) and Rth (550) of the entire protection member 8 were 125 nm and 148 nm.

(Manufacturing of a Protection Member 9)

The supporting body surface of the surface layer (anti-reflection layer)-attached optical film 1B was attached to the λ/4 film 9A on the supporting body side through the easy-adhesion layer so as to manufacture a protection member 9. The Re (550) and Rth (550) of the entire protection member 9 were 138 nm and 148 nm.

(Manufacturing of a Protection Member 10)

A 100 μm-thick ZEONOR film ZF14, which was a commercially available cyclic olefin-based resin film manufactured by Optes Inc., was attached to the λ/4 film 5A on the supporting body side through the easy-adhesion layer so as to manufacture a protection member 10. The Re (550) and Rth (550) of the entire protection member 10 were 138 nm and −3 nm. The moisture permeability of the ZEONOR film ZF14 at 40° C. and 90% RH after 24 hours was 20 g/m²/day.

(Manufacturing of a Protection Member 11)

A protection member 11 was manufactured in the same manner as for the manufacturing of the protection member 5 except that the λ/4 film 5A was changed to the λ/4 film 9A. The Re (550) and Rth (550) of the entire protection member 11 were 138 nm and 108 nm.

(Manufacturing of a Protection Member 12)

A protection member 12 was manufactured in the same manner as for the manufacturing of the protection member 10 except that the λ/4 film 5A was changed to the λ/4 film 9A. The Re (550) and Rth (550) of the entire protection member 12 were 138 nm and 106 nm.

3. Manufacturing of an Optical Retardation Film

(Manufacturing of an Optical Retardation Film A)

The cellulose acylate-based optical retardation film that was used for a liquid crystal television LC-46LX1, manufactured by Sharp Electronics Corporation, was peeled off, and used as an optical retardation film A. The moisture permeability of the used optical retardation film A at 40° C. and 90% RH after 24 hours was 500 g/m²/day.

(Manufacturing of an Optical Retardation Film B)

The norbornene-based optical retardation film that was used for a liquid crystal television KDL-46HX800, manufactured by Sharp Electronics Corporation, was peeled off, and used as an optical retardation film B. The moisture permeability of the used optical retardation film B at 40° C. and 90% RH after 24 hours was 22 g/m²/day.

(Manufacturing of an Optical Retardation Film C)

The cellulose acylate-based optical retardation film that was used for a liquid crystal television KDL-52W5, manufactured by Sharp Electronics Corporation, was peeled off, and used as an optical retardation film C. The moisture permeability of the used optical retardation film C at 40° C. and 90% RH after 24 hours was 1020 g/m²/day.

(Manufacturing of an Optical Retardation Film D)

<Synthesis of a Cyclic Olefin-Based Polymer P-1>

180 parts by mass of purified toluene and 60 parts by mass of 5-norbornene-2-allyl acetate (NB—CH₂—OC(O)—CH₃: NB represents norbornene) were injected into a reaction tank. Next, 0.005 parts by mass of palladium (II) acetate dissolved in 20 parts by mass of chloromethane and 0.05 parts by mass of tricyclohexylphosphonium (tetrakispentafluorophenyl) borate were injected into the reaction tank. The chemicals were reacted for 18 hours while being stirred at 90° C. After the reaction, 1000 parts by mass of purified toluene was added, a polymer solution was diluted, and then injected into excess ethanol, thereby producing white polymer sedimentation. The sedimentation was purified, and the obtained polymer was dried at 80° C. for 24 hours under vacuum.

The obtained polymer was dissolved in tetrahydrofuran, the molecular weight was measured using gel permeation chromatography, the number average molecular weight in terms of polystyrene was 95,000, and the weight average molecular weight was 260,000.

<Film Making>

The following composition was injected into a mixing tank, stirred to dissolve the respective components, and then filtered using a paper filter having an average pore diameter of 34 μm and a sintered metal filter having an average pore diameter of 10 μm, thereby preparing a cyclic olefin-based resin solution.

Composition of a cyclic olefin-based resin solution A

| | | |
|---|---|---|
| Cyclic olefin-based polymer P-1 | 150 | parts by mass |
| ARUFON UH-2041 (manufactured by Toagosei | 13.5 | parts by mass |
| Co., Ltd.) | | |
| ARUFON UH-2180 (manufactured by Toagosei | 31.5 | parts by mass |
| Co., Ltd.) | | |
| Dichloromethane | 420 | parts by mass |
| Methanol | 40 | parts by mass |
| IRGANOX 1010 (manufactured by Ciba | 0.45 | parts by mass |
| Specialty Chemicals Inc.) | | |

Composition of a cyclic olefin-based resin solution B

| | | |
|---|---|---|
| Cyclic olefin-based polymer P-1 | 100 | parts by mass |
| Dichloromethane | 276 | parts by mass |
| Methanol | 24 | parts by mass |
| IRGANOX 1010 (manufactured by Ciba | 0.3 | parts by mass |
| Specialty Chemicals Inc.) | | |

Next, the following composition including the cyclic olefin-based resin solution B that was manufactured by the above method was injected into a disperser, and a matting agent dispersion fluid C was prepared.

Composition of the matting agent dispersion fluid C

| | | |
|---|---|---|
| Silica particles having an average particle diameter | 2 | parts by mass |
| of 16 nm (aerosol R972, manufactured by Nippon | | |
| Aerosil Co., Ltd.) | | |
| Dichloromethane | 73 | parts by mass |
| Methanol | 10 | parts by mass |
| Cyclic olefin-based resin solution B | 10 | parts by mass |

100 parts by mass of the cyclic olefin-based resin solution A and 1.43 parts by mass of the matting agent dispersion fluid C were mixed, a film-making dope was prepared, and cast in a band caster. After the width of a film peeled off from the band at a residual solvent amount of approximately 30% by mass was widened up to a stretch rate of 18% using a tenter, the film was mitigated for 60 seconds at 140° C. so that the stretch rate became 14%, and dried. After that, the film was moved from tenter transportation to roll transportation, and, furthermore, dried from 120° C. to 140° C., thereby producing a 1440 mm-wide cyclic olefin-based film. The film was used as a cyclic olefin-based optical retardation film D. The Re (550) and Rth (550) of the cyclic olefin-based optical retardation film D were 53 nm and 115 nm respectively. Here, for the Re (550) and Rth (550), values measured at a wavelength of 550 nm using an automatic double reflectometer KOBRA-21ADH (manufactured by Oji Scientific Instruments) were used. In addition, the moisture permeability of the λ/4 film 2A at 40° C. and 90% RH after 24 hours was 290 g/m²/day.

(Manufacturing of an Optical Retardation Film E)

A commercially available norbornene-based polymer film “ZEONOR ZF14” (manufactured by Optes Inc.) was subjected to fixed-end biaxial stretching so as to manufacture a norbornene-based optical retardation film E. The Re (550) and Rth (550) of the norbornene-based optical retardation film E were 70 nm and 210 nm respectively. Here, for the Re (550) and Rth (550), values measured at a wavelength of 550 nm using an automatic double reflectometer KOBRA-21ADH (manufactured by Oji Scientific Instruments) were used. In addition, the moisture permeability of the λ/4 film 1A at 40° C. and 90% RH after 24 hours was 20 g/m²/day.

(Manufacturing of an Optical Retardation Film F)

Cellulose acrylates having the kinds of acyl groups and the substitution degree as described in the following table were prepared. The cellulose acrylates were prepared by adding sulfuric acid (7.8 parts by mass with respect to 100 parts by mass of cellulose) as a catalyst, adding carboxylic acid, which was to be a raw material of an acyl substituent, and causing an acylation reaction at 40° C. At this time, the kinds and substitution degree of the acyl group were adjusted by adjusting the kinds and amounts of the carboxylic acid. In addition, maturation was carried out at 40° C. after the acylation. Furthermore, the low molecular weight components in the cellulose acylate were washed and removed using acetone. Meanwhile, in the table, Ac represents an acetyl group, and CTA represents cellulose triacetate (a cellulose ester deviate in which the acyl group was composed of an acetate group only).

TABLE 1

| | | |
|---|---|---|
| Cotton | Cotton type | CTA |
| | Degree of whole substitution | 2.81 |
| | Rate of 6-substitution rate | 0.320 |
| | Degree of 6-substitution | 0.9 |
| | Substituent | Ac |
| Additive | Additive type | Retardation developing |
| | | agent (1) |
| | Added amount | 7 |
| | [parts by mass with respect to | |
| | 100 parts by mass of cotton] | |
| Plasticizer | Plasticizer type | TPP/BDP |
| | Amount of plasticizer | 7.8/3.9 |
| | [parts by mass with respect to | |
| | 100 parts by mass of cotton] | |
| Stretching | Vertical stretching rate [%] | 28 |
| conditions | Horizontal stretching rate [%] | 60 |
| | Alleviation rate [%] | 7 |
| | Stretching speed [% min] | 100 |
| | Film surface temperature | 160 |
| | [° C.] | |
| | Amount of residual solvent | 45 |
| | during peeling off [%] | |
| | Amount of residual solvent | 10 |
| | after completion of | |
| | stretching [%] | |

The abbreviated names in the table indicate the following.
CTA: cellulose triacetate
TPP: triphenyl phosphate
BDP: biphenyl diphenyl phosphate

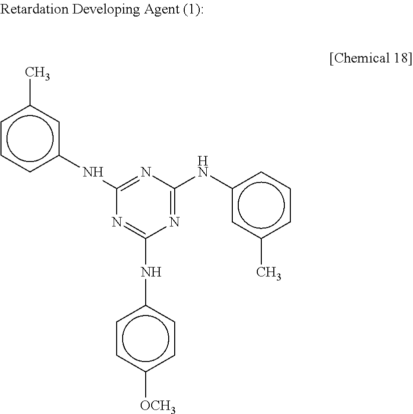

<Preparation of a Cellulose Acylate Solution>

The following composition was injected into a mixing tank, stirred to dissolve the respective components, furthermore, heated to 90° C. for approximately 10 minutes, and then filtered using a paper filter having an average pore diameter of 34 μm and a sintered metal filter having an average pore diameter of 10 μm

Cellulose acylate solution

| | | |
|---|---|---|
| CTA in the table | 100.0 | parts by mass |
| Triphenyl phosphate (TPP) | 7.8 | parts by mass |
| Biphenyl diphenyl phosphate (BDP) | 3.9 | parts by mass |
| Methylene chloride | 403.0 | parts by mass |
| Methanol | 60.2 | parts by mass |

<Preparation of a Matting Agent Dispersion Fluid>

Next, the following composition including a cellulose acylate solution prepared by the above method was injected into a disperser, and a matting agent dispersion fluid was prepared.

Matting agent dispersion fluid

| | | |
|---|---|---|
| Silica particles having an average particle | 2.0 | parts by mass |
| diameter of 16 nm (aerosol R972, manufactured | | |
| by Nippon Aerosil Co., Ltd.) | | |
| Methylene chloride | 72.4 | parts by mass |
| Methanol | 10.8 | parts by mass |
| Cellulose acylate solution | 10.3 | parts by mass |

<Preparation of an Additive Solution>

Next, the following composition including a cellulose acylate solution prepared by the above method was injected into a mixing tank, dissolved by heating and stirring, and an additive solution was prepared.

Additive solution

| | | |
|---|---|---|
| Retardation developing agent (1) | 20.0 | parts by mass |
| Methylene chloride | 58.3 | parts by mass |
| Methanol | 8.7 | parts by mass |
| Cellulose acylate solution | 12.8 | parts by mass |

100 parts by mass of the cellulose acylate solution, 1.35 parts by mass of the matting agent dispersion fluid, and, furthermore, as much the additive solution such that the amount of the retardation developing agent (1) added to a cellulose acylate-based film became 7 parts by mass were mixed, and a film-making dope was prepared. The addition proportion of the additive is expressed by parts by mass when the amount of the cellulose acylate is considered to be 100 parts by mass.

The dope was cast using a band caster. A film stripped from the band at the residual solvent amount as described in the above table was stretched in the vertical direction in the section from the stripping to a tenter at the stretching rate as described in the above table, then, stretched in the width direction at the stretching rate as described in the following table using the tenter, immediately after the horizontal stretching, compressed (mitigated) in the width direction at the rate as described in the following table, and then separated from the tenter, thereby making a cellulose acylate-based film. The residual solvent amount of the film at the separation from the tenter was as described in the above table. The film was cut off at both end portions before a rolling portion, and rolled as a 2000 mm-wide and 4000 m-long roll film. The stretching rates are shown in the above table.

The cellulose-based film as manufactured in the above manner was used as an optical retardation film F. The cellulose acylate-based optical retardation film F had a Re (550) of 70 nm and a Rth (550) of 208 nm. Here, values measured at a wavelength of 550 nm using an automatic double reflectometer KOBRA-21ADH (manufactured by Oji Scientific Instruments) were used as the Re (550) and the Rth (550). In addition, the moisture Permeability at 40° C. and 90% RH after 24 hours was 300 g/m²/day.

4. Manufacturing of a Polarization Plate

A 80 μm-thick polyvinyl alcohol (PVA) film was immersed and dyed in an aqueous solution of iodine having an iodine concentration of 0.05% by mass at 30° C. for 60 seconds, subsequently, vertically stretched 5 times the original length while being immersed in an aqueous solution of boric acid having a boric acid concentration of 4% by mass for 60 seconds, and then dried at 50° C. for 4 minutes, thereby producing a 20 μm-thick polarization film.

In a case in which the attached surface was a circular olefin-based film and a norbornene-based film, a glow discharge treatment (a high-frequency voltage of 4200 V having a frequency of 3000 Hz was applied between the top and bottom electrodes, and the treatment was carried out for 20 seconds) was carried out, and, in a case in which the attached surface was a cellulose acylate-based film, a saponification treatment was carried out. Then, the polarization film was sandwiched with an optical retardation film A on one surface and the protection member 1 on the other surface, and attached using an adhesive, thereby manufacturing a first polarization plate 1 disposed on the observation side. Meanwhile, the films were attached so as to make the retarded axis of the optical retardation film A orthogonal to the absorption axis of the polarization film.

Subsequently, the polarization film was sandwiched with an optical retardation film A on one surface and a commercially available cellulose acylate-based film “TD80UL” on the other surface, and attached using an adhesive, thereby manufacturing a second polarization plate 1 disposed on the light source side. Meanwhile, the films were attached so as to make the retarded axis of the TD80UL parallel to the absorption axis of the polarization film.

The first and second polarization plates 2 to 83 were manufactured by the same method as the above except that the optical retardation film, the protection member, and the λ/4 film were changed as shown in the following tables.

5. Manufacturing of a 3D Display Apparatus

A 3D liquid crystal television (VA mode) UN46C7000 manufactured by Samsung was prepared, the front polarization plate was peeled off, and the manufactured first polarization plate 1 was attached. Subsequently, the rear polarization plate was peeled off, and the manufactured second polarization plate 1 was attached, thereby manufacturing a 3D display apparatus 1.

3D display apparatuses 2 to 83 were manufactured by the same method as the above except that the first and second polarization plates 1 were changed as shown in the following tables.

6. Evaluation

The manufactured 3D display apparatuses 1 to 83 were placed to stand idle for 7 days under conditions of a temperature of 50° C. and a relative humidity of 95%. After the treatment, the apparatuses were placed to stand idle for one day under conditions of a temperature of 25° C. and a relative humidity of 60%, the backlight was continuously lighted for 24 hours, then, the surface shape viewed from the front was observed in a dark room, and the durability unevenness (unevenness including uneven circles or uneven image edges) was evaluated using the following criteria.

A: Not observed (the same as before the test)

B: Light leakage was observed to the permissible extent.

C: Light leakage was evidently observed to the impermissible extent.

D: Significant light leakage was observed to the impermissible extent.

TABLE 2

| | Example 1 | Example 2 | Example 3 | Example 4 | Example 5 | Example 6 | Example 7 | Example 8 |
|---|---|---|---|---|---|---|---|---|
| Protection member | Protection | Protection | Protection | Protection | Protection | Protection | Protection | Protection |
| | member 1 | member 2 | member 3 | member 4 | member 5 | member 1 | member 2 | member 3 |
| Second film | Optical | Optical | Optical | Optical | Optical | Optical | Optical | Optical |
| | retardation | retardation | retardation | retardation | retardation | retardation | retardation | retardation |
| | film A | film A | film A | film A | film A | film B | film B | film B |
| Third film | Optical | Optical | Optical | Optical | Optical | Optical | Optical | Optical |
| | retardation | retardation | retardation | retardation | retardation | retardation | retardation | retardation |
| | film A | film A | film A | film A | film A | film B | film B | film B |
| Protective film on | TD80UL | TD80UL | TD80UL | TD80UL | TD80UL | TD80UL | TD80UL | TD80UL |
| backlight side | | | | | | | | |
| Moisture permeability of | 25 | 100 | 25 | 100 | 20 | 25 | 100 | 25 |
| film having lowest | | | | | | | | |
| moisture permeability in | | | | | | | | |
| protection member | | | | | | | | |
| (g/m²/day) | | | | | | | | |
| Moisture permeability of | 500 | 500 | 500 | 500 | 500 | 22 | 22 | 22 |
| second film | | | | | | | | |
| (g/m²/day) | | | | | | | | |
| Moisture permeability of | 500 | 500 | 500 | 500 | 500 | 22 | 22 | 22 |
| third film | | | | | | | | |
| (g/m²/day) | | | | | | | | |
| No. of first and second | 1 | 2 | 3 | 4 | 5 | 6 | 7 | 8 |
| polarization plates | | | | | | | | |
| Evaluation | A | A | A | A | A | B | B | B |

TABLE 3

| | Example 9 | Example 10 | Example 11 | Example 12 | Example 13 | Example 14 | Example 15 | Example 16 |
|---|---|---|---|---|---|---|---|---|
| Protection member | Protection | Protection | Protection | Protection | Protection | Protection | Protection | Protection |
| | member 4 | member 5 | member 1 | member 3 | member 4 | member 1 | member 3 | member 4 |
| Second film | Optical | Optical | Optical | Optical | Optical | Optical | Optical | Optical |
| | retardation | retardation | retardation | retardation | retardation | retardation | retardation | retardation |
| | film B | film B | film C | film C | film C | film D | film D | film D |
| Third film | Optical | Optical | Optical | Optical | Optical | Optical | Optical | Optical |
| | retardation | retardation | retardation | retardation | retardation | retardation | retardation | retardation |
| | film B | film B | film C | film C | film C | film D | film D | film D |
| Protective film on | TD80UL | TD80UL | TD80UL | TD80UL | TD80UL | TD80UL | TD80UL | TD80UL |
| backlight side | | | | | | | | |
| Moisture permeability of | 100 | 20 | 25 | 25 | 100 | 25 | 25 | 100 |
| film having lowest | | | | | | | | |
| moisture permeability in | | | | | | | | |
| protection member | | | | | | | | |
| (g/m²/day) | | | | | | | | |
| Moisture permeability of | 22 | 22 | 1020 | 1020 | 1020 | 290 | 290 | 290 |
| second film | | | | | | | | |
| (g/m²/day) | | | | | | | | |
| Moisture permeability of | 22 | 22 | 1020 | 1020 | 1020 | 290 | 290 | 290 |
| third film | | | | | | | | |
| (g/m²/day) | | | | | | | | |
| No. of first and second | 9 | 10 | 11 | 12 | 13 | 14 | 15 | 16 |
| polarization plates | | | | | | | | |
| Evaluation | B | B | A | A | A | A | A | A |

TABLE 4

| | Example 17 | Example 18 | Example 19 | Example 20 | Example 21 | Example 22 | Example 23 | Example 24 |
|---|---|---|---|---|---|---|---|---|
| Protection member | Protection | Protection | Protection | Protection | Protection | Protection | Protection | Protection |
| | member 1 | member 3 | member 4 | member 1 | member 3 | member 4 | member 1 | member 3 |
| Second film | TD80UL | TD80UL | TD80UL | Optical | Optical | Optical | TD80UL | TD80UL |
| | | | | retardation | retardation | retardation | | |
| | | | | film E | film E | film E | | |
| Third film | Optical | Optical | Optical | TD80UL | TD80UL | TD80UL | Optical | Optical |
| | retardation | retardation | retardation | | | | retardation | retardation |
| | film E | film E | film E | | | | film F | film F |
| Protective film on | TD80UL | TD80UL | TD80UL | TD80UL | TD80UL | TD80UL | TD80UL | TD80UL |
| backlight side | | | | | | | | |
| Moisture permeability of | 25 | 25 | 100 | 25 | 25 | 100 | 25 | 25 |
| film having lowest | | | | | | | | |
| moisture permeability in | | | | | | | | |
| protection member | | | | | | | | |
| (g/m²/day) | | | | | | | | |
| Moisture permeability of | 430 | 430 | 430 | 20 | 20 | 20 | 430 | 300 |
| second film | | | | | | | | |
| (g/m²/day) | | | | | | | | |
| Moisture permeability of | 20 | 20 | 20 | 430 | 430 | 430 | 300 | 300 |
| third film | | | | | | | | |
| (g/m²/day) | | | | | | | | |
| No. of first and second | 17 | 18 | 19 | 20 | 21 | 22 | 23 | 24 |
| polarization plates | | | | | | | | |
| Evaluation | A | A | A | B | B | B | A | A |

TABLE 5

| | Example 25 | Example 26 | Example 27 | Example 28 | Example 29 | Example 30 | Example 31 | Example 32 |
|---|---|---|---|---|---|---|---|---|
| Protection member | Protection | Protection | Protection | Protection | Protection | λ/4 film 1A | λ/4 film 2A | Protection |
| | member 4 | member 1 | member 3 | member 4 | member 8 | | | member 8 |
| Second film | TD80UL | Optical | Optical | Optical | Optical | Optical | Optical | Optical |
| | | retardation | retardation | retardation | retardation | retardation | retardation | retardation |
| | | film F | film F | film F | film A | film A | film A | film B |
| Third film | Optical | TD80UL | TD80UL | TD80UL | Optical | Optical | Optical | Optical |
| | retardation | | | | retardation | retardation | retardation | retardation |
| | film F | | | | film A | film A | film A | film B |
| Protective film on | TD80UL | TD80UL | TD80UL | TD80UL | TD80UL | TD80UL | TD80UL | TD80UL |
| backlight side | | | | | | | | |
| Moisture permeability of | 100 | 25 | 25 | 100 | 25 | 25 | 100 | 25 |
| film having lowest | | | | | | | | |
| moisture permeability in | | | | | | | | |
| protection member | | | | | | | | |
| (g/m²/day) | | | | | | | | |
| Moisture permeability of | 430 | 300 | 300 | 300 | 500 | 500 | 500 | 22 |
| second film | | | | | | | | |
| (g/m²/day) | | | | | | | | |
| Moisture permeability of | 300 | 430 | 430 | 430 | 500 | 500 | 500 | 22 |
| third film | | | | | | | | |
| (g/m²/day) | | | | | | | | |
| No. of first and second | 25 | 26 | 27 | 28 | 29 | 30 | 31 | 32 |
| polarization plates | | | | | | | | |
| Evaluation | A | A | A | A | A | A | A | B |

TABLE 6

| | Example 33 | Example 34 | Example 35 | Example 36 | Example 37 | Example 38 | Example 39 | Example 40 |
|---|---|---|---|---|---|---|---|---|
| Protection member | λ/4 film 1A | λ/4 film 2A | Protection | λ/4 film 1A | λ/4 film 2A | λ/4 film 1A | λ/4 film 2A | λ/4 film 1A |
| | | | member 8 | | | | | |
| Second film | Optical | Optical | Optical | Optical | Optical | Optical | Optical | TD80UL |
| | retardation | retardation | retardation | retardation | retardation | retardation | retardation | |
| | film B | film B | film C | film C | film C | film D | film D | |
| Third film | Optical | Optical | Optical | Optical | Optical | Optical | Optical | Optical |
| | retardation | retardation | retardation | retardation | retardation | retardation | retardation | retardation |
| | film B | film B | film C | film C | film C | film D | film D | film E |
| Protective film on | TD80UL | TD80UL | TD80UL | TD80UL | TD80UL | TD80UL | TD80UL | TD80UL |
| backlight side | | | | | | | | |
| Moisture permeability of | 25 | 100 | 25 | 25 | 100 | 25 | 100 | 25 |
| film having lowest | | | | | | | | |
| moisture permeability in | | | | | | | | |
| protection member | | | | | | | | |
| (g/m²/day) | | | | | | | | |
| Moisture permeability of | 22 | 22 | 1020 | 1020 | 1020 | 290 | 290 | 430 |
| second film | | | | | | | | |
| (g/m²/day) | | | | | | | | |
| Moisture permeability of | 22 | 22 | 1020 | 1020 | 1020 | 290 | 290 | 20 |
| third film | | | | | | | | |
| (g/m²/day) | | | | | | | | |
| No. of first and second | 33 | 34 | 35 | 36 | 37 | 38 | 39 | 40 |
| polarization plates | | | | | | | | |
| Evaluation | B | B | A | A | A | A | A | A |

TABLE 7

| | Example 41 | Example 42 | Example 43 | Example 44 | Example 45 | Example 46 | Example 47 | Example 48 |
|---|---|---|---|---|---|---|---|---|
| Protection member | λ/4 film 2A | λ/4 film 1A | λ/4 film 2A | λ/4 film 1A | λ/4 film 2A | λ/4 film 1A | λ/4 film 2A | Protection |
| | | | | | | | | member 10 |
| Second film | TD80UL | Optical | Optical | TD80UL | TD80UL | Optical | Optical | Optical |
| | | retardation | retardation | | | retardation | retardation | retardation |
| | | film E | film E | | | film F | film F | film A |
| Third film | Optical | TD80UL | TD80UL | Optical | Optical | TD80UL | TD80UL | Optical |
| | retardation | | | retardation | retardation | | | retardation |
| | film E | | | film F | film F | | | film A |
| Protective film on | TD80UL | TD80UL | TD80UL | TD80UL | TD80UL | TD80UL | TD80UL | TD80UL |
| backlight side | | | | | | | | |
| Moisture permeability of | 100 | 25 | 100 | 25 | 100 | 25 | 100 | 20 |
| film having lowest | | | | | | | | |
| moisture permeability in | | | | | | | | |
| protection member | | | | | | | | |
| (g/m²/day) | | | | | | | | |
| Moisture permeability of | 430 | 20 | 20 | 430 | 430 | 300 | 300 | 500 |
| second film | | | | | | | | |
| (g/m²/day) | | | | | | | | |
| Moisture permeability of | 20 | 430 | 430 | 300 | 300 | 430 | 430 | 500 |
| third film | | | | | | | | |
| (g/m²/day) | | | | | | | | |
| No. of first and second | 41 | 42 | 43 | 44 | 45 | 46 | 47 | 48 |
| polarization plates | | | | | | | | |
| Evaluation | A | B | B | A | A | A | A | A |

TABLE 8

| | Example 49 | Example 50 | Example 51 | Example 52 | Example 53 | Example 54 | Example 55 | Example 56 |
|---|---|---|---|---|---|---|---|---|
| Protection member | Protection | Protection | Protection | Protection | Protection | Protection | Protection | Protection |
| | member 10 | member 10 | member 11 | member 11 | member 11 | member 12 | member 12 | member 12 |
| Second film | Optical | Optical | Optical | Optical | Optical | Optical | Optical | Optical |
| | retardation | retardation | retardation | retardation | retardation | retardation | retardation | retardation |
| | film B | film C | film A | film B | film C | film A | film B | film C |
| Third film | Optical | Optical | Optical | Optical | Optical | Optical | Optical | Optical |
| | retardation | retardation | retardation | retardation | retardation | retardation | retardation | retardation |
| | film B | film C | film A | film B | film C | film A | film B | film C |
| Protective film on | TD80UL | TD80UL | TD80UL | TD80UL | TD80UL | TD80UL | TD80UL | TD80UL |
| backlight side | | | | | | | | |
| Moisture permeability of | 20 | 20 | 20 | 20 | 20 | 20 | 20 | 20 |
| film having lowest | | | | | | | | |
| moisture permeability in | | | | | | | | |
| protection member | | | | | | | | |
| (g/m²/day) | | | | | | | | |
| Moisture permeability of | 22 | 1020 | 500 | 22 | 1020 | 500 | 22 | 1020 |
| second film | | | | | | | | |
| (g/m²/day) | | | | | | | | |
| Moisture permeability of | 22 | 1020 | 500 | 22 | 1020 | 500 | 22 | 1020 |
| third film | | | | | | | | |
| (g/m²/day) | | | | | | | | |
| No. of first and second | 49 | 50 | 51 | 52 | 53 | 54 | 55 | 56 |
| polarization plates | | | | | | | | |
| Evaluation | B | A | A | B | A | A | B | A |

TABLE 9

| | Comparative | Comparative | Comparative | Comparative | Comparative | Comparative | Comparative | Comparative |
|---|---|---|---|---|---|---|---|---|
| | Example 1 | Example 2 | Example 3 | Example 4 | Example 5 | Example 6 | Example 7 | Example 8 |
| Protection member | Protection | Protection | Optical film | Optical film | Protection | Optical film | Protection | Optical film |
| | member 6 | member 6 | 1B | 1B | member 6 | 1B | member 6 | 1B |
| Second film | Optical | Optical | Optical | Optical | Optical | Optical | Optical | Optical |
| | retardation | retardation | retardation | retardation | retardation | retardation | retardation | retardation |
| | film A | film B | film A | film B | film C | film C | film D | film D |
| Third film | Optical | Optical | Optical | Optical | Optical | Optical | Optical | Optical |
| | retardation | retardation | retardation | retardation | retardation | retardation | retardation | retardation |
| | film A | film B | film A | film B | film C | film C | film D | film D |
| Protective film on | TD80UL | TD80UL | TD80UL | TD80UL | TD80UL | TD80UL | TD80UL | TD80UL |
| backlight side | | | | | | | | |
| Moisture permeability of | 330 | 330 | 430 | 430 | 330 | 430 | 330 | 430 |
| film having lowest | | | | | | | | |
| moisture permeability in | | | | | | | | |
| protection member | | | | | | | | |
| (g/m²/day) | | | | | | | | |
| Moisture permeability of | 500 | 22 | 500 | 22 | 1020 | 1020 | 290 | 290 |
| second film | | | | | | | | |
| (g/m²/day) | | | | | | | | |
| Moisture permeability of | 500 | 22 | 500 | 22 | 1020 | 1020 | 290 | 290 |
| third film | | | | | | | | |
| (g/m²/day) | | | | | | | | |
| No. of first and second | 57 | 58 | 59 | 60 | 61 | 62 | 63 | 64 |
| polarization plates | | | | | | | | |
| Evaluation | D | C | D | C | D | D | D | D |

TABLE 10

| | Comparative | Comparative | Comparative | Comparative | Comparative | Comparative | Comparative | Comparative |
|---|---|---|---|---|---|---|---|---|
| | Example 9 | Example 10 | Example 11 | Example 12 | Example 13 | Example 14 | Example 15 | Example 16 |
| Protection member | Protection | Optical film | Protection | Optical film | Protection | Optical film | Protection | Optical film |
| | member 6 | 1B | member 6 | 1B | member 6 | 1B | member 6 | 1B |
| Second film | TD80UL | TD80UL | Optical | Optical | TD80UL | TD80UL | Optical | Optical |
| | | | retardation | retardation | | | retardation | retardation |
| | | | film E | film E | | | film F | film F |
| Third film | Optical | Optical | TD80UL | TD80UL | Optical | Optical | TD80UL | TD80UL |
| | retardation | retardation | | | retardation | retardation | | |
| | film E | film E | | | film F | film F | | |
| Protective film on | TD80UL | TD80UL | TD80UL | TD80UL | TD80UL | TD80UL | TD80UL | TD80UL |
| backlight side | | | | | | | | |
| Moisture permeability of | 330 | 430 | 330 | 430 | 330 | 430 | 330 | 430 |
| film having lowest | | | | | | | | |
| moisture permeability in | | | | | | | | |
| protection member | | | | | | | | |
| (g/m²/day) | | | | | | | | |
| Moisture permeability of | 430 | 430 | 20 | 20 | 430 | 430 | 300 | 300 |
| second film | | | | | | | | |
| (g/m²/day) | | | | | | | | |
| Moisture permeability of | 20 | 20 | 430 | 430 | 300 | 300 | 430 | 430 |
| third film | | | | | | | | |
| (g/m²/day) | | | | | | | | |
| No. of first and second | 65 | 66 | 67 | 68 | 69 | 70 | 71 | 72 |
| polarization plates | | | | | | | | |
| Evaluation | C | C | D | D | D | D | D | D |

TABLE 11

| | Comparative | Comparative | Comparative | Comparative | Comparative | Comparative | Comparative | Comparative |
|---|---|---|---|---|---|---|---|---|
| | Example 17 | Example 18 | Example 19 | Example 20 | Example 21 | Example 22 | Example 23 | Example 24 |
| Protection member | Protection | Protection | Protection | Protection | λ/4 film 7A | λ/4 film 7A | λ/4 film 7A | λ/4 film 7A |
| | member 7 | member 7 | member 7 | member 7 | | | | |
| Second film | Optical | Optical | TD80UL | Optical | Optical | Optical | TD80UL | Optical |
| | retardation | retardation | | retardation | retardation | retardation | | retardation |
| | film A | film B | | film E | film A | film B | | film E |
| Third film | Optical | Optical | Optical | TD80UL | Optical | Optical | Optical | TD80UL |
| | retardation | retardation | retardation | | retardation | retardation | retardation | |
| | film A | film B | film E | | film A | film B | film E | |
| Protective film on | TD80UL | TD80UL | TD80UL | TD80UL | TD80UL | TD80UL | TD80UL | TD80UL |
| backlight side | | | | | | | | |
| Moisture permeability of | 110 | 110 | 110 | 110 | 110 | 110 | 110 | 110 |
| film having lowest in | | | | | | | | |
| moisture permeability in | | | | | | | | |
| protection member | | | | | | | | |
| (g/m²/day) | | | | | | | | |
| Moisture permeability of | 500 | 22 | 430 | 20 | 500 | 22 | 430 | 20 |
| second film | | | | | | | | |
| (g/m²/day) | | | | | | | | |
| Moisture permeability of | 500 | 22 | 20 | 430 | 500 | 22 | 20 | 430 |
| third film | | | | | | | | |
| (g/m²/day) | | | | | | | | |
| No. of first and second | 73 | 74 | 75 | 76 | 77 | 78 | 79 | 80 |
| polarization plates | | | | | | | | |
| Evaluation | C | C | C | C | C | C | C | C |

TABLE 12

| | Comparative | Comparative | Comparative |
|---|---|---|---|
| | Example 25 | Example 26 | Example 27 |
| Protection member | Protection | Protection | Protection |
| | member 9 | member 9 | member 9 |
| Second film | Optical | Optical | Optical |
| | retardation | retardation | retardation |
| | film A | film B | film C |
| Third film | Optical | Optical | Optical |
| | retardation | retardation | retardation |
| | film A | film B | film C |
| Protective film on | TD80UL | TD80UL | TD80UL |
| backlight side | | | |
| Moisture permeability | 330 | 330 | 330 |
| of film having lowest | | | |
| moisture permeability | | | |
| in protection member | | | |
| (g/m²/day) | | | |
| Moisture permeability | 500 | 22 | 1020 |
| of second film | | | |
| (g/m²/day) | | | |
| Moisture permeability | 500 | 22 | 1020 |
| of third film | | | |
| (g/m²/day) | | | |
| No. of first and second | 81 | 82 | 83 |
| polarization plates | | | |
| Evaluation | D | C | D |

It is found from the tables that, when the protection portion includes at least one layer of the first film for which the moisture permeability at 40° C. and 90% RH is 100 g/m²/day or less, the durability unevenness is improved.

Liquid crystal cells in the VA mode were used in the above examples and comparative examples, but the same effect was obtained even when 3D display apparatuses were manufactured in the same manner as in the above examples and comparative examples except that liquid crystal cells in the IPS mode were used, and the same tests were carried out.

In addition, the same effect was obtained even when 3D display apparatuses were manufactured in the same manner as in the above examples and comparative examples except that an anti-reflection film CLEAR AR (manufactured by Sony Chemical & Information Device Corporation) and an anti-glare & hard coat AGA1 (manufactured by Sanritz Corporation) were used instead of the optical film 1B, and the same tests were carried out.

In addition, the same effect was obtained even when a 3D display system was manufactured as in FIG. 8, and the same tests as in the examples and comparative examples were carried out.

What is claimed is:

1. A 3D display apparatus comprising:
a first polarization film disposed on an observation side; and
a protection member that is disposed on a surface of the first polarization film on the observation side and has a λ/4 function,
wherein the protection member includes at least a first film of which the moisture permeability at 40° C. and 90% RH is 100 g/m²/day or less.

2. The 3D display apparatus according to claim 1, wherein the first film is a cyclic olefin-based polymer film.

3. The 3D display apparatus according to claim 1, wherein the protection member has an anti-reflection layer on the surface of the protection member on the observation side.

4. The 3D display apparatus according to claim 2, wherein the protection member has an anti-reflection layer on the surface of the protection member on the observation side.

5. The 3D display apparatus according to claim 1, wherein the first film has the λ/4 function.

6. The 3D display apparatus according to claim 1, wherein the protection member includes an optically anisotropic layer composed of a composition including a liquid crystalline compound.

7. The 3D display apparatus according to claim 3 further comprising a cellulose acylate-based film at least at one of positions between the first film and the anti-reflection layer and between the first film and the optically anisotropic layer.

8. The 3D display apparatus according to claim 1 comprising a second film for which the moisture permeability at 40° C. and 90% RH is 10 g/m²/day to 2000 g/m²/day on the surface of the first polarization film on an opposite side to the side on which the protection member is disposed.

9. The 3D display apparatus according to claim 8, wherein the second film is a cellulose acyl ate-based film.

10. A time-sequential 3D display system comprising: at least the 3D display apparatus according to claim 1; and a time-sequential image display shutting device that operates in synchronization with the 3D display apparatus.

11. The time-sequential 3D display system according to claim 10, wherein the time-sequential image display shutting device has at least a λ/4 plate, a liquid crystal cell, and a polarization film arranged in order from a side facing the 3D display apparatus.

12. The time-sequential 3D display system according to claim 11, wherein the time-sequential image display shutting device further has a polarization film between the λ/4 plate and the liquid crystal cell.
